(19) United States
(12) Patent Application Publication
(10) Pub. No.: US 2013/0261069 A1
(43) Pub. Date: Oct. 3, 2013

(54) PESTICIDAL MIXTURES COMPRISING ISOXAZOLINE DERIVATIVES

(71) Applicants: Ana Dutton, Basel (CH); Jerome Yves Cassayre, Stein (CH); Ulrich Johannes Haas, Stein (CH)

(72) Inventors: Ana Dutton, Basel (CH); Jerome Yves Cassayre, Stein (CH); Ulrich Johannes Haas, Stein (CH)

(73) Assignee: SYNGENTA CROP PROTECTION LLC, Greensboro, NC (US)

(21) Appl. No.: 13/702,580

(22) PCT Filed: Jun. 9, 2011
(86) PCT No.: PCT/EP2011/059586

§ 371 Date: Feb. 21, 2013

(30) Foreign Application Priority Data
Jun. 9, 2010 (EP) 10165342.6
Jun. 9, 2010 (EP) 10165346.7

(51) Int. Cl. A01N 43/80; A01N 53/00; A01N 43/54; A01N 43/38; A01N 43/40; A01N 43/88; A01N 43/90

(52) U.S. Cl. CPC A01N 43/80; A01N 43/88; A01N 53/00; A01N 43/90; A01N 43/38; A01N 43/40; A01N 43/54
USPC 514/30; 514/378; 514/229.2; 514/357; 514/269

(57) ABSTRACT

The present invention provides pesticidal mixtures comprising a component A, a component B and a component C, wherein component A is a compound of formula (I) wherein one of Y¹ and Y² is S, SO or SO₂ and the other is CH₂; L is a direct bond or methylene; A¹ and A² are C—H, or one of A¹ and A² is C—H and the other is N; R¹ is hydrogen or methyl; R² is chlorodifluoromethyl or trifluoromethyl; R³ is 3,5-dibromo-phenyl, 3,5-dichloro-phenyl, 3,4-dichloro-phenyl, or 3,4,5-trichloro-phenyl; R⁴ is methyl; R⁵ is hydrogen; or R⁴ and R⁵ together form a bridging 1,3-butadiene group; component B is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen, N-[9-(dichloromethylene)-1,2,3,4-tetrahydro-1,4-methanonaphthalen-5-yl]-3-(difluoromethyl)-1-methyl-1H-pyrazole-4-carboxamide and Fuxapyroxad; or component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria spp. such as P. penetrans and P. nishizawae, Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat; and component C is a compound selected from an insecticide, a fungicide and a nematicide, which insecticide is selected from neonicotinoids, carbamates, diamides, spinosyns, phenylpyrazoles, pyrethroids, Pyrifluquinazone, Pymetrozine, Sulfoxaflor and Spirotetramat; which fungicide is selected from Azoxystrobin, Trifloxystrobin, Fluoxastrobin, Cyproconazole, Difenoconazole, Prothioconazole, Tebuconazole, Triticonazole, Fludioxonil, Thiabendazole, Ipconazole, Cyprodinil, Myclobutanil, Metalaxyl, Mefenoxam, Sedaxane, N-[9-(dichloromethylene)-1,2,3,4-tetrahydro-1,4-methanonaphthalen-5-yl]-3-(difluoromethyl)-1-methyl-1H-pyrazole-4-carboxamide, Fluopyram, Penflufen, Fuxapyroxad, Fluopyram, and Penthiopyrad; which nematicide is selected from Abamectin, carbamate nematicides organophosphorous nematicides, Captan, Thiophanate-methyl, Thiabendazole, a compound of formula (X), wherein n is 0, 1 or 2 and the thiazole ring may be optionally substituted, Bacillus spp., Streptomyces spp. and Pasteuria spp.; Pochonia spp., Metarhizium spp.; wherein components B and C are different. The invention also provides methods of using the mixtures in the field of agriculture.

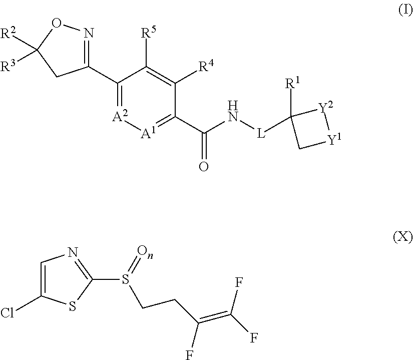

The present invention relates to mixtures of pesticidally active ingredients and to methods of using the mixtures in the field of agriculture.

WO 2009/080250 discloses that certain isoxazoline compounds have insecticidal activity.

The present invention provides pesticidal mixtures comprising a component A, a component B, and a component C, wherein component A is a compound of formula I

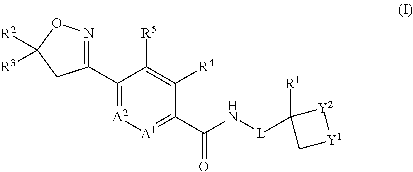

wherein
one of Y¹ and Y² is S, SO or SO₂ and the other is CH₂;
L is a direct bond or methylene;
A¹ and A² are C—H, or one of A¹ and A² is C—H and the other is N;
R¹ is hydrogen or methyl;
R² is chlorodifluoromethyl or trifluoromethyl;
R³ is 3,5-dibromo-phenyl, 3,5-dichloro-phenyl, 3,4-dichloro-phenyl, or 3,4,5-trichloro-phenyl;
R⁴ is methyl;
R⁵ is hydrogen;
or R⁴ and R⁵ together form a bridging 1,3-butadiene group;
component B is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen, N-[9-(dichloromethylene)-1,2,3,4-tetrahydro-1,4-methanonaphthalen-5-yl]-3-(difluoromethyl)-1-methyl-1H-pyrazole-4-carboxamide and Fuxapyroxad; or
component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria spp. such as P. penetrans and P. nishizawae, Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat; and
component C is a compound selected from an insecticide, a fungicide and a nematicide, which insecticide is selected from neonicotinoids, carbamates, diamides, spinosyns, phenylpyrazoles, pyrethroids, Pyrifluquinazone, Pymetrozine, Sulfoxaflor and Spirotetramat;
which fungicide is selected from Azoxystrobin, Trifloxystrobin, Fluoxastrobin, Cyproconazole, Difenoconazole, Prothioconazole, Tebuconazole, Triticonazole, Fludioxonil, Ipconazole, Cyprodinil, Myclobutanil, Metalaxyl, Mefenoxam, Sedaxane, N-[9-(dichloromethylene)-1,2,3,4-tetrahydro-1,4-methanonaphthalen-5-yl]-3-(difluoromethyl)-1-methyl-1H-pyrazole-4-carboxamide, Thiobendazole, Fluopyram, Penflufen, Fuxapyroxad and Penthiopyrad;
which nematicide is selected from Avermectin (e.g., Abamectin), carbamate nematicides organophosphorus nematicides, Captan, Thiophanate-methyl and Thiabendazole a compound of formula X,

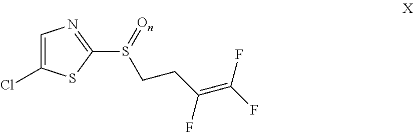

wherein n is 0, 1 or 2 and the thiazole ring may be optionally substituted, Bacillus spp. such as B. firmus, B. cereus B. subtilis, Streptomyces spp. such as S. avermitilis, and Pasteuria spp. such as P. penetrans and P. nishizawae; fungi including Metarhizium spp. such as M. anisopliae; Pochonia spp. such as P. chlamydosporia; wherein components B and C are different.

Compounds of formula I are known to have insecticidal activity. Certain active ingredient mixtures of a compound of formula I and additional active ingredients can enhance the spectrum of action with respect to the pest to be controlled, e.g. the animal pest and/or the fungal pest. For example, the combination of A, B and C may cause an increase in the expected insecticidal action and/or fungicidal action. This allows, on the one hand, a substantial broadening of the spectrum of pests that can be controlled and, on the other hand, increased safety in use through lower rates of application.

However, besides the actual synergistic action with respect to pest control, the pesticidal mixtures according to the invention can have further advantageous properties which can also be described, in a wider sense, as synergistic activity. Examples of such advantageous properties that may be mentioned are: a broadening of the spectrum of activity; a reduction in the rate of application of the active ingredients; adequate pest control with the aid of the mixtures according to the invention, sometimes even at a rate of application at which the individual compounds are totally ineffective; advantageous behaviour during formulation and/or upon application, for example upon grinding, sieving, emulsifying, dissolving or dispensing; increased storage stability; improved stability to light; more advantageous degradability; improved toxicological and/or ecotoxicological behaviour; improved characteristics of the useful plants including: emergence, crop yields, more developed root system, tillering increase, increase in plant height, bigger leaf blade, less dead basal leaves, stronger tillers, greener leaf colour, less fertilizers needed, less seeds needed, more productive tillers, earlier flowering, early grain maturity, less plant verse (lodging), increased shoot growth, improved plant vigor, and early germination; or any other advantages familiar to a person skilled in the art.

The mixtures of the invention may also comprise other active ingredients in addition to components A, B and C. In other embodiments the mixtures of invention may include only components A, B and C (or A, B, C1 and C2) as pesticidally active ingredients.

Components B and C are known e.g. from “The Pesticide Manual”, Fifteenth Edition, Edited by Clive Tomlin, British Crop Protection Council, or otherwise known to the person skilled in the art. N-[9-(dichloromethylene)-1,2,3,4-tetrahydro-1,4-methanonaphthalen-5-yl]-3-(difluoromethyl)-1-methyl-1H-pyrazole-4-carboxamide is a compound of formula II

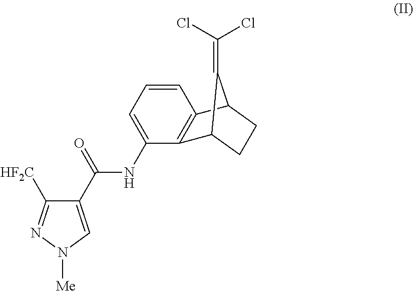

In one preferred group of compounds of formula I Y¹ is S and Y² is CH₂.

In another preferred group of compounds of formula I Y¹ is SO and Y² is CH₂.

In another preferred group of compounds of formula I Y¹ is SO₂ and Y² is CH₂ in the compound of formula I.

In another preferred group of compounds of formula I Y² is S and Y¹ is CH₂.

In another preferred group of compounds of formula I Y² is SO and Y¹ is CH₂.

In another preferred group of compounds of formula I Y² is SO₂ and Y¹ is CH₂.

In yet another preferred group of compounds of formula I L is a direct bond or methylene; one of Y¹ and Y² is S and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is SO and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is SO₂ and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is S and the other is CH₂; A¹ and A² are C—H; R¹ is hydrogen or methyl; R² is trifluoromethyl; R³ is 3,5-dichloro-phenyl; and R⁴ is methyl; and R⁴ and R⁵ together form a bridging 1,3-butadiene group.

In yet another preferred group of compounds of formula I L is a direct bond or methylene; one of Y¹ and Y² is SO and the other is CH₂; A¹ and A² are C—H; R¹ is hydrogen or methyl; R² is trifluoromethyl; R³ is 3,5-dichloro-phenyl; and R⁴ is methyl; and R⁴ and R⁵ together form a bridging 1,3-butadiene group.

In yet another preferred group of compounds of formula I L is a direct bond or methylene; one of Y¹ and Y² is SO₂ and the other is CH₂; A¹ and A² are C—H; R¹ is hydrogen or methyl; R² is trifluoromethyl; R³ is 3,5-dichloro-phenyl; and R⁴ is methyl; and R⁴ and R⁵ together form a bridging 1,3-butadiene group.

In yet another preferred group of compounds of formula I L is a direct bond or methylene; one of Y¹ and Y² is S and the other is CH₂; A¹ is C—H; A² is N; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is SO and the other is CH₂; A¹ is C—H; A² is N; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond or methylene; one of Y¹ and Y² is SO₂ and the other is CH₂; A¹ is C—H; A² is N; R¹ is hydrogen or methyl; R² is trifluoromethyl; R³ is 3,5-dichloro-phenyl; R⁴ is methyl; and R⁵ is hydrogen.

In yet another preferred group of compounds of formula I L is a direct bond; Y¹ is S, SO or SO₂; Y² is CH₂; A¹ is C—H; A² is C—H; R¹ is hydrogen; R² is trifluoromethyl; R³ is 3,5-dichloro-phenyl; R⁴ is methyl; and R⁵ is hydrogen.

In yet another preferred group of compounds of formula I L is a direct bond; Y¹ is S, SO or SO₂; Y² is CH₂; A¹ is C—H; A² is C—H; R¹ is methyl; R² is trifluoromethyl; R³ is 3,5-dichloro-phenyl; R⁴ is methyl; and R⁵ is hydrogen.

In yet another preferred group of compounds of formula I L is methylene; Y¹ is CH₂; Y² is S, SO or SO₂; A¹ is C—H; A² is C—H; R¹ is hydrogen; R² is trifluoromethyl; R³ is 3,5-dichloro-phenyl; R⁴ is methyl; and R⁵ is hydrogen.

In yet another preferred group of compounds of formula I L is methylene; Y¹ is CH₂; Y² is S, SO or SO₂; A¹ is C—H; A² is C—H; R¹ is methyl; R² is trifluoromethyl; R³ is 3,5-dichloro-phenyl; R⁴ is methyl; and R⁵ is hydrogen.

Preferably when L is a direct bond Y² is CH₂ and Y¹ is S, SO or SO₂ and when L is methylene Y² is S, SO or SO₂ and Y¹ is CH₂.

Each substituent definition in each alternative preferred groups of compounds of formula I may be juxtaposed with any substituent definition in any other preferred group of compounds, in any combination.

Compounds of formula I include at least one chiral centre and may exist as compounds of formula I* or compounds of formula I**.

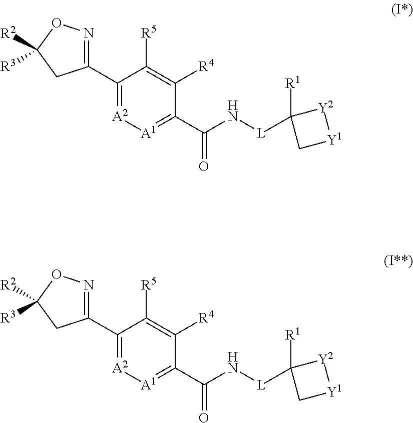

Compounds of formula I** are more biologically active than compounds of formula I* (confirmed by X-ray analysis). Component A may be a mixture of compounds I* and I** in any ratio e.g. in a molar ratio of 1:99 to 99:1, e.g. 10:1 to 1:10, e.g. a substantially 50:50 molar ratio. Preferably component A is a racemic mixture of the compounds of formula I** and I* or is enantiomerically enriched for the compound of formula I**. For example, when component A is an enantiomerically enriched mixture of formula I**, the molar proportion of compound I** compared to the total amount of both enantiomers is for example greater than 50%, e.g. at least 55, 60, 65, 70, 75, 80, 85, 90, 95, 96, 97, 98, or at least 99%.

Preferred compounds of formula I are shown in the Table below.

TABLE 1
Compounds of formula (Ia)

| | |
|---|---|
| | (Ia) |
| 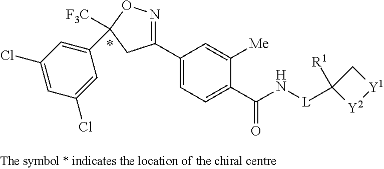 | |

| Comp | Stereochemistry | | | | |
|---|---|---|---|---|---|
| No. | at * | L | R¹ | Y¹ | Y² |
| 1 | racemic mixture | bond | CH₃ | S | CH₂ |
| 2 | racemic mixture | bond | CH₃ | SO (cis) | CH₂ |
| 3 | racemic mixture | bond | CH₃ | SO (trans) | CH₂ |
| 4 | racemic mixture | bond | CH₃ | SO₂ | CH₂ |
| 5 | racemic mixture | bond | H | S | CH₂ |
| 6 | racemic mixture | bond | H | SO (cis) | CH₂ |
| 7 | racemic mixture | bond | H | SO (trans) | CH₂ |
| 8 | racemic mixture | bond | H | SO₂ | CH₂ |
| 9 | racemic mixture | CH₂ | CH₃ | CH₂ | S |
| 10 | racemic mixture | CH₂ | CH₃ | CH₂ | SO (cis) |
| 11 | racemic mixture | CH₂ | CH₃ | CH₂ | SO (trans) |
| 12 | racemic mixture | CH₂ | CH₃ | CH₂ | SO₂ |
| 13 | racemic mixture | CH₂ | H | CH₂ | S |
| 14 | racemic mixture | CH₂ | H | CH₂ | SO (cis) |
| 15 | racemic mixture | CH₂ | H | CH₂ | SO (trans) |
| 16 | racemic mixture | CH₂ | H | CH₂ | SO₂ |
| 19 | S | bond | CH₃ | S | CH₂ |
| 20 | S | bond | CH₃ | SO (cis) | CH₂ |
| 21 | S | bond | CH₃ | SO (trans) | CH₂ |
| 22 | S | bond | CH₃ | SO₂ | CH₂ |
| 23 | S | bond | H | S | CH₂ |
| 24 | S | bond | H | SO (cis) | CH₂ |
| 25 | S | bond | H | SO (trans) | CH₂ |
| 26 | S | bond | H | SO₂ | CH₂ |
| 27 | S | CH₂ | CH₃ | CH₂ | S |
| 28 | S | CH₂ | CH₃ | CH₂ | SO (cis) |
| 29 | S | CH₂ | CH₃ | CH₂ | SO (trans) |
| 30 | S | CH₂ | CH₃ | CH₂ | SO₂ |
| 31 | S | CH₂ | H | CH₂ | S |
| 32 | S | CH₂ | H | CH₂ | SO (cis) |
| 33 | S | CH₂ | H | CH₂ | SO (trans) |
| 34 | S | CH₂ | H | CH₂ | SO₂ |

The present invention includes all isomers of compounds of formula (I), salts and N-oxides thereof, including enantiomers, diastereomers and tautomers. Component A may be a mixture of any type of isomer of a compound of formula I, or may be substantially a single type of isomer. For example, where Y¹ or Y² is SO, component A may be a mixture of the cis and trans isomer in any ratio, e.g. in a molar ratio of 1:99 to 99:1, e.g. 10:1 to 1:10, e.g. a substantially 50:50 molar ratio. For example, in trans enriched mixtures of the compound of formula I, e.g. when Y¹ or Y² is SO, the molar proportion of the trans compound in the mixture compared to the total amount of both cis and trans is for example greater than 50%, e.g. at least 55, 60, 65, 70, 75, 80, 85, 90, 95, 96, 97, 98, or at least 99%. Likewise, in cis enriched mixtures of the compound of formula I (preferred), e.g. when Y¹ or Y² is SO, the molar proportion of the cis compound in the mixture compared to the total amount of both cis and trans is for example greater than 50%, e.g. at least 55, 60, 65, 70, 75, 80, 85, 90, 95, 96, 97, 98, or at least 99%. The compound of formula I may be enriched for the trans sulphoxide. Likewise, the compound of formula I may be enriched for the cis sulphoxide. Y¹ or Y² is SO for compounds 2, 3, 6, 7, 10, 11, 14, 15, 20, 21, 24, 25, 28, 29, 32 and 33 in Table 1. Each may be a mixture which is enriched for the cis or trans isomer respectively.

In one embodiment component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans and Pasteuria nishizawae; and component C is a compound selected from Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat.

In a further embodiment component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans and Pasteuria nishizawae; and component C is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad.

In yet another embodiment component B is a compound selected from Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat; and component C is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad.

In yet another embodiment component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans and Pasteuria nishizawae; and wherein the mixture comprises as component C, component C1 and component C2, wherein component C1 is a compound selected from Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat; and component C2 is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad.

In one embodiment of the invention component B is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad and component C is an insecticide which is selected from neonicotinoids, carbamates, diamides, spinosyns, phenylpyrazoles, pyrethroids, Pyrifluquinazone, Pymetrozine, Sulfoxaflor and Spirotetramat. Examples of neonicotinoids are Thiamethoxam, Clothianidin, Imidacloprid, Acetamiprid, Dinotefuran, Nitenpyram, Nithiazine, Flonicamid and Thiacloprid. Preferred neonicotinoids are Thiamethoxam, Imidacloprid and Clothianidin. Examples of carbamates include Thiodicarb, Aldicarb, Carbofuran, Furadan, Fenoxycarb, Carbaryl, Sevin, Ethienocarb, and Fenobucarb. Examples of diamides include Chlorantraniliprole, Cyantraniliprole, and Flubendiamide. Examples of spinosyns include Spinosad and Spinetoram. Examples of pyrethoids include Cyhalothrin, Lambda-cyhalothrin, Famma-cyhalothrin, and Tefluthrin. An example of phenylpyrazole is Fipronil.

In another embodiment of the invention component B is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad and component C is a fungicide. The fungicide is preferably selected from Azoxystrobin, Trifloxystrobin, Fluoxastrobin, Cyproconazole, Difenoconazole, Prothioconazole, Tebuconazole, Triticonazole, Fludioxonil, Ipconazole, Cyprodinil, Myclobutanil, Metalaxyl, Mefenoxam (also known as Metalaxyl-M), Sedaxane, Thiobendazole, Fluopyram, Penflufen, Fuxapyroxad and Penthiopyrad.

In another embodiment of the invention component B is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad and component C is a nematicide. The nematicide can be any nematicide known in the art. Examples include an Avermectin (e.g., Abamectin), carbamate nematicides (e.g., Aldicarb, Thiodicarb, Carbofuran, Carbosulfan, Oxamyl, Aldoxycarb, Ethoprop, Methomyl, Benomyl, Alanycarb, Iprodione), organophosphorus nematicides (e.g., Phenamiphos (Fenamiphos), Fensulfothion, Terbufos, Fosthiazate, Dimethoate, Phosphocarb, Dichlofenthion, Isamidofos, Fosthietan, Isazofos Ethoprophos, Cadusafos, Terbufos, Chlorpyrifos, Dichlofenthion, Heterophos, Isamidofos, Mecarphon, Phorate, Thionazin, Triazophos, Diamidafos, Fosthietan, Phosphamidon, Imicyafos), and certain fungicides, such as Captan, Thiophanate-methyl and Thiabendazole. Also included as a nematicide is a compound of formula X,

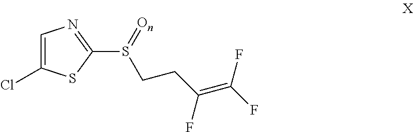

wherein n is 0, 1 or 2 and the thiazole ring may be optionally substituted. Abamectin, Aldicarb, Thiodicarb, Dimethoate, Ethomyl, a compound of formula X and Oxamyl are preferred nematicides for use in this invention.

In addition, nematicidally active biological agents can be included in the compositions of the invention. The nematicidally active biological agent refers to any biological agent that has nematicidal activity. The biological agent can be any type known in the art including bacteria and fungi. The wording “nematicidally active” refers to having an effect on, such as reduction in damage caused by, agricultural-related nematodes. The nematicidally active biological agent can be a bacterium or a fungus. Preferably, the biological agent is a bacterium. Examples of nematicidally active bacteria include Bacillus firmus, Bacillus cereus, Bacillus subtilis, Pasteuria penetrans and Pasteuria nishizawae. A suitable Bacillus firmus strain is strain CNCM 1-1582 which is commercially available as BioNem™. A suitable Bacillus cereus strain is strain CNCM 1-1562. Of both Bacillus strains more details can be found in U.S. Pat. No. 6,406,690.

In one embodiment component C is a compound selected from Thiamethoxam, Clothianidin, Nithiazine, Flonicamid, Imidacloprid, Acetamiprid, Dinotefuran, Nitenpyram, Thiacloprid, Thiodicarb, Aldicarb, Carbofuran, Furadan, Fenoxycarb, Carbaryl, Sevin, Ethienocarb, Fenobucarb, Chlorantraniliprole, Cyantraniliprole, Flubendiamide, Spinosad, Spinetoram, Cyhalothrin, Lambda-cyhalothrin, Gamma-cyhalothrin, Tefluthrin, Fipronil, Azoxystrobin, Trifloxystrobin, Fluoxastrobin, Cyproconazole, Difenoconazole, Prothioconazole, Tebuconazole, Triticonazole, Fludioxonil, Thiabendazole, Ipconazole, Cyprodinil, Myclobutanil, Metalaxyl, Mefenoxam, Sedaxane, Fluopyram, Penflufen, Fuxapyroxad, Abamectin, Aldicarb, Thiodicarb, Carbofuran, Carbosulfan, Oxamyl, Aldoxycarb, Ethoprop, Methomyl, Benomyl, Alanycarb, Iprodione, Phenamiphos, Fensulfothion, Terbufos, Fosthiazate, Dimethoate, Phosphocarb, Dichlofenthion, Isamidofos, Fosthietan, Isazofos, Ethoprophos, Cadusafos, Terbufos, Chlorpyrifos, Dichlofenthion, Heterophos, Isamidofos, Mecarphon, Phorate, Thionazin, Triazophos, Diamidafos, Fosthietan, Phosphamidon, Imicyafos, Captan, Thiophanate-methyl, Thiabendazole, a compound of formula X, Pyrifluquinazone, Pymetrozine, Sulfoxaflor and Spirotetramat, Bacillus firmus, Bacillus subtilis, Pasteuria penetrans and Pasteuria nishizawae.

In one embodiment component component B is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad and C is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans and Pasteuria nishizawae.

In one embodiment component B is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad and component C is a compound selected from Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat.

In one embodiment component B is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad and component C is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad, provided that components B and C are different.

In a further embodiment component B is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad and the pesticidal mixture comprises, as component C, component C1 and component C2, wherein component C1 is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans and Pasteuria nishizawae; and component C2 is a compound selected from Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat. Reference herein to component C includes reference to component C1 and component C2.

The following are particularly preferred embodiments:

A compound of formula I with thiamethoxam and lambda cyhalothrin.

A compound of formula I with abamectin and lambda cyhalothrin.

A compound of formula I with spirotetramat and lambda cyhalothrin.

A compound of formula I with sulfoxaflor and lambda cyhalothrin.

A compound of formula I with a compound of formula II and lambda cyhalothrin.

A compound of formula I with a compound of formula II and sulfoxaflor.

A compound of formula I with a compound of formula II and abamectin.

A compound of formula I with a compound of formula II and thiamethoxam.

A compound of formula I with azoxystrobin and lambda cyhalothrin.

A compound of formula I with azoxystrobin and sulfoxaflor.

A compound of formula I with azoxystrobin and abamectin.

A compound of formula I with azoxystrobin and thiamethoxam.

In one embodiment component C is M. anisopliae. It can be noted that M. anisopliae may also be used in combination with compound of formula I without a further active ingredient, and which may produce a synergistic effect.

In all embodiments of the invention components B and C are different.

The invention in particular relates to the following combinations described in the tables below, which may act synergistically. Synergism may also arise from combination of compounds of formula I with B and C separately.

| A | B | C | A | B | C |
|---|---|---|---|---|---|
| T1 | Sedaxane | Tefluthrin | T1 | Sedaxane | Lambda- |
| | | | | | cyhalothrin |
| T1 | Fludioxonil | Tefluthrin | T1 | Fludioxonil | Lambda- |
| | | | | | cyhalothrin |
| T1 | Metalaxyl | Tefluthrin | T1 | Metalaxyl | Lambda- |
| | | | | | cyhalothrin |
| T1 | Mefenoxam | Tefluthrin | T1 | Mefenoxam | Lambda- |
| | | | | | cyhalothrin |
| T1 | Cyprodinil | Tefluthrin | T1 | Cyprodinil | Lambda- |
| | | | | | cyhalothrin |
| T1 | Azoxystrobin | Tefluthrin | T1 | Azoxystrobin | Lambda- |
| | | | | | cyhalothrin |
| T1 | Tebuconazole | Tefluthrin | T1 | Tebuconazole | Lambda- |
| | | | | | cyhalothrin |
| T1 | Difenoconazole | Tefluthrin | T1 | Difenoconazole | Lambda- |
| | | | | | cyhalothrin |
| T1 | Thiabendazole | Tefluthrin | T1 | Thiabendazole | Lambda- |
| | | | | | cyhalothrin |
| T1 | Fluopyram | Tefluthrin | T1 | Fluopyram | Lambda- |
| | | | | | cyhalothrin |
| T1 | Penflufen | Tefluthrin | T1 | Penflufen | Lambda- |
| | | | | | cyhalothrin |
| T1 | Fuxapyroxad | Tefluthrin | T1 | Fuxapyroxad | Lambda- |
| | | | | | cyhalothrin |
| T1 | Sedaxane | Abamectin | T1 | Sedaxane | Spinosad |
| T1 | Fludioxonil | Abamectin | T1 | Fludioxonil | Spinosad |
| T1 | Metalaxyl | Abamectin | T1 | Metalaxyl | Spinosad |
| T1 | Mefenoxam | Abamectin | T1 | Mefenoxam | Spinosad |
| T1 | Cyprodinil | Abamectin | T1 | Cyprodinil | Spinosad |
| T1 | Azoxystrobin | Abamectin | T1 | Azoxystrobin | Spinosad |
| T1 | Tebuconazole | Abamectin | T1 | Tebuconazole | Spinosad |
| T1 | Difenoconazole | Abamectin | T1 | Difenoconazole | Spinosad |
| T1 | Thiabendazole | Abamectin | T1 | Thiabendazole | Spinosad |
| T1 | Fluopyram | Abamectin | T1 | Fluopyram | Spinosad |
| T1 | Penflufen | Abamectin | T1 | Penflufen | Spinosad |
| T1 | Fuxapyroxad | Abamectin | T1 | Fuxapyroxad | Spinosad |
| T1 | Sedaxane | Spinetoram | T1 | Sedaxane | Chlorpyrifos |
| T1 | Fludioxonil | Spinetoram | T1 | Fludioxonil | Chlorpyrifos |
| T1 | Metalaxyl | Spinetoram | T1 | Metalaxyl | Chlorpyrifos |
| T1 | Mefenoxam | Spinetoram | T1 | Mefenoxam | Chlorpyrifos |
| T1 | Cyprodinil | Spinetoram | T1 | Cyprodinil | Chlorpyrifos |
| T1 | Azoxystrobin | Spinetoram | T1 | Azoxystrobin | Chlorpyrifos |
| T1 | Tebuconazole | Spinetoram | T1 | Tebuconazole | Chlorpyrifos |
| T1 | Difenoconazole | Spinetoram | T1 | Difenoconazole | Chlorpyrifos |
| T1 | Thiabendazole | Spinetoram | T1 | Thiabendazole | Chlorpyrifos |
| T1 | Fluopyram | Spinetoram | T1 | Fluopyram | Chlorpyrifos |
| T1 | Penflufen | Spinetoram | T1 | Penflufen | Chlorpyrifos |
| T1 | Fuxapyroxad | Spinetoram | T1 | Fuxapyroxad | Chlorpyrifos |
| T1 | Sedaxane | Thiodicarb | T1 | Sedaxane | Chlorantraniliprole |
| T1 | Fludioxonil | Thiodicarb | T1 | Fludioxonil | Chlorantraniliprole |
| T1 | Metalaxyl | Thiodicarb | T1 | Metalaxyl | Chlorantraniliprole |
| T1 | Mefenoxam | Thiodicarb | T1 | Mefenoxam | Chlorantraniliprole |
| T1 | Cyprodinil | Thiodicarb | T1 | Cyprodinil | Chlorantraniliprole |
| T1 | Azoxystrobin | Thiodicarb | T1 | Azoxystrobin | Chlorantraniliprole |
| T1 | Tebuconazole | Thiodicarb | T1 | Tebuconazole | Chlorantraniliprole |
| T1 | Difenoconazole | Thiodicarb | T1 | Difenoconazole | Chlorantraniliprole |
| T1 | Thiabendazole | Thiodicarb | T1 | Thiabendazole | Chlorantraniliprole |
| T1 | Fluopyram | Thiodicarb | T1 | Fluopyram | Chlorantraniliprole |
| T1 | Penflufen | Thiodicarb | T1 | Penflufen | Chlorantraniliprole |
| T1 | Fuxapyroxad | Thiodicarb | T1 | Fuxapyroxad | Chlorantraniliprole |
| T1 | Sedaxane | Cyantraniliprole | T1 | Sedaxane | Bacillus firmus |
| T1 | Fludioxonil | Cyantraniliprole | T1 | Fludioxonil | Bacillus firmus |
| T1 | Metalaxyl | Cyantraniliprole | T1 | Metalaxyl | Bacillus firmus |
| T1 | Mefenoxam | Cyantraniliprole | T1 | Mefenoxam | Bacillus firmus |
| T1 | Cyprodinil | Cyantraniliprole | T1 | Cyprodinil | Bacillus firmus |
| T1 | Azoxystrobin | Cyantraniliprole | T1 | Azoxystrobin | Bacillus firmus |
| T1 | Tebuconazole | Cyantraniliprole | T1 | Tebuconazole | Bacillus firmus |
| T1 | Difenoconazole | Cyantraniliprole | T1 | Difenoconazole | Bacillus firmus |
| T1 | Thiabendazole | Cyantraniliprole | T1 | Thiabendazole | Bacillus firmus |
| T1 | Fluopyram | Cyantraniliprole | T1 | Fluopyram | Bacillus firmus |
| T1 | Penflufen | Cyantraniliprole | T1 | Penflufen | Bacillus firmus |
| T1 | Fuxapyroxad | Cyantraniliprole | T1 | Fuxapyroxad | Bacillus firmus |
| T1 | Sedaxane | Bacillus subtilis | T1 | Sedaxane | Pasteuria penetrans |
| T1 | Fludioxonil | Bacillus subtilis | T1 | Fludioxonil | Pasteuria penetrans |
| T1 | Metalaxyl | Bacillus subtilis | T1 | Metalaxyl | Pasteuria penetrans |
| T1 | Mefenoxam | Bacillus subtilis | T1 | Mefenoxam | Pasteuria penetrans |
| T1 | Cyprodinil | Bacillus subtilis | T1 | Cyprodinil | Pasteuria penetrans |
| T1 | Azoxystrobin | Bacillus subtilis | T1 | Azoxystrobin | Pasteuria penetrans |
| T1 | Tebuconazole | Bacillus subtilis | T1 | Tebuconazole | Pasteuria penetrans |
| T1 | Difenoconazole | Bacillus subtilis | T1 | Difenoconazole | Pasteuria penetrans |
| T1 | Thiabendazole | Bacillus subtilis | T1 | Thiabendazole | Pasteuria penetrans |
| T1 | Fluopyram | Bacillus subtilis | T1 | Fluopyram | Pasteuria penetrans |
| T1 | Penflufen | Bacillus subtilis | T1 | Penflufen | Pasteuria penetrans |
| T1 | Fuxapyroxad | Bacillus subtilis | T1 | Fuxapyroxad | Pasteuria penetrans |

| A | B | C | A | B | C |
|---|---|---|---|---|---|
| T1 | Sedaxane | Imidacloprid | T1 | Sedaxane | Thiacloprid |
| T1 | Fludioxonil | Imidacloprid | T1 | Fludioxonil | Thiacloprid |
| T1 | Metalaxyl | Imidacloprid | T1 | Metalaxyl | Thiacloprid |
| T1 | Mefenoxam | Imidacloprid | T1 | Mefenoxam | Thiacloprid |
| T1 | Cyprodinil | Imidacloprid | T1 | Cyprodinil | Thiacloprid |
| T1 | Azoxystrobin | Imidacloprid | T1 | Azoxystrobin | Thiacloprid |
| T1 | Tebuconazole | Imidacloprid | T1 | Tebuconazole | Thiacloprid |
| T1 | Difenoconazole | Imidacloprid | T1 | Difenoconazole | Thiacloprid |
| T1 | Thiabendazole | Imidacloprid | T1 | Thiabendazole | Thiacloprid |
| T1 | Fluopyram | Imidacloprid | T1 | Fluopyram | Thiacloprid |
| T1 | Penflufen | Imidacloprid | T1 | Penflufen | Thiacloprid |
| T1 | Fuxapyroxad | Imidacloprid | T1 | Fuxapyroxad | Thiacloprid |
| T1 | Sedaxane | Acetamiprid | T1 | Sedaxane | Nitenpyram |
| T1 | Fludioxonil | Acetamiprid | T1 | Fludioxonil | Nitenpyram |
| T1 | Metalaxyl | Acetamiprid | T1 | Metalaxyl | Nitenpyram |
| T1 | Mefenoxam | Acetamiprid | T1 | Mefenoxam | Nitenpyram |
| T1 | Cyprodinil | Acetamiprid | T1 | Cyprodinil | Nitenpyram |
| T1 | Azoxystrobin | Acetamiprid | T1 | Azoxystrobin | Nitenpyram |
| T1 | Tebuconazole | Acetamiprid | T1 | Tebuconazole | Nitenpyram |
| T1 | Difenoconazole | Acetamiprid | T1 | Difenoconazole | Nitenpyram |
| T1 | Thiabendazole | Acetamiprid | T1 | Thiabendazole | Nitenpyram |
| T1 | Fluopyram | Acetamiprid | T1 | Fluopyram | Nitenpyram |
| T1 | Penflufen | Acetamiprid | T1 | Penflufen | Nitenpyram |
| T1 | Fuxapyroxad | Acetamiprid | T1 | Fuxapyroxad | Nitenpyram |
| T1 | Sedaxane | Dinotefuran | T1 | Sedaxane | Thiamethoxam |
| T1 | Fludioxonil | Dinotefuran | T1 | Fludioxonil | Thiamethoxam |
| T1 | Metalaxyl | Dinotefuran | T1 | Metalaxyl | Thiamethoxam |
| T1 | Mefenoxam | Dinotefuran | T1 | Mefenoxam | Thiamethoxam |
| T1 | Cyprodinil | Dinotefuran | T1 | Cyprodinil | Thiamethoxam |
| T1 | Azoxystrobin | Dinotefuran | T1 | Azoxystrobin | Thiamethoxam |
| T1 | Tebuconazole | Dinotefuran | T1 | Tebuconazole | Thiamethoxam |
| T1 | Difenoconazole | Dinotefuran | T1 | Difenoconazole | Thiamethoxam |
| T1 | Thiabendazole | Dinotefuran | T1 | Thiabendazole | Thiamethoxam |
| T1 | Fluopyram | Dinotefuran | T1 | Fluopyram | Thiamethoxam |
| T1 | Penflufen | Dinotefuran | T1 | Penflufen | Thiamethoxam |
| T1 | Fuxapyroxad | Dinotefuran | T1 | Fuxapyroxad | Thiamethoxam |
| T1 | Sedaxane | Clothianidin | T1 | Sedaxane | Nithiazine |
| T1 | Fludioxonil | Clothianidin | T1 | Fludioxonil | Nithiazine |
| T1 | Metalaxyl | Clothianidin | T1 | Metalaxyl | Nithiazine |
| T1 | Mefenoxam | Clothianidin | T1 | Mefenoxam | Nithiazine |
| T1 | Cyprodinil | Clothianidin | T1 | Cyprodinil | Nithiazine |
| T1 | Azoxystrobin | Clothianidin | T1 | Azoxystrobin | Nithiazine |
| T1 | Tebuconazole | Clothianidin | T1 | Tebuconazole | Nithiazine |
| T1 | Difenoconazole | Clothianidin | T1 | Difenoconazole | Nithiazine |
| T1 | Thiabendazole | Clothianidin | T1 | Thiabendazole | Nithiazine |
| T1 | Fluopyram | Clothianidin | T1 | Fluopyram | Nithiazine |
| T1 | Penflufen | Clothianidin | T1 | Penflufen | Nithiazine |
| T1 | Fuxapyroxad | Clothianidin | T1 | Fuxapyroxad | Nithiazine |
| T1 | Sedaxane | Flonicamid | T1 | Sedaxane | Fipronil |
| T1 | Fludioxonil | Flonicamid | T1 | Fludioxonil | Fipronil |
| T1 | Metalaxyl | Flonicamid | T1 | Metalaxyl | Fipronil |
| T1 | Mefenoxam | Flonicamid | T1 | Mefenoxam | Fipronil |
| T1 | Cyprodinil | Flonicamid | T1 | Cyprodinil | Fipronil |
| T1 | Azoxystrobin | Flonicamid | T1 | Azoxystrobin | Fipronil |
| T1 | Tebuconazole | Flonicamid | T1 | Tebuconazole | Fipronil |
| T1 | Difenoconazole | Flonicamid | T1 | Difenoconazole | Fipronil |
| T1 | Thiabendazole | Flonicamid | T1 | Thiabendazole | Fipronil |
| T1 | Fluopyram | Flonicamid | T1 | Fluopyram | Fipronil |
| T1 | Penflufen | Flonicamid | T1 | Penflufen | Fipronil |
| T1 | Fuxapyroxad | Flonicamid | T1 | Fuxapyroxad | Fipronil |
| T1 | Sedaxane | Pyrifluquinazone | T1 | Sedaxane | Pymetrozine |
| T1 | Fludioxonil | Pyrifluquinazone | T1 | Fludioxonil | Pymetrozine |
| T1 | Metalaxyl | Pyrifluquinazone | T1 | Metalaxyl | Pymetrozine |
| T1 | Mefenoxam | Pyrifluquinazone | T1 | Mefenoxam | Pymetrozine |
| T1 | Cyprodinil | Pyrifluquinazone | T1 | Cyprodinil | Pymetrozine |
| T1 | Azoxystrobin | Pyrifluquinazone | T1 | Azoxystrobin | Pymetrozine |
| T1 | Tebuconazole | Pyrifluquinazone | T1 | Tebuconazole | Pymetrozine |
| T1 | Difenoconazole | Pyrifluquinazone | T1 | Difenoconazole | Pymetrozine |
| T1 | Thiabendazole | Pyrifluquinazone | T1 | Thiabendazole | Pymetrozine |
| T1 | Fluopyram | Pyrifluquinazone | T1 | Fluopyram | Pymetrozine |
| T1 | Penflufen | Pyrifluquinazone | T1 | Penflufen | Pymetrozine |
| T1 | Fuxapyroxad | Pyrifluquinazone | T1 | Fuxapyroxad | Pymetrozine |
| T1 | Sedaxane | Sulfoxaflor | T1 | Sedaxane | Spirotetramat |
| T1 | Fludioxonil | Sulfoxaflor | T1 | Fludioxonil | Spirotetramat |
| T1 | Metalaxyl | Sulfoxaflor | T1 | Metalaxyl | Spirotetramat |
| T1 | Mefenoxam | Sulfoxaflor | T1 | Mefenoxam | Spirotetramat |
| T1 | Cyprodinil | Sulfoxaflor | T1 | Cyprodinil | Spirotetramat |
| T1 | Azoxystrobin | Sulfoxaflor | T1 | Azoxystrobin | Spirotetramat |
| T1 | Tebuconazole | Sulfoxaflor | T1 | Tebuconazole | Spirotetramat |
| T1 | Difenoconazole | Sulfoxaflor | T1 | Difenoconazole | Spirotetramat |
| T1 | Thiabendazole | Sulfoxaflor | T1 | Thiabendazole | Spirotetramat |
| T1 | Fluopyram | Sulfoxaflor | T1 | Fluopyram | Spirotetramat |
| T1 | Penflufen | Sulfoxaflor | T1 | Penflufen | Spirotetramat |
| T1 | Fuxapyroxad | Sulfoxaflor | T1 | Fuxapyroxad | Spirotetramat |

| A | B | C | A | B | C |
|---|---|---|---|---|---|
| T1 | Sedaxane | Fludioxonil | T1 | Fludioxonil | Sedaxane |
| T1 | Sedaxane | Metalaxyl | T1 | Fludioxonil | Metalaxyl |
| T1 | Sedaxane | Mefenoxam | T1 | Fludioxonil | Mefenoxam |
| T1 | Sedaxane | Cyprodinil | T1 | Fludioxonil | Cyprodinil |
| T1 | Sedaxane | Azoxystrobin | T1 | Fludioxonil | Azoxystrobin |
| T1 | Sedaxane | Tebuconazole | T1 | Fludioxonil | Tebuconazole |
| T1 | Sedaxane | Difenoconazole | T1 | Fludioxonil | Difenoconazole |
| T1 | Sedaxane | Thiabendazole | T1 | Fludioxonil | Thiabendazole |
| T1 | Sedaxane | Fluopyram | T1 | Fludioxonil | Fluopyram |
| T1 | Sedaxane | Penflufen | T1 | Fludioxonil | Penflufen |
| T1 | Sedaxane | Fuxapyroxad | T1 | Fludioxonil | Fuxapyroxad |
| T1 | Metalaxyl | Fludioxonil | T1 | Mefenoxam | Fludioxonil |
| T1 | Metalaxyl | Sedaxane | T1 | Mefenoxam | Sedaxane |
| T1 | Metalaxyl | Mefenoxam | T1 | Mefenoxam | Metalaxyl |
| T1 | Metalaxyl | Cyprodinil | T1 | Mefenoxam | Cyprodinil |
| T1 | Metalaxyl | Azoxystrobin | T1 | Mefenoxam | Azoxystrobin |
| T1 | Metalaxyl | Tebuconazole | T1 | Mefenoxam | Tebuconazole |
| T1 | Metalaxyl | Difenoconazole | T1 | Mefenoxam | Difenoconazole |
| T1 | Metalaxyl | Thiabendazole | T1 | Mefenoxam | Thiabendazole |
| T1 | Metalaxyl | Fluopyram | T1 | Mefenoxam | Fluopyram |
| T1 | Metalaxyl | Penflufen | T1 | Mefenoxam | Penflufen |
| T1 | Metalaxyl | Fuxapyroxad | T1 | Mefenoxam | Fuxapyroxad |
| T1 | Cyprodinil | Fludioxonil | T1 | Azoxystrobin | Fludioxonil |
| T1 | Cyprodinil | Sedaxane | T1 | Azoxystrobin | Sedaxane |
| T1 | Cyprodinil | Mefenoxam | T1 | Azoxystrobin | Mefenoxam |
| T1 | Cyprodinil | Metalaxyl | T1 | Azoxystrobin | Cyprodinil |
| T1 | Cyprodinil | Azoxystrobin | T1 | Azoxystrobin | Metalaxayl |
| T1 | Cyprodinil | Tebuconazole | T1 | Azoxystrobin | Tebuconazole |
| T1 | Cyprodinil | Difenoconazole | T1 | Azoxystrobin | Difenoconazole |
| T1 | Cyprodinil | Thiabendazole | T1 | Azoxystrobin | Thiabendazole |
| T1 | Cyprodinil | Fluopyram | T1 | Azoxystrobin | Fluopyram |
| T1 | Cyprodinil | Penflufen | T1 | Azoxystrobin | Penflufen |
| T1 | Cyprodinil | Fuxapyroxad | T1 | Azoxystrobin | Fuxapyroxad |
| T1 | Tebuconazole | Fludioxonil | T1 | Difenoconazole | Fludioxonil |
| T1 | Tebuconazole | Sedaxane | T1 | Difenoconazole | Sedaxane |
| T1 | Tebuconazole | Mefenoxam | T1 | Difenoconazole | Mefenoxam |
| T1 | Tebuconazole | Cyprodinil | T1 | Difenoconazole | Cyprodinil |
| T1 | Tebuconazole | Azoxystrobin | T1 | Difenoconazole | Azoxystrobin |
| T1 | Tebuconazole | Metalaxyl | T1 | Difenoconazole | Tebuconazole |
| T1 | Tebuconazole | Difenoconazole | T1 | Difenoconazole | Metalaxyl |
| T1 | Tebuconazole | Thiabendazole | T1 | Difenoconazole | Thiabendazole |
| T1 | Tebuconazole | Fluopyram | T1 | Difenoconazole | Fluopyram |
| T1 | Tebuconazole | Penflufen | T1 | Difenoconazole | Penflufen |
| T1 | Tebuconazole | Fuxapyroxad | T1 | Difenoconazole | Fuxapyroxad |
| T1 | Thiabendazole | Fludioxonil | T1 | Fluopyram | Fludioxonil |
| T1 | Thiabendazole | Sedaxane | T1 | Fluopyram | Sedaxane |
| T1 | Thiabendazole | Mefenoxam | T1 | Fluopyram | Mefenoxam |
| T1 | Thiabendazole | Cyprodinil | T1 | Fluopyram | Cyprodinil |
| T1 | Thiabendazole | Azoxystrobin | T1 | Fluopyram | Azoxystrobin |
| T1 | Thiabendazole | Tebuconazole | T1 | Fluopyram | Tebuconazole |
| T1 | Thiabendazole | Difenoconazole | T1 | Fluopyram | Difenoconazole |
| T1 | Thiabendazole | Metalaxyl | T1 | Fluopyram | Thiabendazole |
| T1 | Thiabendazole | Fluopyram | T1 | Fluopyram | Metalaxyl |
| T1 | Thiabendazole | Penflufen | T1 | Fluopyram | Penflufen |
| T1 | Thiabendazole | Fuxapyroxad | T1 | Fluopyram | Fuxapyroxad |
| T1 | Penflufen | Fludioxonil | T1 | Fuxapyroxad | Fludioxonil |
| T1 | Penflufen | Sedaxane | T1 | Fuxapyroxad | Sedaxane |
| T1 | Penflufen | Mefenoxam | T1 | Fuxapyroxad | Mefenoxam |
| T1 | Penflufen | Cyprodinil | T1 | Fuxapyroxad | Cyprodinil |
| T1 | Penflufen | Azoxystrobin | T1 | Fuxapyroxad | Azoxystrobin |
| T1 | Penflufen | Tebuconazole | T1 | Fuxapyroxad | Tebuconazole |
| T1 | Penflufen | Difenoconazole | T1 | Fuxapyroxad | Difenoconazole |
| T1 | Penflufen | Thiabendazole | T1 | Fuxapyroxad | Thiabendazole |
| T1 | Penflufen | Fluopyram | T1 | Fuxapyroxad | Fluopyram |
| T1 | Penflufen | Metalaxyl | T1 | Fuxapyroxad | Penflufen |
| T1 | Penflufen | Fuxapyroxad | T1 | Fuxapyroxad | Metalaxyl |

| A | B | C | A | B | C |
|---|---|---|---|---|---|
| T1 | Tefluthrin | Imidacloprid | T1 | Lambda-cyhalothrin | Imidacloprid |
| T1 | Tefluthrin | Thiacloprid | T1 | Lambda-cyhalothrin | Thiacloprid |
| T1 | Tefluthrin | Acetamiprid | T1 | Lambda-cyhalothrin | Acetamiprid |
| T1 | Tefluthrin | Nitenpyram | T1 | Lambda-cyhalothrin | Nitenpyram |
| T1 | Tefluthrin | Dinotefuran | T1 | Lambda-cyhalothrin | Dinotefuran |
| T1 | Tefluthrin | Thiamethoxam | T1 | Lambda-cyhalothrin | Thiamethoxam |
| T1 | Tefluthrin | Clothianidin | T1 | Lambda-cyhalothrin | Clothianidin |
| T1 | Tefluthrin | Nithiazine | T1 | Lambda-cyhalothrin | Nithiazine |
| T1 | Tefluthrin | Flonicamid | T1 | Lambda-cyhalothrin | Flonicamid |
| T1 | Tefluthrin | Fipronil | T1 | Lambda-cyhalothrin | Fipronil |
| T1 | Tefluthrin | Pyrifluquin- | T1 | Lambda-cyhalothrin | Pyrifluquin- |
| | | azone | | | azone |
| T1 | Tefluthrin | Pymetrozine | T1 | Lambda-cyhalothrin | Pymetrozine |
| T1 | Tefluthrin | Sulfoxaflor | T1 | Lambda-cyhalothrin | Sulfoxaflor |
| T1 | Tefluthrin | Spirotetramat | T1 | Lambda-cyhalothrin | Spirotetramat |
| T1 | Abamectin | Imidacloprid | T1 | Spinosad | Imidacloprid |
| T1 | Abamectin | Thiacloprid | T1 | Spinosad | Thiacloprid |
| T1 | Abamectin | Acetamiprid | T1 | Spinosad | Acetamiprid |
| T1 | Abamectin | Nitenpyram | T1 | Spinosad | Nitenpyram |
| T1 | Abamectin | Dinotefuran | T1 | Spinosad | Dinotefuran |
| T1 | Abamectin | Thiamethoxam | T1 | Spinosad | Thiamethoxam |
| T1 | Abamectin | Clothianidin | T1 | Spinosad | Clothianidin |
| T1 | Abamectin | Nithiazine | T1 | Spinosad | Nithiazine |
| T1 | Abamectin | Flonicamid | T1 | Spinosad | Flonicamid |
| T1 | Abamectin | Fipronil | T1 | Spinosad | Fipronil |
| T1 | Abamectin | Pyrifluquin- | T1 | Spinosad | Pyrifluquin- |
| | | azone | | | azone |
| T1 | Abamectin | Pymetrozine | T1 | Spinosad | Pymetrozine |
| T1 | Abamectin | Sulfoxaflor | T1 | Spinosad | Sulfoxaflor |
| T1 | Abamectin | Spirotetramat | T1 | Spinosad | Spirotetramat |
| T1 | Spinetoram | Imidacloprid | T1 | Chlorpyrifos | Imidacloprid |
| T1 | Spinetoram | Thiacloprid | T1 | Chlorpyrifos | Thiacloprid |
| T1 | Spinetoram | Acetamiprid | T1 | Chlorpyrifos | Acetamiprid |
| T1 | Spinetoram | Nitenpyram | T1 | Chlorpyrifos | Nitenpyram |
| T1 | Spinetoram | Dinotefuran | T1 | Chlorpyrifos | Dinotefuran |
| T1 | Spinetoram | Thiamethoxam | T1 | Chlorpyrifos | Thiamethoxam |
| T1 | Spinetoram | Clothianidin | T1 | Chlorpyrifos | Clothianidin |
| T1 | Spinetoram | Nithiazine | T1 | Chlorpyrifos | Nithiazine |
| T1 | Spinetoram | Flonicamid | T1 | Chlorpyrifos | Flonicamid |
| T1 | Spinetoram | Fipronil | T1 | Chlorpyrifos | Fipronil |
| T1 | Spinetoram | Pyrifluquin- | T1 | Chlorpyrifos | Pyrifluquin- |
| | | azone | | | azone |
| T1 | Spinetoram | Pymetrozine | T1 | Chlorpyrifos | Pymetrozine |
| T1 | Spinetoram | Sulfoxaflor | T1 | Chlorpyrifos | Sulfoxaflor |
| T1 | Spinetoram | Spirotetramat | T1 | Chlorpyrifos | Spirotetramat |
| T1 | Thiodicarb | Imidacloprid | T1 | Chlorantraniliprole | Imidacloprid |
| T1 | Thiodicarb | Thiacloprid | T1 | Chlorantraniliprole | Thiacloprid |
| T1 | Thiodicarb | Acetamiprid | T1 | Chlorantraniliprole | Acetamiprid |
| T1 | Thiodicarb | Nitenpyram | T1 | Chlorantraniliprole | Nitenpyram |
| T1 | Thiodicarb | Dinotefuran | T1 | Chlorantraniliprole | Dinotefuran |
| T1 | Thiodicarb | Thiamethoxam | T1 | Chlorantraniliprole | Thiamethoxam |
| T1 | Thiodicarb | Clothianidin | T1 | Chlorantraniliprole | Clothianidin |
| T1 | Thiodicarb | Nithiazine | T1 | Chlorantraniliprole | Nithiazine |
| T1 | Thiodicarb | Flonicamid | T1 | Chlorantraniliprole | Flonicamid |
| T1 | Thiodicarb | Fipronil | T1 | Chlorantraniliprole | Fipronil |
| T1 | Thiodicarb | Pyrifluquin- | T1 | Chlorantraniliprole | Pyrifluquin- |
| | | azone | | | azone |
| T1 | Thiodicarb | Pymetrozine | T1 | Chlorantraniliprole | Pymetrozine |
| T1 | Thiodicarb | Sulfoxaflor | T1 | Chlorantraniliprole | Sulfoxaflor |
| T1 | Thiodicarb | Spirotetramat | T1 | Chlorantraniliprole | Spirotetramat |
| T1 | Cyantraniliprole | Imidacloprid | T1 | Bacillus firmus | Imidacloprid |
| T1 | Cyantraniliprole | Thiacloprid | T1 | Bacillus firmus | Thiacloprid |
| T1 | Cyantraniliprole | Acetamiprid | T1 | Bacillus firmus | Acetamiprid |
| T1 | Cyantraniliprole | Nitenpyram | T1 | Bacillus firmus | Nitenpyram |
| T1 | Cyantraniliprole | Dinotefuran | T1 | Bacillus firmus | Dinotefuran |
| T1 | Cyantraniliprole | Thiamethoxam | T1 | Bacillus firmus | Thiamethoxam |
| T1 | Cyantraniliprole | Clothianidin | T1 | Bacillus firmus | Clothianidin |
| T1 | Cyantraniliprole | Nithiazine | T1 | Bacillus firmus | Nithiazine |
| T1 | Cyantraniliprole | Flonicamid | T1 | Bacillus firmus | Flonicamid |
| T1 | Cyantraniliprole | Fipronil | T1 | Bacillus firmus | Fipronil |
| T1 | Cyantraniliprole | Pyrifluquin- | T1 | Bacillus firmus | Pyrifluquin- |
| | | azone | | | azone |
| T1 | Cyantraniliprole | Pymetrozine | T1 | Bacillus firmus | Pymetrozine |
| T1 | Cyantraniliprole | Sulfoxaflor | T1 | Bacillus firmus | Sulfoxaflor |
| T1 | Cyantraniliprole | Spirotetramat | T1 | Bacillus firmus | Spirotetramat |
| T1 | Bacillus subtilis | Imidacloprid | T1 | Pasteuria penetrans | Imidacloprid |
| T1 | Bacillus subtilis | Thiacloprid | T1 | Pasteuria penetrans | Thiacloprid |
| T1 | Bacillus subtilis | Acetamiprid | T1 | Pasteuria penetrans | Acetamiprid |
| T1 | Bacillus subtilis | Nitenpyram | T1 | Pasteuria penetrans | Nitenpyram |
| T1 | Bacillus subtilis | Dinotefuran | T1 | Pasteuria penetrans | Dinotefuran |
| T1 | Bacillus subtilis | Thiamethoxam | T1 | Pasteuria penetrans | Thiamethoxam |
| T1 | Bacillus subtilis | Clothianidin | T1 | Pasteuria penetrans | Clothianidin |
| T1 | Bacillus subtilis | Nithiazine | T1 | Pasteuria penetrans | Nithiazine |
| T1 | Bacillus subtilis | Flonicamid | T1 | Pasteuria penetrans | Flonicamid |
| T1 | Bacillus subtilis | Fipronil | T1 | Pasteuria penetrans | Fipronil |
| T1 | Bacillus subtilis | Pyrifluquin- | T1 | Pasteuria penetrans | Pyrifluquin- |
| | | azone | | | azone |
| T1 | Bacillus subtilis | Pymetrozine | T1 | Pasteuria penetrans | Pymetrozine |
| T1 | Bacillus subtilis | Sulfoxaflor | T1 | Pasteuria penetrans | Sulfoxaflor |
| T1 | Bacillus subtilis | Spirotetramat | T1 | Pasteuria penetrans | Spirotetramat |

| A | B | C | A | B | C |
|---|---|---|---|---|---|
| T1 | Tefluthrin | Sedaxane | T1 | Lambda-cyhalothrin | Sedaxane |
| T1 | Tefluthrin | Fludioxonil | T1 | Lambda-cyhalothrin | Fludioxonil |
| T1 | Tefluthrin | Metalaxyl | T1 | Lambda-cyhalothrin | Metalaxyl |
| T1 | Tefluthrin | Mefenoxam | T1 | Lambda-cyhalothrin | Mefenoxam |
| T1 | Tefluthrin | Cyprodinil | T1 | Lambda-cyhalothrin | Cyprodinil |
| T1 | Tefluthrin | Azoxystrobin | T1 | Lambda-cyhalothrin | Azoxystrobin |
| T1 | Tefluthrin | Tebuconazole | T1 | Lambda-cyhalothrin | Tebuconazole |
| T1 | Tefluthrin | Difenoconazole | T1 | Lambda-cyhalothrin | Difenoconazole |
| T1 | Tefluthrin | Thiabendazole | T1 | Lambda-cyhalothrin | Thiabendazole |
| T1 | Tefluthrin | Fluopyram | T1 | Lambda-cyhalothrin | Fluopyram |
| T1 | Tefluthrin | Penflufen | T1 | Lambda-cyhalothrin | Penflufen |
| T1 | Tefluthrin | Fuxapyroxad | T1 | Lambda-cyhalothrin | Fuxapyroxad |
| T1 | Abamectin | Sedaxane | T1 | Spinosad | Sedaxane |
| T1 | Abamectin | Fludioxonil | T1 | Spinosad | Fludioxonil |
| T1 | Abamectin | Metalaxyl | T1 | Spinosad | Metalaxyl |
| T1 | Abamectin | Mefenoxam | T1 | Spinosad | Mefenoxam |
| T1 | Abamectin | Cyprodinil | T1 | Spinosad | Cyprodinil |
| T1 | Abamectin | Azoxystrobin | T1 | Spinosad | Azoxystrobin |
| T1 | Abamectin | Tebuconazole | T1 | Spinosad | Tebuconazole |
| T1 | Abamectin | Difenoconazole | T1 | Spinosad | Difenoconazole |
| T1 | Abamectin | Thiabendazole | T1 | Spinosad | Thiabendazole |
| T1 | Abamectin | Fluopyram | T1 | Spinosad | Fluopyram |
| T1 | Abamectin | Penflufen | T1 | Spinosad | Penflufen |
| T1 | Abamectin | Fuxapyroxad | T1 | Spinosad | Fuxapyroxad |
| T1 | Spinetoram | Sedaxane | T1 | Chlorpyrifos | Sedaxane |
| T1 | Spinetoram | Fludioxonil | T1 | Chlorpyrifos | Fludioxonil |
| T1 | Spinetoram | Metalaxyl | T1 | Chlorpyrifos | Metalaxyl |
| T1 | Spinetoram | Mefenoxam | T1 | Chlorpyrifos | Mefenoxam |
| T1 | Spinetoram | Cyprodinil | T1 | Chlorpyrifos | Cyprodinil |
| T1 | Spinetoram | Azoxystrobin | T1 | Chlorpyrifos | Azoxystrobin |
| T1 | Spinetoram | Tebuconazole | T1 | Chlorpyrifos | Tebuconazole |
| T1 | Spinetoram | Difenoconazole | T1 | Chlorpyrifos | Difenoconazole |
| T1 | Spinetoram | Thiabendazole | T1 | Chlorpyrifos | Thiabendazole |
| T1 | Spinetoram | Fluopyram | T1 | Chlorpyrifos | Fluopyram |
| T1 | Spinetoram | Penflufen | T1 | Chlorpyrifos | Penflufen |
| T1 | Spinetoram | Fuxapyroxad | T1 | Chlorpyrifos | Fuxapyroxad |
| T1 | Thiodicarb | Sedaxane | T1 | Chlorantraniliprole | Sedaxane |
| T1 | Thiodicarb | Fludioxonil | T1 | Chlorantraniliprole | Fludioxonil |
| T1 | Thiodicarb | Metalaxyl | T1 | Chlorantraniliprole | Metalaxyl |
| T1 | Thiodicarb | Mefenoxam | T1 | Chlorantraniliprole | Mefenoxam |
| T1 | Thiodicarb | Cyprodinil | T1 | Chlorantraniliprole | Cyprodinil |
| T1 | Thiodicarb | Azoxystrobin | T1 | Chlorantraniliprole | Azoxystrobin |
| T1 | Thiodicarb | Tebuconazole | T1 | Chlorantraniliprole | Tebuconazole |
| T1 | Thiodicarb | Difenoconazole | T1 | Chlorantraniliprole | Difenoconazole |
| T1 | Thiodicarb | Thiabendazole | T1 | Chlorantraniliprole | Thiabendazole |
| T1 | Thiodicarb | Fluopyram | T1 | Chlorantraniliprole | Fluopyram |
| T1 | Thiodicarb | Penflufen | T1 | Chlorantraniliprole | Penflufen |
| T1 | Thiodicarb | Fuxapyroxad | T1 | Chlorantraniliprole | Fuxapyroxad |
| T1 | Cyantraniliprole | Sedaxane | T1 | Bacillus firmus | Sedaxane |
| T1 | Cyantraniliprole | Fludioxonil | T1 | Bacillus firmus | Fludioxonil |
| T1 | Cyantraniliprole | Metalaxyl | T1 | Bacillus firmus | Metalaxyl |
| T1 | Cyantraniliprole | Mefenoxam | T1 | Bacillus firmus | Mefenoxam |
| T1 | Cyantraniliprole | Cyprodinil | T1 | Bacillus firmus | Cyprodinil |
| T1 | Cyantraniliprole | Azoxystrobin | T1 | Bacillus firmus | Azoxystrobin |
| T1 | Cyantraniliprole | Tebuconazole | T1 | Bacillus firmus | Tebuconazole |
| T1 | Cyantraniliprole | Difenoconazole | T1 | Bacillus firmus | Difenoconazole |
| T1 | Cyantraniliprole | Thiabendazole | T1 | Bacillus firmus | Thiabendazole |
| T1 | Cyantraniliprole | Fluopyram | T1 | Bacillus firmus | Fluopyram |
| T1 | Cyantraniliprole | Penflufen | T1 | Bacillus firmus | Penflufen |
| T1 | Cyantraniliprole | Fuxapyroxad | T1 | Bacillus firmus | Fuxapyroxad |
| T1 | Bacillus subtilis | Sedaxane | T1 | Pasteuria penetrans | Sedaxane |
| T1 | Bacillus subtilis | Fludioxonil | T1 | Pasteuria penetrans | Fludioxonil |
| T1 | Bacillus subtilis | Metalaxyl | T1 | Pasteuria penetrans | Metalaxyl |
| T1 | Bacillus subtilis | Mefenoxam | T1 | Pasteuria penetrans | Mefenoxam |
| T1 | Bacillus subtilis | Cyprodinil | T1 | Pasteuria penetrans | Cyprodinil |
| T1 | Bacillus subtilis | Azoxystrobin | T1 | Pasteuria penetrans | Azoxystrobin |
| T1 | Bacillus subtilis | Tebuconazole | T1 | Pasteuria penetrans | Tebuconazole |
| T1 | Bacillus subtilis | Difenoconazole | T1 | Pasteuria penetrans | Difenoconazole |
| T1 | Bacillus subtilis | Thiabendazole | T1 | Pasteuria penetrans | Thiabendazole |
| T1 | Bacillus subtilis | Fluopyram | T1 | Pasteuria penetrans | Fluopyram |
| T1 | Bacillus subtilis | Penflufen | T1 | Pasteuria penetrans | Penflufen |
| T1 | Bacillus subtilis | Fuxapyroxad | T1 | Pasteuria penetrans | Fuxapyroxad |

| A | B | C | A | B | C |
|---|---|---|---|---|---|
| T1 | Tefluthrin | Lambda- | T1 | Lambda-cyhalothrin | Tefluthrin |
| | | cyhalothrin | | | |
| T1 | Tefluthrin | Abamectin | T1 | Lambda-cyhalothrin | Abamectin |
| T1 | Tefluthrin | Spinosad | T1 | Lambda-cyhalothrin | Spinosad |
| T1 | Tefluthrin | Spinetoram | T1 | Lambda-cyhalothrin | Spinetoram |
| T1 | Tefluthrin | Chlorpyrifos | T1 | Lambda-cyhalothrin | Chlorpyrifos |
| T1 | Tefluthrin | Thiodicarb | T1 | Lambda-cyhalothrin | Thiodicarb |
| T1 | Tefluthrin | Chlorantranili- | T1 | Lambda-cyhalothrin | Chlorantranili- |
| | | prole | | | prole |
| T1 | Tefluthrin | Cyantranili- | T1 | Lambda-cyhalothrin | Cyantranili- |
| | | prole | | | prole |
| T1 | Tefluthrin | Bacillus firmus | T1 | Lambda-cyhalothrin | Bacillus firmus |
| T1 | Tefluthrin | Bacillus subtilis | T1 | Lambda-cyhalothrin | Bacillus subtilis |
| T1 | Tefluthrin | Pasteuria | T1 | Lambda-cyhalothrin | Pasteuria |
| | | penetrans | | | penetrans |
| T1 | Abamectin | Tefluthrin | T1 | Spinosad | Tefluthrin |
| T1 | Abamectin | Lambda- | T1 | Spinosad | Lambda- |
| | | cyhalothrin | | | cyhalothrin |
| T1 | Abamectin | Spinosad | T1 | Spinosad | Abamectin |
| T1 | Abamectin | Spinetoram | T1 | Spinosad | Spinetoram |
| T1 | Abamectin | Chlorpyrifos | T1 | Spinosad | Chlorpyrifos |
| T1 | Abamectin | Thiodicarb | T1 | Spinosad | Thiodicarb |
| T1 | Abamectin | Chlorantranili- | T1 | Spinosad | Chlorantranili- |
| | | prole | | | prole |
| T1 | Abamectin | Cyantranili- | T1 | Spinosad | Cyantranili- |
| | | prole | | | prole |
| T1 | Abamectin | Bacillus firmus | T1 | Spinosad | Bacillus firmus |
| T1 | Abamectin | Bacillus subtilis | T1 | Spinosad | Bacillus subtilis |
| T1 | Abamectin | Pasteuria | T1 | Spinosad | Pasteuria |
| | | penetrans | | | penetrans |
| T1 | Spinetoram | Tefluthrin | T1 | Chlorpyrifos | Tefluthrin |
| T1 | Spinetoram | Lambda- | T1 | Chlorpyrifos | Lambda- |
| | | cyhalothrin | | | cyhalothrin |
| T1 | Spinetoram | Abamectin | T1 | Chlorpyrifos | Abamectin |
| T1 | Spinetoram | Spinosad | T1 | Chlorpyrifos | Spinosad |
| T1 | Spinetoram | Chlorpyrifos | T1 | Chlorpyrifos | Chlorantranili- |
| | | | | | prole |
| T1 | Spinetoram | Thiodicarb | T1 | Chlorpyrifos | Thiodicarb |
| T1 | Spinetoram | Chlorantranili- | T1 | Chlorpyrifos | Chlorantranili- |
| | | prole | | | prole |
| T1 | Spinetoram | Cyantranili- | T1 | Chlorpyrifos | Cyantranili- |
| | | prole | | | prole |
| T1 | Spinetoram | Bacillus firmus | T1 | Chlorpyrifos | Bacillus firmus |
| T1 | Spinetoram | Bacillus subtilis | T1 | Chlorpyrifos | Bacillus subtilis |
| T1 | Spinetoram | Pasteuria | T1 | Chlorpyrifos | Pasteuria |
| | | penetrans | | | penetrans |
| T1 | Thiodicarb | Tefluthrin | T1 | Chlorantraniliprole | Tefluthrin |
| T1 | Thiodicarb | Lambda- | T1 | Chlorantraniliprole | Lambda- |
| | | cyhalothrin | | | cyhalothrin |
| T1 | Thiodicarb | Abamectin | T1 | Chlorantraniliprole | Abamectin |
| T1 | Thiodicarb | Spinosad | T1 | Chlorantraniliprole | Spinosad |
| T1 | Thiodicarb | Chlorantranili- | T1 | Chlorantraniliprole | Chlorantranili- |
| | | prole | | | prole |
| T1 | Thiodicarb | Chlorpyrifos | T1 | Chlorantraniliprole | Chlorpyrifos |
| T1 | Thiodicarb | Chlorantranili- | T1 | Chlorantraniliprole | Thiodicarb |
| | | prole | | | |
| T1 | Thiodicarb | Cyantranili- | T1 | Chlorantraniliprole | Cyantranili- |
| | | prole | | | prole |
| T1 | Thiodicarb | Bacillus firmus | T1 | Chlorantraniliprole | Bacillus firmus |
| T1 | Thiodicarb | Bacillus subtilis | T1 | Chlorantraniliprole | Bacillus subtilis |
| T1 | Thiodicarb | Pasteuria | T1 | Chlorantraniliprole | Pasteuria |
| | | penetrans | | | penetrans |
| T1 | Cyantraniliprole | Tefluthrin | T1 | Bacillus firmus | Tefluthrin |
| T1 | Cyantraniliprole | Lambda- | T1 | Bacillus firmus | Lambda- |
| | | cyhalothrin | | | cyhalothrin |
| T1 | Cyantraniliprole | Abamectin | T1 | Bacillus firmus | Abamectin |
| T1 | Cyantraniliprole | Spinosad | T1 | Bacillus firmus | Spinosad |
| T1 | Cyantraniliprole | Chlorantranili- | T1 | Bacillus firmus | Chlorantranili- |
| | | prole | | | prole |
| T1 | Cyantraniliprole | Chlorpyrifos | T1 | Bacillus firmus | Chlorpyrifos |
| T1 | Cyantraniliprole | Thiodicarb | T1 | Bacillus firmus | Thiodicarb |
| T1 | Cyantraniliprole | Chlorantraniliprole | T1 | Bacillus firmus | Chlorantranili- |
| | | | | | prole |
| T1 | Cyantraniliprole | Bacillus firmus | T1 | Bacillus firmus | Cyantranili- |
| | | | | | prole |
| T1 | Cyantraniliprole | Bacillus subtilis | T1 | Bacillus firmus | Bacillus subtilis |
| T1 | Cyantraniliprole | Pasteuria | T1 | Bacillus firmus | Pasteuria |
| | | penetrans | | | penetrans |
| T1 | Bacillus subtilis | Tefluthrin | T1 | Pasteuria penetrans | Tefluthrin |
| T1 | Bacillus subtilis | Lambda- | T1 | Pasteuria penetrans | Lambda- |
| | | cyhalothrin | | | cyhalothrin |
| T1 | Bacillus subtilis | Abamectin | T1 | Pasteuria penetrans | Abamectin |
| T1 | Bacillus subtilis | Spinosad | T1 | Pasteuria penetrans | Spinosad |
| T1 | Bacillus subtilis | Chlorantranili- | T1 | Pasteuria penetrans | Chlorantranili- |
| | | prole | | | prole |
| T1 | Bacillus subtilis | Chlorpyrifos | T1 | Pasteuria penetrans | Chlorpyrifos |
| T1 | Bacillus subtilis | Thiodicarb | T1 | Pasteuria penetrans | Thiodicarb |
| T1 | Bacillus subtilis | Chlorantranili- | T1 | Pasteuria penetrans | Chlorantranili- |
| | | prole | | | prole |
| T1 | Bacillus subtilis | Cyantranili- | T1 | Pasteuria penetrans | Cyantranili- |
| | | prole | | | prole |
| T1 | Bacillus subtilis | Bacillus firmus | T1 | Pasteuria penetrans | Bacillus firmus |
| T1 | Bacillus subtilis | Pasteuria | T1 | Pasteuria penetrans | Bacillus subtilis |
| | | penetrans | | | |

| A | B | C | A | B | C |
|---|---|---|---|---|---|
| T1 | Imidacloprid | Sedaxane | T1 | Thiacloprid | Sedaxane |
| T1 | Imidacloprid | Fludioxonil | T1 | Thiacloprid | Fludioxonil |
| T1 | Imidacloprid | Metalaxyl | T1 | Thiacloprid | Metalaxyl |
| T1 | Imidacloprid | Mefenoxam | T1 | Thiacloprid | Mefenoxam |
| T1 | Imidacloprid | Cyprodinil | T1 | Thiacloprid | Cyprodinil |
| T1 | Imidacloprid | Azoxystrobin | T1 | Thiacloprid | Azoxystrobin |
| T1 | Imidacloprid | Tebuconazole | T1 | Thiacloprid | Tebuconazole |
| T1 | Imidacloprid | Difenoconazole | T1 | Thiacloprid | Difenoconazole |
| T1 | Imidacloprid | Thiabendazole | T1 | Thiacloprid | Thiabendazole |
| T1 | Imidacloprid | Fluopyram | T1 | Thiacloprid | Fluopyram |
| T1 | Imidacloprid | Penflufen | T1 | Thiacloprid | Penflufen |
| T1 | Imidacloprid | Fuxapyroxad | T1 | Thiacloprid | Fuxapyroxad |
| T1 | Acetamiprid | Sedaxane | T1 | Nitenpyram | Sedaxane |
| T1 | Acetamiprid | Fludioxonil | T1 | Nitenpyram | Fludioxonil |
| T1 | Acetamiprid | Metalaxyl | T1 | Nitenpyram | Metalaxyl |
| T1 | Acetamiprid | Mefenoxam | T1 | Nitenpyram | Mefenoxam |
| T1 | Acetamiprid | Cyprodinil | T1 | Nitenpyram | Cyprodinil |
| T1 | Acetamiprid | Azoxystrobin | T1 | Nitenpyram | Azoxystrobin |
| T1 | Acetamiprid | Tebuconazole | T1 | Nitenpyram | Tebuconazole |
| T1 | Acetamiprid | Difenoconazole | T1 | Nitenpyram | Difenoconazole |
| T1 | Acetamiprid | Thiabendazole | T1 | Nitenpyram | Thiabendazole |
| T1 | Acetamiprid | Fluopyram | T1 | Nitenpyram | Fluopyram |
| T1 | Acetamiprid | Penflufen | T1 | Nitenpyram | Penflufen |
| T1 | Acetamiprid | Fuxapyroxad | T1 | Nitenpyram | Fuxapyroxad |
| T1 | Dinotefuran | Sedaxane | T1 | Thiamethoxam | Sedaxane |
| T1 | Dinotefuran | Fludioxonil | T1 | Thiamethoxam | Fludioxonil |
| T1 | Dinotefuran | Metalaxyl | T1 | Thiamethoxam | Metalaxyl |
| T1 | Dinotefuran | Mefenoxam | T1 | Thiamethoxam | Mefenoxam |
| T1 | Dinotefuran | Cyprodinil | T1 | Thiamethoxam | Cyprodinil |
| T1 | Dinotefuran | Azoxystrobin | T1 | Thiamethoxam | Azoxystrobin |
| T1 | Dinotefuran | Tebuconazole | T1 | Thiamethoxam | Tebuconazole |
| T1 | Dinotefuran | Difenoconazole | T1 | Thiamethoxam | Difenoconazole |
| T1 | Dinotefuran | Thiabendazole | T1 | Thiamethoxam | Thiabendazole |
| T1 | Dinotefuran | Fluopyram | T1 | Thiamethoxam | Fluopyram |
| T1 | Dinotefuran | Penflufen | T1 | Thiamethoxam | Penflufen |
| T1 | Dinotefuran | Fuxapyroxad | T1 | Thiamethoxam | Fuxapyroxad |
| T1 | Clothianidin | Sedaxane | T1 | Nithiazine | Sedaxane |
| T1 | Clothianidin | Fludioxonil | T1 | Nithiazine | Fludioxonil |
| T1 | Clothianidin | Metalaxyl | T1 | Nithiazine | Metalaxyl |
| T1 | Clothianidin | Mefenoxam | T1 | Nithiazine | Mefenoxam |
| T1 | Clothianidin | Cyprodinil | T1 | Nithiazine | Cyprodinil |
| T1 | Clothianidin | Azoxystrobin | T1 | Nithiazine | Azoxystrobin |
| T1 | Clothianidin | Tebuconazole | T1 | Nithiazine | Tebuconazole |
| T1 | Clothianidin | Difenoconazole | T1 | Nithiazine | Difenoconazole |
| T1 | Clothianidin | Thiabendazole | T1 | Nithiazine | Thiabendazole |
| T1 | Clothianidin | Fluopyram | T1 | Nithiazine | Fluopyram |
| T1 | Clothianidin | Penflufen | T1 | Nithiazine | Penflufen |
| T1 | Clothianidin | Fuxapyroxad | T1 | Nithiazine | Fuxapyroxad |
| T1 | Flonicamid | Sedaxane | T1 | Fipronil | Sedaxane |
| T1 | Flonicamid | Fludioxonil | T1 | Fipronil | Fludioxonil |
| T1 | Flonicamid | Metalaxyl | T1 | Fipronil | Metalaxyl |
| T1 | Flonicamid | Mefenoxam | T1 | Fipronil | Mefenoxam |
| T1 | Flonicamid | Cyprodinil | T1 | Fipronil | Cyprodinil |
| T1 | Flonicamid | Azoxystrobin | T1 | Fipronil | Azoxystrobin |
| T1 | Flonicamid | Tebuconazole | T1 | Fipronil | Tebuconazole |
| T1 | Flonicamid | Difenoconazole | T1 | Fipronil | Difenoconazole |
| T1 | Flonicamid | Thiabendazole | T1 | Fipronil | Thiabendazole |
| T1 | Flonicamid | Fluopyram | T1 | Fipronil | Fluopyram |
| T1 | Flonicamid | Penflufen | T1 | Fipronil | Penflufen |
| T1 | Flonicamid | Fuxapyroxad | T1 | Fipronil | Fuxapyroxad |
| T1 | Pyrifluquinazone | Sedaxane | T1 | Pymetrozine | Sedaxane |
| T1 | Pyrifluquinazone | Fludioxonil | T1 | Pymetrozine | Fludioxonil |
| T1 | Pyrifluquinazone | Metalaxyl | T1 | Pymetrozine | Metalaxyl |
| T1 | Pyrifluquinazone | Mefenoxam | T1 | Pymetrozine | Mefenoxam |
| T1 | Pyrifluquinazone | Cyprodinil | T1 | Pymetrozine | Cyprodinil |
| T1 | Pyrifluquinazone | Azoxystrobin | T1 | Pymetrozine | Azoxystrobin |
| T1 | Pyrifluquinazone | Tebuconazole | T1 | Pymetrozine | Tebuconazole |
| T1 | Pyrifluquinazone | Difenoconazole | T1 | Pymetrozine | Difenoconazole |
| T1 | Pyrifluquinazone | Thiabendazole | T1 | Pymetrozine | Thiabendazole |
| T1 | Pyrifluquinazone | Fluopyram | T1 | Pymetrozine | Fluopyram |
| T1 | Pyrifluquinazone | Penflufen | T1 | Pymetrozine | Penflufen |
| T1 | Pyrifluquinazone | Fuxapyroxad | T1 | Pymetrozine | Fuxapyroxad |
| T1 | Sulfoxaflor | Sedaxane | T1 | Spirotetramat | Sedaxane |
| T1 | Sulfoxaflor | Fludioxonil | T1 | Spirotetramat | Fludioxonil |
| T1 | Sulfoxaflor | Metalaxyl | T1 | Spirotetramat | Metalaxyl |
| T1 | Sulfoxaflor | Mefenoxam | T1 | Spirotetramat | Mefenoxam |
| T1 | Sulfoxaflor | Cyprodinil | T1 | Spirotetramat | Cyprodinil |
| T1 | Sulfoxaflor | Azoxystrobin | T1 | Spirotetramat | Azoxystrobin |
| T1 | Sulfoxaflor | Tebuconazole | T1 | Spirotetramat | Tebuconazole |
| T1 | Sulfoxaflor | Difenoconazole | T1 | Spirotetramat | Difenoconazole |
| T1 | Sulfoxaflor | Thiabendazole | T1 | Spirotetramat | Thiabendazole |
| T1 | Sulfoxaflor | Fluopyram | T1 | Spirotetramat | Fluopyram |
| T1 | Sulfoxaflor | Penflufen | T1 | Spirotetramat | Penflufen |
| T1 | Sulfoxaflor | Fuxapyroxad | T1 | Spirotetramat | Fuxapyroxad |

| A | B | C | A | B | C |
|---|---|---|---|---|---|
| T1 | Imidacloprid | Thiacloprid | T1 | Thiacloprid | Imidacloprid |
| T1 | Imidacloprid | Acetamiprid | T1 | Thiacloprid | Acetamiprid |
| T1 | Imidacloprid | Nitenpyram | T1 | Thiacloprid | Nitenpyram |
| T1 | Imidacloprid | Dinotefuran | T1 | Thiacloprid | Dinotefuran |
| T1 | Imidacloprid | Thiamethoxam | T1 | Thiacloprid | Thiamethoxam |
| T1 | Imidacloprid | Clothianidin | T1 | Thiacloprid | Clothianidin |
| T1 | Imidacloprid | Nithiazine | T1 | Thiacloprid | Nithiazine |
| T1 | Imidacloprid | Flonicamid | T1 | Thiacloprid | Flonicamid |
| T1 | Imidacloprid | Fipronil | T1 | Thiacloprid | Fipronil |
| T1 | Imidacloprid | Pyrifluquin- | T1 | Thiacloprid | Pyrifluquin- |
| | | azone | | | azone |
| T1 | Imidacloprid | Pymetrozine | T1 | Thiacloprid | Pymetrozine |
| T1 | Imidacloprid | Sulfoxaflor | T1 | Thiacloprid | Sulfoxaflor |
| T1 | Imidacloprid | Spirotetramat | T1 | Thiacloprid | Spirotetramat |
| T1 | Acetamiprid | Imidacloprid | T1 | Nitenpyram | Imidacloprid |
| T1 | Acetamiprid | Thiacloprid | T1 | Nitenpyram | Thiacloprid |
| T1 | Acetamiprid | Nitenpyram | T1 | Nitenpyram | Acetamiprid |
| T1 | Acetamiprid | Dinotefuran | T1 | Nitenpyram | Dinotefuran |
| T1 | Acetamiprid | Thiamethoxam | T1 | Nitenpyram | Thiamethoxam |
| T1 | Acetamiprid | Clothianidin | T1 | Nitenpyram | Clothianidin |
| T1 | Acetamiprid | Nithiazine | T1 | Nitenpyram | Nithiazine |
| T1 | Acetamiprid | Flonicamid | T1 | Nitenpyram | Flonicamid |
| T1 | Acetamiprid | Fipronil | T1 | Nitenpyram | Fipronil |
| T1 | Acetamiprid | Pyrifluquin- | T1 | Nitenpyram | Pyrifluquin- |
| | | azone | | | azone |
| T1 | Acetamiprid | Pymetrozine | T1 | Nitenpyram | Pymetrozine |
| T1 | Acetamiprid | Sulfoxaflor | T1 | Nitenpyram | Sulfoxaflor |
| T1 | Acetamiprid | Spirotetramat | T1 | Nitenpyram | Spirotetramat |
| T1 | Dinotefuran | Imidacloprid | T1 | Thiamethoxam | Imidacloprid |
| T1 | Dinotefuran | Thiacloprid | T1 | Thiamethoxam | Thiacloprid |
| T1 | Dinotefuran | Acetamiprid | T1 | Thiamethoxam | Acetamiprid |
| T1 | Dinotefuran | Nitenpyram | T1 | Thiamethoxam | Nitenpyram |
| T1 | Dinotefuran | Thiamethoxam | T1 | Thiamethoxam | Dinotefuran |
| T1 | Dinotefuran | Clothianidin | T1 | Thiamethoxam | Clothianidin |
| T1 | Dinotefuran | Nithiazine | T1 | Thiamethoxam | Nithiazine |
| T1 | Dinotefuran | Flonicamid | T1 | Thiamethoxam | Flonicamid |
| T1 | Dinotefuran | Fipronil | T1 | Thiamethoxam | Fipronil |
| T1 | Dinotefuran | Pyrifluquin- | T1 | Thiamethoxam | Pyrifluquin- |
| | | azone | | | azone |
| T1 | Dinotefuran | Pymetrozine | T1 | Thiamethoxam | Pymetrozine |
| T1 | Dinotefuran | Sulfoxaflor | T1 | Thiamethoxam | Sulfoxaflor |
| T1 | Dinotefuran | Spirotetramat | T1 | Thiamethoxam | Spirotetramat |
| T1 | Clothianidin | Imidacloprid | T1 | Nithiazine | Imidacloprid |
| T1 | Clothianidin | Thiacloprid | T1 | Nithiazine | Thiacloprid |
| T1 | Clothianidin | Acetamiprid | T1 | Nithiazine | Acetamiprid |
| T1 | Clothianidin | Nitenpyram | T1 | Nithiazine | Nitenpyram |
| T1 | Clothianidin | Dinotefuran | T1 | Nithiazine | Dinotefuran |
| T1 | Clothianidin | Thiamethoxam | T1 | Nithiazine | Thiamethoxam |
| T1 | Clothianidin | Nithiazine | T1 | Nithiazine | Clothianidin |
| T1 | Clothianidin | Flonicamid | T1 | Nithiazine | Flonicamid |
| T1 | Clothianidin | Fipronil | T1 | Nithiazine | Fipronil |
| T1 | Clothianidin | Pyrifluquin- | T1 | Nithiazine | Pyrifluquin- |
| | | azone | | | azone |
| T1 | Clothianidin | Pymetrozine | T1 | Nithiazine | Pymetrozine |
| T1 | Clothianidin | Sulfoxaflor | T1 | Nithiazine | Sulfoxaflor |
| T1 | Clothianidin | Spirotetramat | T1 | Nithiazine | Spirotetramat |
| T1 | Flonicamid | Imidacloprid | T1 | Fipronil | Imidacloprid |
| T1 | Flonicamid | Thiacloprid | T1 | Fipronil | Thiacloprid |
| T1 | Flonicamid | Acetamiprid | T1 | Fipronil | Acetamiprid |
| T1 | Flonicamid | Nitenpyram | T1 | Fipronil | Nitenpyram |
| T1 | Flonicamid | Dinotefuran | T1 | Fipronil | Dinotefuran |
| T1 | Flonicamid | Thiamethoxam | T1 | Fipronil | Thiamethoxam |
| T1 | Flonicamid | Clothianidin | T1 | Fipronil | Clothianidin |
| T1 | Flonicamid | Nithiazine | T1 | Fipronil | Nithiazine |
| T1 | Flonicamid | Fipronil | T1 | Fipronil | Flonicamid |
| T1 | Flonicamid | Pyrifluquin- | T1 | Fipronil | Pyrifluquin- |
| | | azone | | | azone |
| T1 | Flonicamid | Pymetrozine | T1 | Fipronil | Pymetrozine |
| T1 | Flonicamid | Sulfoxaflor | T1 | Fipronil | Sulfoxaflor |
| T1 | Flonicamid | Spirotetramat | T1 | Fipronil | Spirotetramat |
| T1 | Pyrifluquinazone | Imidacloprid | T1 | Pymetrozine | Imidacloprid |
| T1 | Pyrifluquinazone | Thiacloprid | T1 | Pymetrozine | Thiacloprid |
| T1 | Pyrifluquinazone | Acetamiprid | T1 | Pymetrozine | Acetamiprid |
| T1 | Pyrifluquinazone | Nitenpyram | T1 | Pymetrozine | Nitenpyram |
| T1 | Pyrifluquinazone | Dinotefuran | T1 | Pymetrozine | Dinotefuran |
| T1 | Pyrifluquinazone | Thiamethoxam | T1 | Pymetrozine | Thiamethoxam |
| T1 | Pyrifluquinazone | Clothianidin | T1 | Pymetrozine | Clothianidin |
| T1 | Pyrifluquinazone | Nithiazine | T1 | Pymetrozine | Nithiazine |
| T1 | Pyrifluquinazone | Flonicamid | T1 | Pymetrozine | Flonicamid |
| T1 | Pyrifluquinazone | Fipronil | T1 | Pymetrozine | Fipronil |
| T1 | Pyrifluquinazone | Pymetrozine | T1 | Pymetrozine | Pyrifluquin- |
| | | | | | azone |
| T1 | Pyrifluquinazone | Sulfoxaflor | T1 | Pymetrozine | Sulfoxaflor |
| T1 | Pyrifluquinazone | Spirotetramat | T1 | Pymetrozine | Spirotetramat |
| T1 | Sulfoxaflor | Imidacloprid | T1 | Spirotetramat | Imidacloprid |
| T1 | Sulfoxaflor | Thiacloprid | T1 | Spirotetramat | Thiacloprid |
| T1 | Sulfoxaflor | Acetamiprid | T1 | Spirotetramat | Acetamiprid |
| T1 | Sulfoxaflor | Nitenpyram | T1 | Spirotetramat | Nitenpyram |
| T1 | Sulfoxaflor | Dinotefuran | T1 | Spirotetramat | Dinotefuran |
| T1 | Sulfoxaflor | Thiamethoxam | T1 | Spirotetramat | Thiamethoxam |
| T1 | Sulfoxaflor | Clothianidin | T1 | Spirotetramat | Clothianidin |
| T1 | Sulfoxaflor | Nithiazine | T1 | Spirotetramat | Nithiazine |
| T1 | Sulfoxaflor | Flonicamid | T1 | Spirotetramat | Flonicamid |
| T1 | Sulfoxaflor | Fipronil | T1 | Spirotetramat | Fipronil |
| T1 | Sulfoxaflor | Pyrifluquin- | T1 | Spirotetramat | Pyrifluquin- |
| | | azone | | | azone |
| T1 | Sulfoxaflor | Pymetrozine | T1 | Spirotetramat | Pymetrozine |
| T1 | Sulfoxaflor | Spirotetramat | T1 | Spirotetramat | Sulfoxaflor |
| T1 | Comopund II | Sedaxane | T1 | Comopund II | Imidacloprid |
| T1 | Comopund II | Fludioxonil | T1 | Comopund II | Thiacloprid |
| T1 | Comopund II | Metalaxyl | T1 | Comopund II | Acetamiprid |
| T1 | Comopund II | Mefenoxam | T1 | Comopund II | Nitenpyram |
| T1 | Comopund II | Cyprodinil | T1 | Comopund II | Dinotefuran |
| T1 | Comopund II | Azoxystrobin | T1 | Comopund II | Thiamethoxam |
| T1 | Comopund II | Tebuconazole | T1 | Comopund II | Clothianidin |
| T1 | Comopund II | Difenoconazole | T1 | Comopund II | Nithiazine |
| T1 | Comopund II | Thiabendazole | T1 | Comopund II | Flonicamid |
| T1 | Comopund II | Fluopyram | T1 | Comopund II | Fipronil |
| T1 | Comopund II | Penflufen | T1 | Comopund II | Pyrifluquin- |
| | | | | | azone |
| T1 | Comopund II | Fuxapyroxad | T1 | Comopund II | Pymetrozine |
| T1 | Comopund II | Spirotetramat | T1 | Comopund II | Sulfoxaflor |
| T1 | Comopund II | Tefluthrin | T1 | Sedaxane | Pasteuria |
| | | | | | nishizawae |
| T1 | Comopund II | Lambda- | T1 | Fludioxonil | Pasteuria |
| | | cyhalothrin | | | nishizawae |
| T1 | Comopund II | Abamectin | T1 | Metalaxyl | Pasteuria |
| | | | | | nishizawae |
| T1 | Comopund II | Spinetoram | T1 | Mefenoxam | Pasteuria |
| | | | | | nishizawae |
| T1 | Comopund II | Chlorpyrifos | T1 | Cyprodinil | Pasteuria |
| | | | | | nishizawae |
| T1 | Comopund II | Thiodicarb | T1 | Azoxystrobin | Pasteuria |
| | | | | | nishizawae |
| T1 | Comopund II | Chlorantranili- | T1 | Tebuconazole | Pasteuria |
| | | prole | | | nishizawae |
| T1 | Comopund II | Cyantranili-prole | T1 | Difenoconazole | Pasteuria |
| | | | | | nishizawae |
| T1 | Comopund II | Bacillus firmus | T1 | Thiabendazole | Pasteuria |
| | | | | | nishizawae |
| T1 | Comopund II | Bacillus subtilis | T1 | Fluopyram | Pasteuria |
| | | | | | nishizawae |
| T1 | Comopund II | Pasteuria | T1 | Penflufen | Pasteuria |
| | | penetrans | | | nishizawae |
| T1 | Comopund II | Spinosad | T1 | Fuxapyroxad | Pasteuria |
| | | | | | nishizawae |
| T1 | Pasteuria | Imidacloprid | | | |
| | nishizawae | | | | |
| T1 | Pasteuria | Thiacloprid | | | |
| | nishizawae | | | | |
| T1 | Pasteuria | Acetamiprid | | | |
| | nishizawae | | | | |
| T1 | Pasteuria | Nitenpyram | | | |
| | nishizawae | | | | |
| T1 | Pasteuria | Dinotefuran | | | |
| | nishizawae | | | | |
| T1 | Pasteuria | Thiamethoxam | | | |
| | nishizawae | | | | |
| T1 | Pasteuria | Clothianidin | | | |
| | nishizawae | | | | |
| T1 | Pasteuria | Nithiazine | | | |
| | nishizawae | | | | |
| T1 | Pasteuria | Flonicamid | | | |
| | nishizawae | | | | |
| T1 | Pasteuria | Fipronil | | | |
| | nishizawae | | | | |
| T1 | Pasteuria | Pyrifluquin-azone | | | |
| | nishizawae | | | | |
| T1 | Pasteuria | Pymetrozine | | | |
| | nishizawae | | | | |
| T1 | Pasteuria | Sulfoxaflor | | | |
| | nishizawae | | | | |
| T1 | Pasteuria | Spirotetramat | | | |
| | nishizawae | | | | |
| T1 | Pasteuria | Tefluthrin | | | |
| | nishizawae | | | | |
| T1 | Pasteuria | Lambda-cyhalothrin | | | |
| | nishizawae | | | | |
| T1 | Pasteuria | Abamectin | | | |
| | nishizawae | | | | |
| T1 | Pasteuria | Spinosad | | | |
| | nishizawae | | | | |
| T1 | Pasteuria | Chlorantranili-prole | | | |
| | nishizawae | | | | |
| T1 | Pasteuria | Chlorpyrifos | | | |
| | nishizawae | | | | |
| T1 | Pasteuria | Thiodicarb | | | |
| | nishizawae | | | | |
| T1 | Pasteuria | Chlorantranili-prole | | | |
| | nishizawae | | | | |
| T1 | Pasteuria | Cyantranili-prole | | | |
| | nishizawae | | | | |
| T1 | Pasteuria | Bacillus firmus | | | |
| | nishizawae | | | | |
| T1 | Pasteuria | Bacillus subtilis | | | |
| | nishizawae | | | | |

“T1” means a compound selected from Table 1. A, B, C refer to components A, B and C. Preferred ratios of these mixtures are described below.

In any or all embodiments the invention may not include the following combinations:

| A | B | C | A | B | C |
|---|---|---|---|---|---|
| T1 | Cyantraniliprole | Thiamethoxam | T1 | Chlorantraniliprole | Thiamethoxam |

The present invention also relates to: a method of controlling phytopathogenic diseases on useful plants or on propagation material thereof, which comprises applying to the useful plants, the locus thereof or propagation material thereof a combination of components A, B and C; a method of controlling insects, acarines, nematodes or molluscs which comprises applying to a pest, to a locus of a pest, to a plant susceptible to attack by a pest, or to plant propagation material susceptible to attack by a pest a combination of components A, B and C; a seed comprising a pesticidal mixture of components A, B and C; a method comprising applying to a seed, e.g. coating, a mixture of components A, B and C.

Mixtures of the invention are particularly useful for controlling phytopathogenic diseases when one of the component B and C is a fungicide.

The present invention also includes pesticidal mixtures comprising a component A, B and C in a synergistically effective amount; agricultural compositions comprising a mixture of component A, B and C in a synergistically effective amount; the use of a mixture of component A, B and C in a synergistically effective amount for combating animal pests; the use of a mixture of component A, B and C in a synergistically effective amount for combating phytopathogenic fungi; a method of combating animal pests which comprises contacting the animal pests, their habit, breeding ground, food supply, plant, seed, soil, area, material or environment in which the animal pests are growing or may grow, or the materials, plants, seeds, soils, surfaces or spaces to be protected from animal attack or infestation with a mixture of component A, B and C in a synergistically effective amount; a method for protecting crops from attack or infestation by animal pests and/or phythopathogenic fungi, which comprises contacting a crop with a mixture of component A, B and C in a synergistically effective amount; a method for the protection of seeds from soil insects and of the seedlings' roots and shoots from soil and foliar insects and/or phythopathogenic fungi comprising contacting the seeds before sowing and/or after pre-germination with a mixture of component A, B and C in a synergistically effective amount; seeds comprising, e.g. coated with, a mixture of component A, B and C in a synergistically effective amount; a method comprising applying to a seed, e.g. coating, a mixture of component A, B and C in a synergistically effective amount; a method of controlling phytopathogenic, e.g. fungal, diseases on useful plants or on propagation material thereof, which comprises applying to the useful plants, the locus thereof or propagation material thereof a combination of components A, B and C in a synergistically effective amount. In such applications the mixtures of A, B and C will normally be applied in a fungicidally effective amount. The invention also provides a method of controlling insects, acarines, nematodes or molluscs which comprises applying to a pest, to a locus of a pest, to a plant susceptible to attack by a pest, or to plant propagation material susceptible to attack by a pest, a combination of components A, B and C in a synergistically effective amount. In such applications mixtures of A, B and C will normally be applied in an insecticidally, acaricidally, nematicidally or molluscicidally effective amount. In application components A, B and C may be applied simultaneously or separately.

The mixtures of the invention, and in particular those in in the tables above may be used on soybean to control, for example, Elasmopalpus lignosellus, Diloboderus abderus, Diabrotica speciosa, Sternechus subsignatus, Formicidae, Agrotis ypsilon, Julus spp., Anticarsia gemmatalis, Megascelis ssp., Procornitermes ssp., Gryllotalpidae, Nezara viridula, Piezodorus spp., Acrosternum spp., Neomegalotomus spp., Cerotoma trifurcata, Popillia japonica, Edessa spp., Liogenys fuscus, Euchistus heros, stalk borer, Scaptocoris castanea, phyllophaga spp., Pseudoplusia includens, Spodoptera spp., Bemisia tabaci, Agriotes spp. The mixtures of the invention are preferably used on soybean to control Diloboderus abderus, Diabrotica speciosa, Nezara viridula, Piezodorus spp., Acrosternum spp., Cerotoma trifurcata, Popillia japonica, Euchistus heros, phyllophaga spp., Agriotes sp

The mixtures of the invention and in particular those in the tables above may be used on corn to control, for example, Euchistus heros, Dichelops furcatus, Diloboderus abderus, Elasmopalpus lignosellus, Spodoptera frugiperda, Nezara viridula, Cerotoma trifurcata, Popillia japonica, Agrotis ypsilon, Diabrotica speciosa, Heteroptera, Procornitermes ssp., Scaptocoris castanea, Formicidae, Julus ssp., Dalbulus maidis, Diabrotica virgifera, Mocis latipes, Bemisia tabaci, heliothis spp., Tetranychus spp., thrips spp., phyllophaga spp., scaptocoris spp., Liogenys fuscus, Spodoptera spp., Ostrinia spp., Sesamia spp., Agriotes spp. The mixtures of the invention are preferably used on corn to control Euchistus heros, Dichelops furcatus, Diloboderus abderus, Nezara viridula, Cerotoma trifurcata, Popillia japonica, Diabrotica speciosa, Diabrotica virgifera, Tetranychus spp., thrips spp., phyllophaga spp., scaptocoris spp., Agriotes spp.

The mixtures of the invention and in particular those in Table 1 may be used on sugar cane to control, for example, Sphenophorus spp., termites, Mahanarva spp. The mixtures of the invention are preferably used on sugar cane to control termites, Mahanarva spp.

The mixtures of the invention and in particular those in the tables above may be used on alfalfa to control, for example, Hypera brunneipennis, Hypera postica, Colias eurytheme, Collops spp., Empoasca solana, Epitrix, Geocoris spp., Lygus hesperus, Lygus lineolaris, Spissistilus spp., Spodoptera spp., Trichoplusia ni. The mixtures of the invention are preferably used on alfalfa to control Hypera brunneipennis, Hypera postica, Empoasca solana, Epitrix, Lygus hesperus, Lygus lineolaris, Trichoplusia ni.

The mixtures of the invention and in particular those in the tables above may be used on brassicas to control, for example, Plutella xylostella, Pieris spp., Mamestra spp., Plusia spp., Trichoplusia ni, Phyllotreta spp., Spodoptera spp., Empoasca solana, thrips spp., Spodoptera spp., Delia spp. The mixtures of the invention are preferably used on brassicas to control Plutella xylostella Pieris spp., Plusia spp., Trichoplusia ni, Phyllotreta spp., thrips sp

The mixtures of the invention and in particular those in the tables above may be used on oil seed rape, e.g. canola, to control, for example, Meligethes spp., Ceutorhynchus napi, Psylloides spp.

The mixtures of the invention and in particular those in the tables above may be used on potatoes, including sweet potatoes, to control, for example, Empoasca spp., Leptinotarsa spp., Diabrotica speciosa, Phthorimaea spp., Paratrioza spp., Maladera matrida, Agriotes spp. The mixtures of the invention are preferably used on potatoes, including sweet potatoes, to control Empoasca spp., Leptinotarsa spp., Diabrotica speciosa, Phthorimaea spp., Paratrioza spp., Agriotes spp.

The mixtures of the invention and in particular those in the tables above may be used on cotton to control, for example, Anthonomus grandis, Pectinophora spp., heliothis spp., Spodoptera spp., Tetranychus spp., Empoasca spp., thrips spp., Bemisia tabaci, Lygus spp., phyllophaga spp., Scaptocoris spp. The mixtures of the invention are preferably used on cotton to control Anthonomus grandis, Tetranychus spp., Empoasca spp., thrips spp., Lygus spp., phyllophaga spp., Scaptocoris spp.

The mixtures of the invention and in particular those in the tables above may be used on rice to control, for example, Leptocorisa spp., Cnaphalocrosis spp., Chilo spp., Scirpophaga spp., Lissorhoptrus spp., Oebalus pugnax. The mixtures of the invention are preferably used on rice to control Leptocorisa spp., Lissorhoptrus spp., Oebalus pugnax.

The mixtures of the invention and in particular those in the tables above may be used on coffee to control, for example, Hypothenemus Hampei, Perileucoptera Coffeella, Tetranychus spp. The mixtures of the invention are preferably used on coffee to control Hypothenemus Hampei, Perileucoptera Coffeella.

The mixtures of the invention and in particular those in the tables above may be used on citrus to control, for example, Panonychus citri, Phyllocoptruta oleivora, Brevipalpus spp., Diaphorina citri, Scirtothrips spp., thrips spp., Unaspis spp., Ceratitis capitata, Phyllocnistis spp. The mixtures of the invention are preferably used on citrus to control Panonychus citri, Phyllocoptruta oleivora, Brevipalpus spp., Diaphorina citri, Scirtothrips spp., thrips spp., Phyllocnistis spp.

The mixtures of the invention and in particular those in the tables above may be used on almonds to control, for example, Amyelois transitella, Tetranychus spp.

The mixtures of the invention and in particular those in the tables above may be used on fruiting vegetable, including tomatoes, pepper, chili, eggplant, cucumber, squash etc, to control thrips spp., Tetranychus spp., Polyphagotarsonemus spp., Aculops spp., Empoasca spp., Spodoptera spp., heliothis spp., Tuta absoluta, Liriomyza spp., Bemisia tabaci, Trialeurodes spp., Paratrioza spp., Frankliniella occidentalis, Frankliniella spp., Anthonomus spp., Phyllotreta spp., Amrasca spp., Epilachna spp., Halyomorpha spp., Scirtothrips spp., Leucinodes spp., Neoleucinodes spp. The mixtures of the invention are preferably used on fruiting vegetable, including tomatoes, pepper, chili, eggplant, cucumber, squash etc, to control, for example, thrips spp., Tetranychus spp., Polyphagotarsonemus spp., Aculops spp., Empoasca spp., Spodoptera spp., heliothis spp., Tuta absoluta, Liriomyza spp., Paratrioza spp., Frankliniella occidentalis, Frankliniella spp., Amrasca spp., Scirtothrips spp., Leucinodes spp., Neoleucinodes spp.

The mixtures of the invention and in particular those in the tables above may be used on tea to control, for example, Pseudaulacaspis spp., Empoasca spp., Scirtothrips spp., Caloptilia theivora. The mixtures of the invention are preferably used on tea to control Empoasca spp., Scirtothrips spp.

The mixtures of the invention and in particular those in the tables above may be used on bulb vegetables, including onion, leek etc to control, for example, thrips spp., Spodoptera spp., heliothis spp. The mixtures of the invention are preferably used on bulb vegetables, including onion, leek etc to control thrips spp.

The mixtures of the invention and in particular those in the tables above may be used on grapes to control, for example, Empoasca spp., Lobesia spp., Frankliniella spp., thrips spp., Tetranychus spp., Rhipiphorothrips Cruentatus, Eotetranychus Willamettei, Erythroneura Elegantula, Scaphoides spp. The mixtures of the invention are preferably used on grapes to control Frankliniella spp., thrips spp., Tetranychus spp., Rhipiphorothrips Cruentatus, Scaphoides spp.

The mixtures of the invention and in particular those in the tables above may be used on pome fruit, including apples, pairs etc, to control, for example, Cacopsylla spp., Psylla spp., Panonychus ulmi, Cydia pomonella. The mixtures of the invention are preferably used on pome fruit, including apples, pairs etc, to control Cacopsylla spp., Psylla spp., Panonychus ulmi.

The mixtures of the invention and in particular those in the tables above may be used on stone fruit to control, for example, Grapholita molesta, Scirtothrips spp., thrips spp., Frankliniella spp., Tetranychus spp. The mixtures of the invention are preferably used on stone fruit to control Scirtothrips spp., thrips spp., Frankliniella spp., Tetranychus spp.

The mixtures of the invention, in particular those in the tables above, may be used for soil applications, including as a seed application, to target at least the following: early foliar diseases such as Phakopsora Pachyrihizi, Septoria (e.g. cereals) and other leafspot diseases, cereal rusts and powdery mildew; seed borne disease such as Smuts (e.g. Ustilago, Spacelotheca) on e.g. ceareals and corn, snow mould (e.g. Micodochium) on e.g. cereals, Fusarium on e.g. cereals, corn, potato, rice, cotton, vegetables, stripe disease (e.g. Pyrenophora) on e.g. barley, Pyricularia and Helminthosporium e.g. on rice, potatoes, Phoma and Ascochyta e.g. on pulse crops, oil seed rape and soybean, bunts (e.g. Tilletia) e.g. on wheat, Aspergillus and Penicillium e.g. on corn, soybean, Dipoldia and Colletotrichum e.g. on corn, Cochliobolus and septoria e.g. on cereals; soil borne diseases such as Rhizoctonia (applicable to many crops), Fusarium e.g. on cereals, corn, soybean and cotton, take-all e.g. on wheat, eyespot on e.g. wheat, Thielaviopsis on e.g. cotton; oomycetes such as Pythium spp., downy mildews such as Plasmopora, Aphanomycetes (e.g. on sugar beet); sucking pests such as aphids, thrips, brown plant hopper (e.g. on rice), sting bugs, white flies (e.g. on cotton and vegetables), mites; on soil pests such as corn root worm, wireworms, white grubs, zabrus, termites (e.g. on sugar cane, soy, pasture), maggots, cabbage root fly, red legged earth mite; on lepidoptera, such as spodoptera, cutworms, elasmoplpus, plutella (e.g. brassica), stem borers, leaf miners, flea beetle, Sternechus; on nematicides, such as Heterodera glycines (e.g. on soybean), Pratylenchus brachyurus (e.g. on corn), P. zeae (e.g. oncorn), P. penetrans (e.g. on corn), Meloidogyne incognita (e.g. on vegetables), Heterodera schachtii (e.g. on sugar beet), Rotylenchus reniformis (e.g. on cotton), Heterodera avenae (e.g. on cereals), Pratylenchus neglectus (e.g. on cereals), thornei (e.g. on cereals).

The mixtures of the invention, in particular those in the tables above may be used for seed applications at least on the following: soil grubs for corn, soybeans, sugarcane: Migdolus spp; Phyllophaga spp.; Diloboderus spp; Cyclocephala spp; Lyogenys fuscus; sugarcane weevils: Sphenophorus levis & Metamasius hemipterus; termites for soybeans, sugarcane, pasture, others: Heterotermes tenuis; Heterotermes longiceps; Cornitermes cumulans; Procornitermes triacifer; Neocapritermes opacus; Neocapritermes parvus; corn root worms for corn and potatoes: Diabrotica spp., seed Maggot: Delia platura; soil stinkbugs: Scaptocoris castanea; wireworms: Agriotes spp; Athous spp Hipnodes bicolor; Ctenicera destructor; Limonius canu; Limonius califormicus; rice water weevil: Lissorhoptrus oryzophilus; Red Legged earth mites: Halotydeus destructor.

For soil applications using compounds of formula I on sugar cane, including application on sugar cane propogation material such as buds, the following mixing partners are of particular interest: insecticides selected from neonicotinoids, in particular thiamethoxam, imidacloprid and clothianidin, sulfoxaflor, abamectin, carbofuran, tefluthrin, fipronil, ethiprole, spinosad, lamda-cyhalothrin, bisamides, in particular chlorantraniliprole, cyantraniliprole, flubendiamide; fungicides selected from azoxystrobin, cyproconazole, thiabendazole, fluazinam, fludioxonil, mefenoxam, Sedaxane. For foliar applications using compounds of formula I on sugar cane, the following mixing partners are of particular interest: insecticides selected from thiamethoxam, Lambda cyhalothrin, spirotetramat, spinetoran, chlorantraniliprole, lufenuron; fungicides selected from N-[9-(dichloromethylene)-1,2,3,4-tetrahydro-1,4-methanonaphthalen-5-yl]-3-(difluoromethyl)-1-methyl-1H-pyrazole-4-carboxamide [CAS 1072957-71-1], azoxystrobin, cyproconazole, protioconazole. Combinations with glyphosate are also of interest.

Particular combinations of interest for sugar cane, particularly on sugar cane propogation material such as buds, include a compound of formula I with thiamethoxam and abamectin, a compound of formula I with thiamethoxam and cyantraniliprole, a compound of formula I with thiamethoxam and chlorantraniliprole. Further combinations of particular interest include a compound of formula I+thiamethoxam+abamectin+mefenoxam+fludioxonil+azoxystrobin+thiabendazole; a compound of formula I+abamectin+mefenoxam+fludioxonil+azoxystrobin+thiabendazole, a compound of formula I+thiamethoxam+mefenoxam+fludioxonil+azoxystrobin+thiabendazole, a compound of formula I+thiamethoxam+abamectin+mefenoxam+fludioxonil+azoxystrobin+thiabendazole, a compound of formula I+thiamethoxam+abamectin+fludioxonil+azoxystrobin+thiabendazole, a compound of formula I+thiamethoxam+abamectin+mefenoxam+azoxystrobin+thiabendazole, a compound of formula I+thiamethoxam+abamectin+mefenoxam+fludioxonil+thiabendazole, a compound of formula I+thiamethoxam+abamectin+mefenoxam+fludioxonil+azoxystrobin. Example or ratios are below.

Further combination of interest include mixtures of compounds of formula I with the mixtures described in: WO2006/015865 and WO2007/090623, in particular those described in the Examples. Of particular interest are the following combinations: a compound of formula I+sedaxane+mefenoxam+difenoconazole, a compound of formula I+fludioxonil+sedaxane+difenoconazole, a compound of formula I+fludioxonil+sedaxane+difenoconazole+thiamethoxam, a compound of formula I+fludioxonil+mefenoxam+sedaxane+thiabendazole, a compound of formula I+fludioxonil+difenoconazole+sedaxane+a compound of formula I+fludioxonil+sedaxane+mefenoxam. Example or ratios are below.

The active ingredient combinations are effective against harmful microorganisms, such as microorganisms, that cause phytopathogenic diseases, in particular against phytopathogenic fungi and bacteria. The active ingredient combinations are effective especially against phytopathogenic fungi belonging to the following classes: Ascomycetes (e.g. Venturia, Podosphaera, Erysiphe, Monilinia, Mycosphaerella, Uncinula); Basidiomycetes (e.g. the genus Hemileia, Rhizoctonia, Phakopsora, Puccinia, Ustilago, Tilletia); Fungi imperfecti (also known as Deuteromycetes; e.g. Botrytis, Helminthosporium, Rhynchosporium, Fusarium, Septoria, Cercospora, Alternaria, Pyricularia and Pseudocercosporella); Oomycetes (e.g. Phytophthora, Peronospora, Pseudoperonospora, Albugo, Bremia, Pythium, Pseudosclerospora, Plasmopara).

The mixtures of the present invention can be used to control infestations of insect pests such as Lepidoptera, Diptera, Hemiptera, Thysanoptera, Orthoptera, Dictyoptera, Coleoptera, Siphonaptera, Hymenoptera and Isoptera and also other invertebrate pests, for example, acarine, nematode and mollusc pests. Insects, acarines, nematodes and molluscs are hereinafter collectively referred to as animal pests. The animal pests which may be controlled by the use of the invention compounds include those animal pests associated with agriculture (which term includes the growing of crops for food and fiber products), horticulture and animal husbandry, companion animals, forestry and the storage of products of vegetable origin (such as fruit, grain and timber); those pests associated with the damage of man-made structures and the transmission of diseases of man and animals; and also nuisance pests (such as flies). The mixtures of the invention are particularly effective against insects, acarines and/or nematodes.

According to the invention “useful plants” typically comprise the following species of plants: grape vines; cereals, such as wheat, barley, rye or oats; beet, such as sugar beet or fodder beet; fruits, such as pomes, stone fruits or soft fruits, for example apples, pears, plums, peaches, almonds, cherries, strawberries, raspberries or blackberries; leguminous plants, such as beans, lentils, peas or soybeans; oil plants, such as rape, mustard, poppy, olives, sunflowers, coconut, castor oil plants, cocoa beans or groundnuts; cucumber plants, such as marrows, cucumbers or melons; fibre plants, such as cotton, flax, hemp or jute; citrus fruit, such as oranges, lemons, grapefruit or mandarins; vegetables, such as spinach, lettuce, asparagus, cabbages, carrots, onions, tomatoes, potatoes, cucurbits or paprika; lauraceae, such as avocados, cinnamon or camphor; maize; tobacco; nuts; coffee; sugar cane; tea; vines; hops; durian; bananas; natural rubber plants; turf or ornamentals, such as flowers, shrubs, broad-leaved trees or evergreens, for example conifers. This list does not represent any limitation. It may be noted that compound of formula I may also be used for controlling insect, acaricide and/or nematode pests on turf in the absence of mixing partners.

The term “useful plants” is to be understood as including also useful plants that have been rendered tolerant to herbicides like bromoxynil or classes of herbicides (such as, for example, HPPD inhibitors, ALS inhibitors, for example primisulfuron, prosulfuron and trifloxysulfuron, EPSPS (5-enol-pyrovyl-shikimate-3-phosphate-synthase) inhibitors, GS (glutamine synthetase) inhibitors) as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as including also useful plants which have been so transformed by the use of recombinant DNA techniques that they are capable of synthesising one or more selectively acting toxins, such as are known, for example, from toxin-producing bacteria, especially those of the genus Bacillus.

The compound of formula I are understood to represent a new mode of action. Accordingly, it may be noted that compounds of formula I may be used to control acarides, insects and nematodes, preferably insects, that are resistant to active ingredients having other modes of action., e.g. it may be included in resistant management programs.

Toxins that can be expressed by such transgenic plants include, for example, insecticidal proteins, for example insecticidal proteins from Bacillus cereus or Bacillus popliae; or insecticidal proteins from Bacillus thuringiensis, such as δ-endotoxins, e.g. CryIA(b), CryIA(c), CryIF, CryIF(a2), CryIIA(b), CryIIIA, CryIIIB(b1) or Cry9c, or vegetative insecticidal proteins (VIP), e.g. VIP1, VIP2, VIP3 or VIP3A; or insecticidal proteins of bacteria colonising nematodes, for example Photorhabdus spp. or Xenorhabdus spp., such as Photorhabdus luminescens, Xenorhabdus nematophilus; toxins produced by animals, such as scorpion toxins, arachnid toxins, wasp toxins and other insect-specific neurotoxins; toxins produced by fungi, such as Streptomycetes toxins, plant lectins, such as pea lectins, barley lectins or snowdrop lectins; agglutinins; proteinase inhibitors, such as trypsine inhibitors, serine protease inhibitors, patatin, cystatin, papain inhibitors; ribosome-inactivating proteins (RIP), such as ricin, maize-RIP, abrin, luffin, saporin or bryodin; steroid metabolism enzymes, such as 3-hydroxysteroidoxidase, ecdysteroid-UDP-glycosyl-transferase, cholesterol oxidases, ecdysone inhibitors, HMG-COA-reductase, ion channel blockers, such as blockers of sodium or calcium channels, juvenile hormone esterase, diuretic hormone receptors, stilbene synthase, bibenzyl synthase, chitinases and glucanases.

In the context of the present invention there are to be understood by δ-endotoxins, for example CryIA(b), CryIA(c), CryIF, CryIF(a2), CryIIA(b), CryIIIA, CryIIIB(b1) or Cry9c, or vegetative insecticidal proteins (VIP), for example VIP1, VIP2, VIP3 or VIP3A, expressly also hybrid toxins, truncated toxins and modified toxins. Hybrid toxins are produced recombinantly by a new combination of different domains of those proteins (see, for example, WO 02/15701). An example for a truncated toxin is a truncated CryIA(b), which is expressed in the Bt11 maize from Syngenta Seed SAS, as described below. In the case of modified toxins, one or more amino acids of the naturally occurring toxin are replaced. In such amino acid replacements, preferably non-naturally present protease recognition sequences are inserted into the toxin, such as, for example, in the case of CryIIIA055, a cathepsin-D-recognition sequence is inserted into a CryIIIA toxin (see WO 03/018810)

Examples of such toxins or transgenic plants capable of synthesising such toxins are disclosed, for example, in EP-A-0 374 753, WO 93/07278, WO 95/34656, EP-A-0 427 529, EP-A-451 878 and WO 03/052073.

The processes for the preparation of such transgenic plants are generally known to the person skilled in the art and are described, for example, in the publications mentioned above. CryI-type deoxyribonucleic acids and their preparation are known, for example, from WO 95/34656, EP-A-0 367 474, EP-A-0 401 979 and WO 90/13651.

The toxin contained in the transgenic plants imparts to the plants tolerance to harmful insects. Such insects can occur in any taxonomic group of insects, but are especially commonly found in the beetles (Coleoptera), two-winged insects (Diptera) and butterflies (Lepidoptera).

Transgenic plants containing one or more genes that code for an insecticidal resistance and express one or more toxins are known and some of them are commercially available. Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); NatureGard® and Protecta®.

Further examples of such transgenic crops are:

1. Bt11 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a truncated CryIA(b) toxin. Bt11 maize also transgenically expresses the enzyme PAT to achieve tolerance to the herbicide glufosinate ammonium.
2. Bt176 Maize from Syngenta Seeds SAS, Chemin de l'Hobit 27, F-31 790 St. Sauveur, France, registration number C/FR/96/05/10. Genetically modified Zea mays which has been rendered resistant to attack by the European corn borer (Ostrinia nubilalis and Sesamia nonagrioides) by transgenic expression of a CryIA(b) toxin. Bt176 maize also transgenically expresses the enzyme PAT to achieve tolerance to the herbicide glufosinate ammonium.
3. MIR604 Maize from Syngenta Seeds SAS, Chemin de l'Hobit 27, F-31 790 St. Sauveur, France, registration number C/FR/96/05/10. Maize which has been rendered insect-resistant by transgenic expression of a modified CryIIIA toxin. This toxin is Cry3A055 modified by insertion of a cathepsin-D-protease recognition sequence. The preparation of such transgenic maize plants is described in WO 03/018810.
4. MON 863 Maize from Monsanto Europe S.A. 270-272 Avenue de Tervuren, B-1150 Brussels, Belgium, registration number C/DE/02/9. MON 863 expresses a CryIIIB(b1) toxin and has resistance to certain Coleoptera insects.
5. IPC 531 Cotton from Monsanto Europe S.A. 270-272 Avenue de Tervuren, B-1150 Brussels, Belgium, registration number C/ES/96/02.

6. 1507 Maize from Pioneer Overseas Corporation, Avenue Tedesco, 7 B-1160 Brussels, Belgium, registration number C/NL/00/10. Genetically modified maize for the expression of the protein CryIF for achieving resistance to certain Lepidoptera insects and of the PAT protein for achieving tolerance to the herbicide glufosinate ammonium.

7. NK603×MON 810 Maize from Monsanto Europe S.A. 270-272 Avenue de Tervuren, B-1150 Brussels, Belgium, registration number C/GB/02/M3/03. Consists of conventionally bred hybrid maize varieties by crossing the genetically modified varieties NK603 and MON 810. NK603×MON 810 Maize transgenically expresses the protein CP4 EPSPS, obtained from Agrobacterium sp. strain CP4, which imparts tolerance to the herbicide Roundup® (contains glyphosate), and also a CryIA(b) toxin obtained from Bacillus thuringiensis subsp. kurstaki which brings about tolerance to certain Lepidoptera, include the European corn borer.

Transgenic crops of insect-resistant plants are also described in BATS (Zentrum für Biosicherheit and Nachhaltigkeit, Zentrum BATS, Clarastrasse 13, 4058 Basel, Switzerland) Report 2003, (http://bats.ch).

The term “useful plants” is to be understood as including also useful plants which have been so transformed by the use of recombinant DNA techniques that they are capable of synthesising antipathogenic substances having a selective action, such as, for example, the so-called “pathogenesis-related proteins” (PRPs, see e.g. EP-A-0 392 225). Examples of such antipathogenic substances and transgenic plants capable of synthesising such antipathogenic substances are known, for example, from EP-A-0 392 225, WO 95/33818, and EP-A-0 353 191. The methods of producing such transgenic plants are generally known to the person skilled in the art and are described, for example, in the publications mentioned above.

Antipathogenic substances which can be expressed by such transgenic plants include, for example, ion channel blockers, such as blockers for sodium and calcium channels, for example the viral KP1, KP4 or KP6 toxins; stilbene synthases; bibenzyl synthases; chitinases; glucanases; the so-called “pathogenesis-related proteins” (PRPs; see e.g. EP-A-0 392 225); antipathogenic substances produced by microorganisms, for example peptide antibiotics or heterocyclic antibiotics (see e.g. WO 95/33818) or protein or polypeptide factors involved in plant pathogen defence (so-called “plant disease resistance genes”, as described in WO 03/000906).

Useful plants of elevated interest in connection with present invention are cereals; soybean; rice; oil seed rape; pome fruits; stone fruits; peanuts; coffee; tea; strawberries; turf; vines and vegetables, such as tomatoes, potatoes, cucurbits and lettuce.

The term “locus” of a useful plant as used herein is intended to embrace the place on which the useful plants are growing, where the plant propagation materials of the useful plants are sown or where the plant propagation materials of the useful plants will be placed into the soil. An example for such a locus is a field, on which crop plants are growing.

The term “plant propagation material” is understood to denote generative parts of a plant, such as seeds, which can be used for the multiplication of the latter, and vegetative material, such as cuttings or tubers, for example potatoes. There may be mentioned for example seeds (in the strict sense), roots, fruits, tubers, bulbs, rhizomes and parts of plants. Germinated plants and young plants which are to be transplanted after germination or after emergence from the soil, may also be mentioned. These young plants may be protected before transplantation by a total or partial treatment by immersion. Preferably “plant propagation material” is understood to denote seeds.

Methods for applying or treating active ingredients on to plant propagation material, especially seeds, are known in the art, and include dressing, coating, pelleting and soaking application methods of the propagation material. Conventional treating techniques and machines can be used, such as fluidized beds, roller mills, rotostatic seed treaters, drum coaters, and spouted beds.

Methods of applying to the soil can be via any suitable method, which ensures that the combination penetrates the soil, for example, nursery tray application, in furrow application, soil drenching, soil injection, drip irrigation, application through sprinklers or central pivot, incorporation into soil (broad cast or in band) are such methods. Alternatively or in addition one or more materials may be applied on a suitable substrate, for example a seed which is not intended for germination, and “sowing” the treated substrate with the plant propagation material.

Even distribution of ingredients and good adherence is particularly desired for seed treatment. Treatment could vary from a thin film or dressing of the formulation, for example, a mixture of active ingredients, on a plant propagation material, such as a seed, where the original size and/or shape are recognizable to an intermediary state to a thicker film such as pelleting with many layers of different materials (such as carriers, for example, clays; different formulations, such as of other active ingredients; polymers; and colourants) where the original shape and/or size of the seed is no longer recognisable.

Application onto plant propagation material can include controlled release coatings, wherein the ingredients of the combinations are incorporated into materials that release the ingredients over time. Examples of controlled release technologies are generally known in the art and include polymer films and waxes, wherein the ingredients may be incorporated into the controlled release material or applied between layers of materials, or both.

A further aspect of the instant invention is a method of protecting natural substances of plant and/or animal origin, which have been taken from the natural life cycle, and/or their processed forms against attack of fungi and/or animal pests, which comprises applying to said natural substances of plant and/or animal origin or their processed forms a combination of components A, B and C in a synergistically effective amount.

According to the instant invention, the term “natural substances of plant origin, which have been taken from the natural life cycle” denotes plants or parts thereof which have been harvested from the natural life cycle and which are in the freshly harvested form. Examples of such natural substances of plant origin are stalks, leafs, tubers, seeds, fruits or grains. According to the instant invention, the term “processed form of a natural substance of plant origin” is understood to denote a form of a natural substance of plant origin that is the result of a modification process. Such modification processes can be used to transform the natural substance of plant origin in a more storable form of such a substance (a storage good). Examples of such modification processes are pre-drying, moistening, crushing, comminuting, grounding, compressing or roasting. Also falling under the definition of a processed form of a natural substance of plant origin is timber, whether in the form of crude timber, such as construction timber, electricity pylons and barriers, or in the form of finished articles, such as furniture or objects made from wood.

According to the instant invention, the term “natural substances of animal origin, which have been taken from the natural life cycle and/or their processed forms” is understood to denote material of animal origin such as skin, hides, leather, furs, hairs and the like.

The combinations according the present invention can prevent disadvantageous effects such as decay, discoloration or mould.

A preferred embodiment is a method of protecting natural substances of plant origin, which have been taken from the natural life cycle, and/or their processed forms against attack of fungi and/or animal pests, which comprises applying to said natural substances of plant and/or animal origin or their processed forms a combination of components A, B and C in a synergistically effective amount. Such applications include use of the mixtures of the invention as a treatment, for example a fumigant, for stored grain to protect against attack of invertabrate pests and or fungi. It may be noted that compounds of formula I may be used alone as a treatment for stored grain to protect against attack of invertabrate pests.

A further preferred embodiment is a method of protecting fruits, preferably pomes, stone fruits, soft fruits and citrus fruits, which have been taken from the natural life cycle, and/or their processed forms, which comprises applying to said fruits and/or their processed forms a combination of components A, B and C in a synergistically effective amount.

The combinations of the present invention may also be used in the field of protecting industrial material against attack of fungi. According to the instant invention, the term “industrial material” denotes non-living materials which have been prepared for use in industry. For example, industrial materials which are intended to be protected against attack of fungi can be glues, sizes, paper, board, textiles, carpets, leather, wood, constructions, paints, plastic articles, cooling lubricants, aquaeous hydraulic fluids and other materials which can be infested with, or decomposed by, microorganisms. Cooling and heating systems, ventilation and air conditioning systems and parts of production plants, for example cooling-water circuits, which may be impaired by multiplication of microorganisms may also be mentioned from amongst the materials to be protected. The combinations according the present invention can prevent disadvantageous effects such as decay, discoloration or mold.

The combinations of the present invention may also be used in the field of protecting technical material against attack of fungi. According to the instant invention, the term “technical material” includes paper; carpets; constructions; cooling and heating systems; ventilation and air conditioning systems and the like. The combinations according the present invention can prevent disadvantageous effects such as decay, discoloration or mold.

The combinations according to the present invention are particularly effective against powdery mildews; rusts; leafspot species; early blights and molds; especially against Septoria, Puccinia, Erysiphe, Pyrenophora and Tapesia in cereals; Phakopsora in soybeans; Hemileia in coffee; Phragmidium in roses; Alternaria in potatoes, tomatoes and cucurbits; Sclerotinia in turf, vegetables, sunflower and oil seed rape; black rot, red fire, powdery mildew, grey mold and dead arm disease in vine; Botrytis cinerea in fruits; Monilinia spp. in fruits and Penicillium spp. in fruits.

The combinations according to the present invention are furthermore particularly effective against seedborne and soilborne diseases, such as Alternaria spp., Ascochyta spp., Botrytis cinerea, Cercospora spp., Claviceps purpurea, Cochliobolus sativus, Colletotrichum spp., Epicoccum spp., Fusarium graminearum, Fusarium moniliforme, Fusarium oxysporum, Fusarium proliferatum, Fusarium solani, Fusarium subglutinans, Gäumannomyces graminis, Helminthosporium spp., Microdochium nivale, Phoma spp., Pyrenophora graminea, Pyricularia oryzae, Rhizoctonia solani, Rhizoctonia cerealis, Sclerotinia spp., Septoria spp., Sphacelotheca reilliana, Tilletia spp., Typhula incarnata, Urocystis occulta, Ustilago spp. or Verticillium spp.; in particular against pathogens of cereals, such as wheat, barley, rye or oats; maize; rice; cotton; soybean; turf; sugarbeet; oil seed rape; potatoes; pulse crops, such as peas, lentils or chickpea; and sunflower. The combinations according to the present invention are furthermore particularly effective against post harvest diseasese such as Botrytis cinerea, Colletotrichum musae, Curvularia lunata, Fusarium semitecum, Geotrichum candidum, Monilinia fructicola, Monilinia fructigena, Monilinia laxa, Mucor piriformis, Penicilium italicum, Penicilium solitum, Penicillium digitatum or Penicillium expansum in particular against pathogens of fruits, such as pomefruits, for example apples and pears, stone fruits, for example peaches and plums, citrus, melons, papaya, kiwi, mango, berries, for example strawberries, avocados, pomegranates and bananas, and nuts.

The combinations according to the invention are particularly useful for controlling the following plant diseases:

Alternaria species in fruit and vegetables,
Ascochyta species in pulse crops,
Botrytis cinerea in strawberries, tomatoes, sunflower, pulse crops, vegetables and grapes,
Cercospora arachidicola in peanuts,
Cochliobolus sativus in cereals,
Colletotrichum species in pulse crops,
Erysiphe species in cereals,
Erysiphe cichoracearum and Sphaerotheca fuliginea in cucurbits,
Fusarium species in cereals and maize,
Gäumannomyces graminis in cereals and lawns,
Helminthosporium species in maize, rice and potatoes,
Hemileia vastatrix on coffee,
Microdochium species in wheat and rye,
Phakopsora species in soybean,
Puccinia species in cereals, broadleaf crops and perrenial plants,
Pseudocercosporella species in cereals,
Phragmidium mucronatum in roses,
Podosphaera species in fruits,
Pyrenophora species in barley,
Pyricularia oryzae in rice,
Ramularia collo-cygni in barley,
Rhizoctonia species in cotton, soybean, cereals, maize, potatoes, rice and lawns,
Rhynchosporium secalis in barley and rye,
Sclerotinia species in lawns, lettuce, vegetables and oil seed rape,
Septoria species in cereals, soybean and vegetables,
Sphacelotheca reilliana in maize,

Tilletia species in cereals,

Uncinula necator, Guignardia bidwellii and Phomopsis viticola in vines,
Urocystis occulta in rye,
Ustilago species in cereals and maize,
Venturia species in fruits,
Monilinia species on fruits,
Penicillium species on citrus and apples.

The combinations according to the present invention are furthermore particularly effective against the following animal pests: Myzus persicae (aphid), Aphis gossypii (aphid), Aphis fabae (aphid), Lygus spp. (capsids), Dysdercus spp. (capsids), Nilaparvata lugens (planthopper), Nephotettixc incticeps (leafhopper), Nezara spp. (stinkbugs), Euschistus spp. (stinkbugs), Leptocorisa spp. (stinkbugs), Frankliniella occidentalis (thrip), Thrips spp. (thrips), Leptinotarsa decemlineata (Colorado potato beetle), Anthonomus grandis (boll weevil), Aonidiella spp. (scale insects), Trialeurodes spp. (white flies), Bemisia tabaci (white fly), Ostrinia nubilalis (European corn borer), Spodoptera littoralis (cotton leafworm), Heliothis virescens (tobacco budworm), Helicoverpa armigera (cotton bollworm), Helicoverpa zea (cotton bollworm), Sylepta derogata (cotton leaf roller), Pieris brassicae (white butterfly), Plutella xylostella (diamond back moth), Agrotis spp. (cutworms), Chilo suppressalis (rice stem borer), Locusta migratoria (locust), Chortiocetes terminifera (locust), Diabrotica spp. (rootworms), Panonychus ulmi (European red mite), Panonychus citri (citrus red mite), Tetranychus urticae (two-spotted spider mite), Tetranychus cinnabarinus (carmine spider mite), Phyllocoptruta oleivora (citrus rust mite), Polyphagotarsonemus latus (broad mite), Brevipalpus spp. (flat mites), Boophilus microplus (cattle tick), Dermacentor variabilis (American dog tick), Ctenocephalides felis (cat flea), Liriomyza spp. (leafminer), Musca domestica (housefly), Aedes aegypti (mosquito), Anopheles spp. (mosquitoes), Culex spp. (mosquitoes), Lucillia spp. (blowflies), Blattella germanica (cockroach), Periplaneta americana (cockroach), Blatta orientalis (cockroach), termites of the Mastotermitidae (for example Mastotermes spp.), the Kalotermitidae (for example Neotermes spp.), the Rhinotermitidae (for example Coptotermes formosanus, Reticulitermes flavipes, R. speratu, R. virginicus, R. hesperus, and R. santonensis) and the Termitidae (for example Globitermes sulfureus), Solenopsis geminata (fire ant), Monomorium pharaonis (pharaoh's ant), Damalinia spp. and Linognathus spp. (biting and sucking lice), Meloidogyne spp. (root knot nematodes), Globodera spp. and Heterodera spp. (cyst nematodes), Pratylenchus spp. (lesion nematodes), Rhodopholus spp. (banana burrowing nematodes), Tylenchulus spp. (citrus nematodes), Haemonchus contortus (barber pole worm), Caenorhabditis elegans (vinegar eelworm), Trichostrongylus spp. (gastro intestinal nematodes) and Deroceras reticulatum (slug).

The amount of a combination of the invention to be applied, will depend on various factors, such as the compounds employed; the subject of the treatment, such as, for example plants, soil or seeds; the type of treatment, such as, for example spraying, dusting or seed dressing; the purpose of the treatment, such as, for example prophylactic or therapeutic; the type of fungi and/or animal pest to be controlled or the application time.

The mixtures comprising a compound of formula I, e.g. those selected from table 1, and one or more active ingredients as described above can be applied, for example, in a single “ready-mix” form, in a combined spray mixture composed from separate formulations of the single active ingredient components, such as a “tank-mix”, and in a combined use of the single active ingredients when applied in a sequential manner, i.e. one after the other with a reasonably short period, such as a few hours or days. The order of applying the compounds of formula I selected from Table 1 and the active ingredients as described above is not essential for working the present invention.

Synergistic activity is present when the fungicidal and/or animal pesticidal activity of the composition of A+B+C is greater than the sum of the fungicidal and/or pesticidal activities of A, B and C and/or A and (B+C), and/or (A+B) and C, and/or (A+C) and B.

The method of the invention comprises applying to the useful plants, the locus thereof or propagation material thereof in admixture or separately, a synergistically effective aggregate amount of component A, B and C.

Some of said combinations according to the invention have a systemic action and can be used as foliar, soil and seed treatment pesticides.

With the combinations according to the invention it is possible to inhibit or destroy the phytopathogenic microorganisms and/or animal pests which occur in plants or in parts of plants (fruit, blossoms, leaves, stems, tubers, roots) in different useful plants, while at the same time the parts of plants which grow later are also protected from attack by phytopathogenic microorganisms and/or animal pests.

The combinations of the present invention are of particular interest for controlling a large number of fungi and/or animal pests in various useful plants or their seeds, especially in field crops such as potatoes, tobacco and sugarbeets, and wheat, rye, barley, oats, rice, maize, lawns, cotton, soybeans, oil seed rape, pulse crops, sunflower, coffee, sugarcane, fruit and ornamentals in horticulture and viticulture, in vegetables such as cucumbers, beans and cucurbits.

The combinations according to the invention are applied by treating the fungi and/or animal pests, the useful plants, the locus thereof, the propagation material thereof, the natural substances of plant and/or animal origin, which have been taken from the natural life cycle, and/or their processed forms, or the industrial materials threatened by fungus and/or animal pests, attack with a combination of components A, B and C in a synergistically effective amount.

The combinations according to the invention may be applied before or after infection or contamination of the useful plants, the propagation material thereof, the natural substances of plant and/or animal origin, which have been taken from the natural life cycle, and/or their processed forms, or the industrial materials by the fungi and/or animal pests.

When applied to the useful plants the compound of formula I is applied at a rate of 1 to 500 g a.i./ha in association with 1 to 5000 g a.i./ha, particularly 1 to 2000 g a.i./ha, of a compound of each of components B and C, depending on the class of chemical employed as components B and C.

Generally for plant propagation material, such as seed treatment, application rates can vary from 0.001 to 10 g/kg of seeds of active ingredients for compounds of formula I. When the combinations of the present invention are used for treating seed, rates of 0.001 to 5 g of a compound of formula I per kg of seed, preferably from 0.01 to 1 g per kg of seed, and 0.001 to 50 g each of a compound of component B and C per kg of seed, preferably from 0.01 to 10 g per kg of seed, are generally sufficient. When component C is not a fungicide 0.001 to 5 g of a compound of component C per kg of seed, preferably from 0.01 to 1 g per kg of seed, are generally sufficient.

The weight ratio of A to B and A to C may generally be between 1000:1 and 1:1000. In other embodiments that weight ratio of A to B may be between 500:1 to 1:500, for example between 100:1 to 1:100, for example between 1:50 to 50:1, for example 1:20 to 20:1. In other embodiments that weight ratio of A to C may be between 500:1 to 1:500, for example between 100:1 to 1:100, for example between 1:50 to 50:1, for example 1:20 to 20:1. In other embodiments that weight ratio of B to C may be between 500:1 to 1:500, for example between 100:1 to 1:100, for example between 1:50 to 50:1, for example 1:20 to 20:1. In cases where component C is component C1 and component C2, the above rates and ratios apply separately to C1 and C2.

The invention also provides pesticidal mixtures comprising a combination of components A, B and C as mentioned above e.g. in a synergistically effective amount, together with an agriculturally acceptable carrier, and optionally a surfactant.

The compositions of the invention may be employed in any conventional form, for example in the form of a twin pack, a powder for dry seed treatment (DS), an emulsion for seed treatment (ES), a flowable concentrate for seed treatment (FS), a solution for seed treatment (LS), a water dispersible powder for seed treatment (WS), a capsule suspension for seed treatment (CF), a gel for seed treatment (GF), a capsule suspension for seed treatment (CS), an emulsion concentrate (EC), a suspension concentrate (SC), a suspo-emulsion (SE), a capsule suspension (CS), a water dispersible granule (WG), an emulsifiable granule (EG), an emulsion, water in oil (EO), an emulsion, oil in water (EW), a micro-emulsion (ME), an oil dispersion (OD), an oil miscible flowable (OF), an oil miscible liquid (OL), a soluble concentrate (SL), an ultra-low volume suspension (SU), an ultra-low volume liquid (UL), a technical concentrate (TK), a dispersible concentrate (DC), a wettable powder (WP) or any technically feasible formulation in combination with agriculturally acceptable adjuvants.

Such compositions may be produced in conventional manner, e.g. by mixing the active ingredients with appropriate formulation inerts (diluents, solvents, fillers and optionally other formulating ingredients such as surfactants, biocides, anti-freeze, stickers, thickeners and compounds that provide adjuvancy effects). Also conventional slow release formulations may be employed where long lasting efficacy is intended. Particularly formulations to be applied in spraying forms, such as water dispersible concentrates (e.g. EC, SC, DC, OD, SE, EW, EO and the like), wettable powders and granules, may contain surfactants such as wetting and dispersing agents and other compounds that provide adjuvancy effects, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

A seed dressing formulation is applied in a manner known per se to the seeds employing the combination of the invention and a diluent in suitable seed dressing formulation form, e.g. as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules. A typical a tank-mix formulation for seed treatment application comprises 0.25 to 80%, especially 1 to 75%, of the desired ingredients, and 99.75 to 20%, especially 99 to 25%, of a solid or liquid auxiliaries (including, for example, a solvent such as water), where the auxiliaries can be a surfactant in an amount of 0 to 40%, especially 0.5 to 30%, based on the tank-mix formulation. A typical pre-mix formulation for seed treatment application comprises 0.5 to 99.9%, especially 1 to 95%, of the desired ingredients, and 99.5 to 0.1%, especially 99 to 5%, of a solid or liquid adjuvant (including, for example, a solvent such as water), where the auxiliaries can be a surfactant in an amount of 0 to 50%, especially 0.5 to 40%, based on the pre-mix formulation.

The rates of application of a plant propagation material treatment varies, for example, according to type of use, type of crop, the specific compound(s) and/or agent(s) used, and type of plant propagation material. The suitable rate is an effective amount to provide the desired action (such as disease or pest control) and can be determined by trials and routine experimentation known to one of ordinary skill in the art.

Generally for soil treatments, application rates can vary from 0.05 to 3 kg per hectare (g/ha) of ingredients. Generally for seed treatments, application rates can vary from 0.5 to 1000 g/100 kg of seeds of ingredients.

In general, the formulations include from 0.01 to 90% by weight of active agent, from 0 to 20% agriculturally acceptable surfactant and 10 to 99.99% solid or liquid formulation inerts and adjuvant(s), the active agent consisting of at least the compound of formula I together with a compound of component B, and optionally other active agents, particularly microbiocides or conservatives or the like. Concentrated forms of compositions generally contain in between about 2 and 80%, preferably between about 5 and 70% by weight of active agent. Application forms of formulation may for example contain from 0.01 to 20% by weight, preferably from 0.01 to 5% by weight of active agent. Whereas commercial products will preferably be formulated as concentrates, the end user will normally employ diluted formulations.

A synergistic effect exists whenever the action of an active ingredient combination is greater than the sum of the actions of the individual components.

The following non-limiting Examples which follow serve to illustrate the invention.

### FORMULATION EXAMPLES

| Powders for dry seed treatment | a) | b) | c) |
|---|---|---|---|
| active ingredients | 25% | 50% | 75% |
| light mineral oil | 5% | 5% | 5% |
| highly dispersed silicic acid | 5% | 5% | — |
| Kaolin | 65% | 40% | — |
| Talcum | — | | 20 |

The combination is thoroughly mixed with the adjuvants and the mixture is thoroughly ground in a suitable mill, affording powders that can be used directly for seed treatment.

| Dusts | a) | b) | c) |
|---|---|---|---|
| Active ingredients | 5% | 6% | 4% |
| Talcum | 95% | — | — |
| Kaolin | — | 94% | — |
| mineral filler | — | — | 96% |

Ready-for-use dusts are obtained by mixing the combination with the carrier and grinding the mixture in a suitable mill. Such powders can also be used for dry dressings for seed.

### Suspension Concentrate

| | |
|---|---|
| active ingredients | 40% |
| propylene glycol | 10% |
| nonylphenol polyethylene glycol ether (15 mol of ethylene oxide) | 6% |
| Sodium lignosulfonate | 10% |
| carboxymethylcellulose | 1% |
| silicone oil (in the form of a 75% emulsion in water) | 1% |
| Water | 32% |

The finely ground combination is intimately mixed with the adjuvants, giving a suspension concentrate from which suspensions of any desired dilution can be obtained by dilution with water. Using such dilutions, seeds can be treated and protected against infestation by spraying, pouring or immersion.

### Flowable Concentrate for Seed Treatment

| | |
|---|---|
| active ingredients | 40% |
| propylene glycol | 5% |
| copolymer butanol PO/EO | 2% |
| Tristyrenephenole with 10-20 moles EO | 2% |
| 1,2-benzisothiazolin-3-one (in the form of a 20% solution in | 0.5% |
| water) | |
| monoazo-pigment calcium salt | 5% |
| Silicone oil (in the form of a 75% emulsion in water) | 0.2% |
| Water | 45.3% |

The finely ground combination is intimately mixed with the adjuvants, giving a suspension concentrate from which suspensions of any desired dilution can be obtained by dilution with water. Using such dilutions, seeds can be treated and protected against infestation by spraying, pouring or immersion.

The invention further pertains to a product for use in agriculture or horticulture comprising a capsule wherein at least a seed treated with the inventive compound is located. In another embodiment, the product comprises a capsule wherein at least a treated or untreated seed and the inventive compound are located.

### Slow Release Capsule Suspension

28 parts of the inventive compound are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed. The obtained capsule suspension is stabilized by adding 0.25 parts of a thickener and 3 parts of a dispersing agent. The capsule suspension formulation contains 28% of the active ingredient. The medium capsule diameter is 8-15 microns. The resulting formulation is applied to seeds as an aqueous suspension in a suitable apparatus.

The action to be expected E for a given active ingredient combination obeys the so-called COLBY formula and can be calculated as follows (COLBY, S. R. “Calculating synergistic and antagonistic responses of herbicide combination”. Weeds, Vol. 15, pages 20-22; 1967):

ppm=milligrams of active ingredient (=a.i.) per liter of spray mixture
X=% action by active ingredient A) using p ppm of active ingredient
Y=% action by active ingredient B) using q ppm of active ingredient.

According to COLBY, the expected (additive) action of active ingredients A)+B) using p+q ppm of active ingredient is

$$E = X + Y - \frac{X \cdot Y}{100}$$

If the action actually observed (O) is greater than the expected action (E), then the action of the combination is super-additive, i.e. there is a synergistic effect. In mathematical terms the synergism factor SF corresponds to O/E. In the agricultural practice an SF of ≧1.2 indicates significant improvement over the purely complementary addition of activities (expected activity), while an SF of ≦0.9 in the practical application routine signals a loss of activity compared to the expected activity.

Tables 2 to 69 show mixtures and compositions of the present invention demonstrating control on range of invertebrate pests, some with notable synergistic effect. As the percent of mortality cannot exceed 100 percent, the unexpected increase in insecticidal activity can be greatest only when the separate active ingredient components alone are at application rates providing considerably less than 100 percent control. Synergy may not be evident at low application rates where the individual active ingredient components alone have little activity. However, in some instances high activity was observed for combinations wherein individual active ingredient alone at the same application rate had essentially no activity. The synergism is remarkable.

Noteworthy are mixtures of a compound of formula A5 with thiamethoxam and lambda cyhalothrin, a compound of formula A5 with abamectin and lambda cyhalothrin, a compound of formula A5 with spirotetramat and lambda cyhalothrin, a compound of formula A5 with sulfoxaflor and lambda cyhalothrin, a compound of formula A5 with a compound of formula II and lambda cyhalothrin, a compound of formula A5 with a compound of formula II and sulfoxaflor, a compound of formula A5 with a compound of formula II and abamectin, a compound of formula A5 with a compound of formula II and thiamethoxam, a compound of formula A5 with azoxystrobin and lambda cyhalothrin, a compound of formula A5 with azoxystrobin and sulfoxaflor, a compound of formula A5 with azoxystrobin and abamectin, a compound of formula A5 with azoxystrobin and thiamethoxam. In the experiments below two replicates per treatment were evaluated.

Heliothis virescens (Tobacco budworm)

Eggs (0-24 h old) are placed in 24-well microtiter plate on artificial diet and treated with test solutions (DMSO) by pipetting. After an incubation period of 4 days, samples are checked for larval mortality. Application rates are as indicated in the Tables.

TABLE 2

| PPM Al | | AVERAGE CONTROL IN % | | | |
|---|---|---|---|---|---|
| COMPOUND | Thiamethoxam + | | Thiamethoxam + | EXPECTED | OBSERVED |
| A5 | Lambda-Cyhalothrin | COMPOUND A5 | Lambda-Cyhalothrin | CONTROL | CONTROL |
| 0.2 | 200 + 0.2 | 0 | 95 | 95 | 95 |
| 0.1 | 100 + 0.1 | 0 | 75 | 75 | 85* |
| 0.05 | 50 + 0.05 | 0 | 0 | 0 | 65* |
| 0.2 | 100 + 0.1 | 0 | 75 | 75 | 55 |
| 0.1 | 50 + 0.05 | 0 | 0 | 0 | 10* |
| 0.4 | 50 + 0.05 | 75 | 0 | 75 | 20 |
| 0.2 | 25 + 0.025 | 0 | 0 | 0 | 25* |
| 0.8 | 50 + 0.05 | 85 | 0 | 85 | 85 |
| 0.4 | 25 + 0.025 | 75 | 0 | 75 | 85* |
| 0.2 | 12.5 + 0.0125 | 0 | 0 | 0 | 25* |

TABLE 3

| PPM Al | | AVERAGE CONTROL IN % | | | |
|---|---|---|---|---|---|
| COMPOUND | Abamectin + | | Abamectin + | EXPECTED | OBSERVED |
| A5 | Lambda-Cyhalothrin | COMPOUND A5 | Lambda-Cyhalothrin | CONTROL | CONTROL |
| 0.2 | 1.6 + 0.2 | 0 | 40 | 40 | 90* |
| 0.1 | 0.8 + 0.1 | 0 | 35 | 35 | 35 |
| 0.2 | 0.8 + 0.1 | 0 | 35 | 35 | 20 |
| 0.1 | 0.4 + 0.05 | 0 | 10 | 10 | 0 |
| 0.05 | 0.2 + 0.025 | 0 | 25 | 25 | 0 |
| 0.1 | 0.2 + 0.025 | 0 | 25 | 25 | 0 |
| 0.4 | 0.4 + 0.05 | 75 | 10 | 78 | 35 |
| 0.2 | 0.2 + 0.025 | 0 | 25 | 25 | 0 |
| 0.8 | 0.4 + 0.05 | 85 | 10 | 87 | 85 |
| 0.4 | 0.2 + 0.025 | 75 | 25 | 81 | 55 |

TABLE 4

| PPM Al | | AVERAGE CONTROL IN % | | | |
|---|---|---|---|---|---|
| COMPOUND | Spirotetramat + | | Spirotetramat + | EXPECTED | OBSERVED |
| A5 | Lambda-Cyhalothrin | COMPOUND A5 | Lambda-Cyhalothrin | CONTROL | CONTROL |
| 0.2 | 800 + 0.2 | 0 | 90 | 90 | 100* |
| 0.1 | 400 + 0.1 | 0 | 40 | 40 | 95* |
| 0.05 | 200 + 0.05 | 0 | 10 | 10 | 50* |
| 0.2 | 400 + 0.1 | 0 | 40 | 40 | 90* |
| 0.1 | 200 + 0.05 | 0 | 10 | 10 | 65* |
| 0.4 | 200 + 0.05 | 78 | 10 | 80 | 25 |
| 0.2 | 100 + 0.025 | 0 | 0 | 0 | 35* |
| 0.8 | 200 + 0.05 | 90 | 10 | 91 | 75 |
| 0.4 | 100 + 0.025 | 78 | 0 | 78 | 85* |

TABLE 5

| PPM Al | | AVERAGE CONTROL IN % | | | |
|---|---|---|---|---|---|
| COMPOUND | Sulfoxaflor + | COMPOUND | Sulfoxaflor + | EXPECTED | OBSERVED |
| A5 | Lambda-Cyhalothrin | A5 | Lambda-Cyhalothrin | CONTROL | CONTROL |
| 0.2 | 800 + 0.2 | 0 | 75 | 75 | 75 |
| 0.1 | 400 + 0.1 | 0 | 50 | 50 | 35 |
| 0.05 | 200 + 0.05 | 0 | 25 | 25 | 10 |
| 0.2 | 400 + 0.1 | 0 | 50 | 50 | 20 |
| 0.1 | 200 + 0.05 | 0 | 25 | 25 | 10 |
| 0.2 | 200 + 0.05 | 0 | 25 | 25 | 25 |
| 0.4 | 200 + 0.05 | 78 | 25 | 83 | 35 |
| 0.2 | 100 + 0.025 | 0 | 0 | 0 | 50* |
| 0.8 | 200 + 0.05 | 90 | 25 | 93 | 75 |
| 0.4 | 100 + 0.025 | 78 | 0 | 78 | 80* |
| 0.2 | 50 + 0.0125 | 0 | 0 | 0 | 25* |

Tetranvchus urticae (Two-Spotted Spider Mite)

Bean leaf discs on agar in 24-well microtiter plates are sprayed with test solutions (DMSO). After drying, the leaf discs are infested with mite populations of mixed ages. 8 days later, discs are checked for mixed population mortality. Application rates are as indicated in the Tables.

TABLE 6

| PPM Al | | AVERAGE CONTROL IN % | | | |
|---|---|---|---|---|---|
| COMPOUND | Thiamethoxam + | COMPOUND | Thiamethoxam + | EXPECTED | OBSERVED |
| A5 | Lambda-Cyhalothrin | A5 | Lambda-Cyhalothrin | CONTROL | CONTROL |
| 0.2 | 800 + 0.2 | 0 | 80 | 80 | 50 |
| 0.1 | 400 + 0.1 | 0 | 50 | 50 | 25 |
| 0.2 | 400 + 0.1 | 0 | 50 | 50 | 90* |
| 0.1 | 200 + 0.05 | 0 | 25 | 25 | 25 |
| 0.2 | 200 + 0.05 | 0 | 25 | 25 | 0 |
| 0.4 | 200 + 0.05 | 65 | 25 | 74 | 80* |
| 0.2 | 100 + 0.025 | 0 | 0 | 0 | 25* |
| 0.8 | 200 + 0.05 | 73 | 25 | 79 | 100* |
| 0.4 | 100 + 0.025 | 65 | 0 | 65 | 100* |
| 0.2 | 50 + 0.0125 | 0 | 0 | 0 | 65* |

TABLE 7

| PPM Al | | AVERAGE CONTROL IN % | | | |
|---|---|---|---|---|---|
| COMPOUND | Abamectin + | COMPOUND | Abamectin + | EXPECTED | OBSERVED |
| A5 | Lambda-Cyhalothrin | A5 | Lambda-Cyhalothrin | CONTROL | CONTROL |
| 0.2 | 0.1 + 0.2 | 0 | 65 | 65 | 90* |
| 0.1 | 0.05 + 0.1 | 0 | 25 | 25 | 40* |
| 0.05 | 0.025 + 0.05 | 0 | 0 | 0 | 25* |
| 0.2 | 0.05 + 0.1 | 0 | 25 | 25 | 90* |
| 0.1 | 0.025 + 0.05 | 0 | 0 | 0 | 65* |
| 0.2 | 0.025 + 0.05 | 0 | 0 | 0 | 80* |
| 0.4 | 0.025 + 0.05 | 65 | 0 | 65 | 90* |
| 0.2 | 0.0125 + 0.025 | 0 | 0 | 0 | 25* |
| 0.05 | 0.003 + 0.00625 | 0 | 0 | 0 | 25* |
| 0.8 | 0.025 + 0.05 | 73 | 0 | 73 | 100* |
| 0.4 | 0.0125 + 0.025 | 65 | 0 | 65 | 80* |
| 0.2 | 0.00.6125 + 0.0125 | 0 | 0 | 0 | 65* |
| 0.1 | 0.003 + 0.00625 | 0 | 0 | 0 | 25* |

TABLE 8

| PPM Al | | AVERAGE CONTROL IN % | | | |
|---|---|---|---|---|---|
| COMPOUND | Spirotetramat + | COMPOUND | Spirotetramat + | EXPECTED | OBSERVED |
| A5 | Lambda-Cyhalothrin | A5 | Lambda-Cyhalothrin | CONTROL | CONTROL |
| 0.2 | 25.0 + 0.2 | 38 | 100 | 100 | 80 |
| 0.1 | 12.5 + 0.1 | 0 | 90 | 90 | 90 |
| 0.05 | 6.25 + 0.05 | 0 | 65 | 65 | 65 |
| 0.025 | 3.125 + 0.025 | 0 | 0 | 0 | 65* |
| 0.0125 | 1.56 + 0.025 | 0 | 0 | 0 | 25* |
| 0.006 | 0.78 + 0.0125 | 0 | 0 | 0 | 50* |
| 0.2 | 12.5 + 0.1 | 38 | 90 | 94 | 90 |
| 0.1 | 6.25 + 0.05 | 0 | 65 | 65 | 65 |
| 0.05 | 3.125 + 0.025 | 0 | 0 | 0 | 65* |
| 0.025 | 1.56 + 0.025 | 0 | 0 | 0 | 25* |
| 0.2 | 6.25 + 0.05 | 38 | 65 | 78 | 80* |
| 0.1 | 3.125 + 0.025 | 0 | 0 | 0 | 40* |
| 0.05 | 1.56 + 0.025 | 0 | 0 | 0 | 25* |
| 0.4 | 6.25 + 0.05 | 73 | 65 | 90 | 80 |
| 0.2 | 3.125 + 0.025 | 38 | 0 | 38 | 0 |
| 0.8 | 6.25 + 0.05 | 90 | 65 | 97 | 100* |
| 0.4 | 3.125 + 0.025 | 73 | 0 | 73 | 75* |
| 0.2 | 1.56 + 0.025 | 38 | 0 | 38 | 65* |

TABLE 9

| PPM Al | | AVERAGE CONTROL IN % | | | |
|---|---|---|---|---|---|
| COMPOUND | Sulfoxaflor + | | Sulfoxaflor + | EXPECTED | OBSERVED |
| A5 | Lambda-Cyhalothrin | COMPOUND A5 | Lambda-Cyhalothrin | CONTROL | CONTROL |
| 0.2 | 800 + 0.2 | 38 | 0 | 38 | 25 |
| 0.1 | 400 + 0.1 | 0 | 0 | 0 | 25* |
| 0.2 | 400 + 0.1 | 38 | 0 | 38 | 65* |
| 0.1 | 200 + 0.05 | 0 | 0 | 0 | 25* |
| 0.2 | 200 + 0.05 | 38 | 0 | 38 | 25 |
| 0.1 | 100 + 0.025 | 0 | 0 | 0 | 25* |
| 0.025 | 25 + 0.00625 | 0 | 0 | 0 | 50* |
| 0.4 | 200 + 0.05 | 73 | 0 | 73 | 65 |
| 0.2 | 100 + 0.025 | 38 | 0 | 38 | 0 |
| 0.8 | 200 + 0.05 | 90 | 0 | 90 | 100* |
| 0.4 | 100 + 0.025 | 73 | 0 | 73 | 90* |
| 0.2 | 50 + 0.0125 | 38 | 0 | 38 | 80* |

Pythium ultimum (Damping off):

Mycelial fragments of the fungus, prepared from a fresh liquid culture, were directly mixed into nutrient broth (potato dextrose broth). After placing a (DMSO) solution of the test compounds into a microtiter plate (96-well format) the nutrient broth containing the fungal spores was added. The test plates were incubated at 24° C. and the inhibition of growth was determined photometrically after 48 hours. Application rates are shown in the Tables.

TABLE 10

| PPM Al | | AVERAGE CONTROL IN % | | | |
|---|---|---|---|---|---|
| COMPOUND | Lambda Cyhalothrin + | | Lambda Cyhalothrin + | EXPECTED | OBSERVED |
| A5 | Azoxystrobin | COMPOUND A5 | Azoxystrobin | CONTROL | CONTROL |
| 60 | 5 + 0.5 | 0 | 50 | 50 | 20 |
| 30 | 2.5 + 0.25 | 0 | 20 | 20 | 20 |
| 15 | 1.25 + 0.125 | 0 | 20 | 20 | 20 |
| 60 | 10 + 1 | 0 | 50 | 50 | 20 |
| 30 | 5 + 0.5 | 0 | 50 | 50 | 20 |
| 15 | 2.5 + 0.25 | 0 | 20 | 20 | 20 |
| 7.5 | 1.25 + 0.125 | 0 | 20 | 20 | 20 |
| 60 | 20 + 2 | 0 | 90 | 90 | 70 |
| 30 | 10 + 1 | 0 | 50 | 50 | 50 |
| 15 | 5 + 0.5 | 0 | 50 | 50 | 20 |
| 7.5 | 2.5 + 0.25 | 0 | 20 | 20 | 20 |
| 3.75 | 1.25 + 0.125 | 0 | 20 | 20 | 20 |
| 30 | 20 + 2 | 0 | 90 | 90 | 70 |
| 15 | 10 + 1 | 0 | 50 | 50 | 50 |
| 7.5 | 5 + 0.5 | 0 | 50 | 50 | 20 |
| 3.75 | 2.5 + 0.25 | 0 | 20 | 20 | 20 |
| 1.875 | 1.25 + 0.125 | 0 | 20 | 20 | 20 |
| 15 | 20 + 2 | 0 | 90 | 90 | 70 |
| 7.5 | 10 + 1 | 0 | 50 | 50 | 50 |
| 3.75 | 5 + 0.5 | 0 | 50 | 50 | 50 |
| 1.875 | 2.5 + 0.25 | 0 | 20 | 20 | 20 |
| 0.9375 | 1.25 + 0.125 | 0 | 20 | 20 | 20 |

TABLE 11

| PPM Al | | AVERAGE CONTROL IN % | | | |
|---|---|---|---|---|---|
| | Sulfoxaflor + | | Sulfoxaflor + | EXPECTED | OBSERVED |
| COMPOUND A5 | Azoxystrobin | COMPOUND A5 | Azoxystrobin | CONTROL | CONTROL |
| 60 | 5 + 0.5 | 0 | 20 | 20 | 20 |
| 30 | 2.5 + 0.25 | 0 | 20 | 20 | 20 |
| 15 | 1.25 + 0.125 | 0 | 20 | 20 | 20 |
| 60 | 10 + 1 | 0 | 50 | 50 | 20 |
| 30 | 5 + 0.5 | 0 | 20 | 20 | 20 |
| 15 | 2.5 + 0.25 | 0 | 20 | 20 | 20 |
| 7.5 | 1.25 + 0.125 | 0 | 20 | 20 | 0 |
| 60 | 20 + 2 | 0 | 70 | 70 | 70 |
| 30 | 10 + 1 | 0 | 50 | 50 | 50 |
| 15 | 5 + 0.5 | 0 | 20 | 20 | 20 |
| 7.5 | 2.5 + 0.25 | 0 | 20 | 20 | 20 |
| 3.75 | 1.25 + 0.125 | 0 | 20 | 20 | 20 |
| 30 | 20 + 2 | 0 | 70 | 70 | 50 |
| 15 | 10 + 1 | 0 | 50 | 50 | 50 |
| 7.5 | 5 + 0.5 | 0 | 20 | 20 | 20 |
| 3.75 | 2.5 + 0.25 | 0 | 20 | 20 | 20 |
| 1.875 | 1.25 + 0.125 | 0 | 20 | 20 | 0 |
| 15 | 20 + 2 | 0 | 70 | 70 | 70 |
| 7.5 | 10 + 1 | 0 | 50 | 50 | 50 |
| 3.75 | 5 + 0.5 | 0 | 20 | 20 | 50* |
| 1.875 | 2.5 + 0.25 | 0 | 20 | 20 | 50* |
| 0.9375 | 1.25 + 0.125 | 0 | 20 | 20 | 20 |

TABLE 12

| PPM Al | | AVERAGE CONTROL IN % | | | |
|---|---|---|---|---|---|
| | Abamectin + | | Abamectin + | EXPECTED | OBSERVED |
| COMPOUND A5 | Azoxystrobin | COMPOUND A5 | Azoxystrobin | CONTROL | CONTROL |
| 60 | 5 + 0.5 | 0 | 20 | 20 | 20 |
| 30 | 2.5 + 0.25 | 0 | 20 | 20 | 20 |
| 15 | 1.25 + 0.125 | 0 | 20 | 20 | 20 |
| 60 | 10 + 1 | 0 | 50 | 50 | 20 |
| 30 | 5 + 0.5 | 0 | 20 | 20 | 20 |
| 15 | 2.5 + 0.25 | 0 | 20 | 20 | 20 |
| 7.5 | 1.25 + 0.125 | 0 | 20 | 20 | 20 |
| 60 | 20 + 2 | 0 | 70 | 70 | 50 |
| 30 | 10 + 1 | 0 | 50 | 50 | 50 |
| 15 | 5 + 0.5 | 0 | 20 | 20 | 20 |
| 7.5 | 2.5 + 0.25 | 0 | 20 | 20 | 20 |
| 3.75 | 1.25 + 0.125 | 0 | 20 | 20 | 20 |
| 30 | 20 + 2 | 0 | 70 | 70 | 50 |
| 15 | 10 + 1 | 0 | 50 | 50 | 50 |
| 7.5 | 5 + 0.5 | 0 | 20 | 20 | 20 |
| 3.75 | 2.5 + 0.25 | 0 | 20 | 20 | 20 |
| 1.875 | 1.25 + 0.125 | 0 | 20 | 20 | 0 |
| 15 | 20 + 2 | 0 | 70 | 70 | 70 |
| 7.5 | 10 + 1 | 0 | 50 | 50 | 50 |
| 3.75 | 5 + 0.5 | 0 | 20 | 20 | 20 |
| 1.875 | 2.5 + 0.25 | 0 | 20 | 20 | 20 |
| 0.9375 | 1.25 + 0.125 | 0 | 20 | 20 | 20 |

TABLE 13

| PPM Al | | AVERAGE CONTROL IN % | | | |
|---|---|---|---|---|---|
| | Thiamethoxam + | | Thiamethoxam + | EXPECTED | OBSERVED |
| COMPOUND A5 | Azoxystrobin | COMPOUND A5 | Azoxystrobin | CONTROL | CONTROL |
| 60 | 5 + 0.5 | 0 | 50 | 50 | 50 |
| 30 | 2.5 + 0.25 | 0 | 50 | 50 | 20 |
| 15 | 1.25 + 0.125 | 0 | 20 | 20 | 20 |
| 60 | 10 + 1 | 0 | 50 | 50 | 50 |
| 30 | 5 + 0.5 | 0 | 50 | 50 | 50 |
| 15 | 2.5 + 0.25 | 0 | 50 | 50 | 20 |
| 7.5 | 1.25 + 0.125 | 0 | 20 | 20 | 20 |
| 3.75 | 0.625 + 0.0625 | 0 | 0 | 0 | 0 |
| 60 | 20 + 2 | 0 | 70 | 70 | 50 |
| 30 | 10 + 1 | 0 | 50 | 50 | 50 |
| 15 | 5 + 0.5 | 0 | 50 | 50 | 50 |
| 7.5 | 2.5 + 0.25 | 0 | 50 | 50 | 20 |
| 3.75 | 1.25 + 0.125 | 0 | 20 | 20 | 20 |
| 30 | 20 + 2 | 0 | 70 | 70 | 50 |
| 15 | 10 + 1 | 0 | 50 | 50 | 50 |
| 7.5 | 5 + 0.5 | 0 | 50 | 50 | 20 |
| 3.75 | 2.5 + 0.25 | 0 | 50 | 50 | 20 |
| 1.875 | 1.25 + 0.125 | 0 | 20 | 20 | 20 |
| 15 | 20 + 2 | 0 | 70 | 70 | 50 |
| 7.5 | 10 + 1 | 0 | 50 | 50 | 50 |
| 3.75 | 5 + 0.5 | 0 | 50 | 50 | 50 |
| 1.875 | 2.5 + 0.25 | 0 | 50 | 50 | 20 |
| 0.9375 | 1.25 + 0.125 | 0 | 20 | 20 | 20 |
| 0.46875 | 0.625 + 0.0625 | 0 | 0 | 0 | 20* |

Rhizoctonia solani (Foot Rot, Damping-Off):

Mycelial fragments of the fungus from cryogenic storage were directly mixed into nutrient broth (potato dextrose broth). After placing a (DMSO) solution of the test compounds into a microtiter plate (96-well format) the nutrient broth containing the fungal spores was added. The test plates were incubated at 24° C. and the inhibition of growth was determined photometrically after 48 hours. Application rates are shown in the Tables.

TABLE 14

| PPM Al | | AVERAGE CONTROL IN % | | | |
|---|---|---|---|---|---|
| | Lambda | | Lambda | | |
| | Cyhalothrin + | | Cyhalothrin + | EXPECTED | OBSERVED |
| COMPOUND A5 | COMPOUND II | COMPOUND A5 | COMPOUND II | CONTROL | CONTROL |
| 3.75 | 0.3125 + 0.03125 | 0 | 70 | 70 | 70 |
| 1.875 | 0.3125 + 0.03125 | 0 | 70 | 70 | 70 |
| 0.9375 | 0.3125 + 0.03125 | 0 | 70 | 70 | 70 |
| 0.46875 | 0.3125 + 0.03125 | 0 | 70 | 70 | 70 |
| 0.46875 | 0.625 + 0.0625 | 0 | 100 | 100 | 90 |
| 0.234375 | 0.3125 + 0.03125 | 0 | 70 | 70 | 50 |

TABLE 15

| PPM Al | | AVERAGE CONTROL IN % | | | |
|---|---|---|---|---|---|
| COMPOUND | Sulfoxaflor + | | Sulfoxaflor + | EXPECTED | OBSERVED |
| A5 | COMPOUND II | COMPOUND A5 | COMPOUND II | CONTROL | CONTROL |
| 7.5 | 0.625 + 0.0625 | 0 | 90 | 90 | 90 |
| 3.75 | 0.3125 + 0.03125 | 0 | 20 | 20 | 50* |
| 3.75 | 0.625 + 0.0625 | 0 | 90 | 90 | 90 |
| 1.875 | 0.3125 + 0.03125 | 0 | 20 | 20 | 90* |
| 1.875 | 0.625 + 0.0625 | 0 | 90 | 90 | 100* |
| 0.9375 | 0.625 + 0.0625 | 0 | 90 | 90 | 90 |
| 0.46875 | 0.3125 + 0.03125 | 0 | 20 | 20 | 0 |
| 0.46875 | 0.625 + 0.0625 | 0 | 90 | 90 | 90 |
| 0.234375 | 0.3125 + 0.03125 | 0 | 20 | 20 | 70* |

TABLE 16

| PPM Al | | AVERAGE CONTROL IN % | | | |
|---|---|---|---|---|---|
| COMPOUND | Abamectin + | | Abamectin + | EXPECTED | OBSERVED |
| A5 | COMPOUND II | COMPOUND A5 | COMPOUND II | CONTROL | CONTROL |
| 7.5 | 0.625 + 0.0625 | 0 | 90 | 90 | 90 |
| 3.75 | 0.625 + 0.0625 | 0 | 90 | 90 | 90 |
| 1.875 | 0.3125 + 0.03125 | 0 | 0 | 0 | 50* |
| 1.875 | 0.625 + 0.0625 | 0 | 90 | 90 | 90 |
| 0.9375 | 0.3125 + 0.03125 | 0 | 0 | 0 | 20* |
| 0.9375 | 0.625 + 0.0625 | 0 | 90 | 90 | 90 |
| 0.46875 | 0.3125 + 0.03125 | 0 | 0 | 0 | 20* |
| 0.46875 | 0.625 + 0.0625 | 0 | 90 | 90 | 90 |
| 0.234375 | 0.3125 + 0.03125 | 0 | 0 | 0 | 70* |
| 0.1171875 | 0.15625 + 0.01563 | 0 | 0 | 0 | 20* |

TABLE 17

| PPM Al | | AVERAGE CONTROL IN % | | | |
|---|---|---|---|---|---|
| COMPOUND | Thiamethoxam + | | Thiamethoxam + | EXPECTED | OBSERVED |
| A5 | COMPOUND II | COMPOUND A5 | COMPOUND II | CONTROL | CONTROL |
| 7.5 | 0.625 + 0.0625 | 0 | 90 | 90 | 90 |
| 3.75 | 0.625 + 0.0625 | 0 | 90 | 90 | 90 |
| 1.875 | 0.625 + 0.0625 | 0 | 90 | 90 | 90 |
| 0.9375 | 0.3125 + 0.03125 | 0 | 0 | 0 | 20* |
| 0.9375 | 0.625 + 0.0625 | 0 | 90 | 90 | 90 |
| 0.46875 | 0.625 + 0.0625 | 0 | 90 | 90 | 90 |
| 0.234375 | 0.3125 + 0.03125 | 0 | 0 | 0 | 20* |

TABLE 18

| PPM Al | | AVERAGE CONTROL IN % | | | |
|---|---|---|---|---|---|
| COMPOUND | Lambda Cyhalothrin + | | Lambda Cyhalothrin + | EXPECTED | OBSERVED |
| A5 | Azoxystrobin | COMPOUND A5 | Azoxystrobin | CONTROL | CONTROL |
| 60 | 5 + 0.5 | 0 | 20 | 20 | 0 |
| 30 | 2.5 + 0.25 | 0 | 20 | 20 | 0 |
| 60 | 10 + 1 | 0 | 20 | 20 | 0 |
| 30 | 5 + 0.5 | 0 | 20 | 20 | 0 |
| 15 | 2.5 + 0.25 | 0 | 20 | 20 | 0 |
| 60 | 20 + 2 | 0 | 20 | 20 | 20 |
| 30 | 10 + 1 | 0 | 20 | 20 | 0 |
| 15 | 5 + 0.5 | 0 | 20 | 20 | 0 |
| 7.5 | 2.5 + 0.25 | 0 | 20 | 20 | 0 |
| 30 | 20 + 2 | 0 | 20 | 20 | 20 |
| 15 | 10 + 1 | 0 | 20 | 20 | 0 |
| 7.5 | 5 + 0.5 | 0 | 20 | 20 | 0 |
| 3.75 | 2.5 + 0.25 | 0 | 20 | 20 | 0 |
| 15 | 20 + 2 | 0 | 20 | 20 | 20 |
| 7.5 | 10 + 1 | 0 | 20 | 20 | 20 |
| 3.75 | 5 + 0.5 | 0 | 20 | 20 | 20 |
| 1.875 | 2.5 + 0.25 | 0 | 20 | 20 | 0 |

TABLE 19

| PPM Al | | AVERAGE CONTROL IN % | | | |
|---|---|---|---|---|---|
| COMPOUND | Sulfoxaflor + | | Sulfoxaflor + | EXPECTED | OBSERVED |
| A5 | Azoxystrobin | COMPOUND A5 | Azoxystrobin | CONTROL | CONTROL |
| 60 | 10 + 1 | 0 | 0 | 0 | 20* |
| 60 | 20 + 2 | 0 | 20 | 20 | 20 |
| 30 | 10 + 1 | 0 | 0 | 0 | 20* |
| 30 | 20 + 2 | 0 | 20 | 20 | 20 |
| 15 | 10 + 1 | 0 | 0 | 0 | 20* |
| 15 | 20 + 2 | 0 | 20 | 20 | 20 |
| 7.5 | 10 + 1 | 0 | 0 | 0 | 20* |

TABLE 20

| PPM Al | | AVERAGE CONTROL IN % | | | |
|---|---|---|---|---|---|
| COMPOUND | Abamectin + | | Abamectin + | EXPECTED | OBSERVED |
| A5 | Azoxystrobin | COMPOUND A5 | Azoxystrobin | CONTROL | CONTROL |
| 60 | 5 + 0.5 | 0 | 20 | 20 | 0 |
| 60 | 10 + 1 | 0 | 20 | 20 | 20 |
| 30 | 5 + 0.5 | 0 | 20 | 20 | 20 |
| 60 | 20 + 2 | 0 | 20 | 20 | 20 |
| 30 | 10 + 1 | 0 | 20 | 20 | 20 |
| 15 | 5 + 0.5 | 0 | 20 | 20 | 0 |
| 30 | 20 + 2 | 0 | 20 | 20 | 20 |
| 15 | 10 + 1 | 0 | 20 | 20 | 0 |
| 7.5 | 5 + 0.5 | 0 | 20 | 20 | 0 |
| 15 | 20 + 2 | 0 | 20 | 20 | 20 |
| 7.5 | 10 + 1 | 0 | 20 | 20 | 20 |
| 3.75 | 5 + 0.5 | 0 | 20 | 20 | 20 |

TABLE 21

| PPM Al | | AVERAGE CONTROL IN % | | | |
|---|---|---|---|---|---|
| COMPOUND | Thiamethoxam + | | Thiamethoxam + | EXPECTED | OBSERVED |
| A5 | Azoxystrobin | COMPOUND A5 | Azoxystrobin | CONTROL | CONTROL |
| 60 | 5 + 0.5 | 0 | 20 | 20 | 0 |
| 30 | 2.5 + 0.25 | 0 | 20 | 20 | 0 |
| 15 | 1.25 + 0.125 | 0 | 0 | 0 | 0 |
| 60 | 10 + 1 | 0 | 20 | 20 | 20 |
| 30 | 5 + 0.5 | 0 | 20 | 20 | 0 |
| 15 | 2.5 + 0.25 | 0 | 20 | 20 | 0 |
| 60 | 20 + 2 | 0 | 20 | 20 | 50* |
| 30 | 10 + 1 | 0 | 20 | 20 | 0 |
| 15 | 5 + 0.5 | 0 | 20 | 20 | 0 |
| 7.5 | 2.5 + 0.25 | 0 | 20 | 20 | 0 |
| 30 | 20 + 2 | 0 | 20 | 20 | 20 |
| 15 | 10 + 1 | 0 | 20 | 20 | 0 |
| 7.5 | 5 + 0.5 | 0 | 20 | 20 | 0 |
| 3.75 | 2.5 + 0.25 | 0 | 20 | 20 | 0 |
| 15 | 20 + 2 | 0 | 20 | 20 | 50* |
| 7.5 | 10 + 1 | 0 | 20 | 20 | 50* |
| 3.75 | 5 + 0.5 | 0 | 20 | 20 | 20 |
| 1.875 | 2.5 + 0.25 | 0 | 20 | 20 | 20 |
| 0.9375 | 1.25 + 0.125 | 0 | 0 | 0 | 20* |

Gaeumannomvces graminis:

Mycelial fragments of the fungus from cryogenic storage were directly mixed into nutrient broth (potato dextrose broth). After placing a (DMSO) solution of the test compounds into a microtiter plate (96-well format) the nutrient broth containing the fungal spores was added. The test plates were incubated at 24° C. and the inhibition of growth was determined photometrically after 48 hours at 620 nm. Application rates are shown in the Tables.

TABLE 22

| PPM Al | | AVERAGE CONTROL IN % | | | |
|---|---|---|---|---|---|
| COMPOUND | Lambda Cyhalothrin + | | Lambda Cyhalothrin + | EXPECTED | OBSERVED |
| A5 | COMPOUND II | COMPOUND A5 | COMPOUND II | CONTROL | CONTROL |
| 60 | 5 + 0.5 | 20 | 50 | 60 | 70* |
| 30 | 2.5 + 0.25 | 20 | 70 | 76 | 50 |
| 15 | 1.25 + 0.125 | 20 | 90 | 92 | 70 |
| 7.5 | 0.625 + 0.0625 | 20 | 90 | 92 | 70 |
| 3.75 | 0.3125 + 0.03125 | 20 | 70 | 76 | 70 |
| 1.875 | 0.15625 + 0.01563 | 20 | 50 | 60 | 50 |
| 0.9375 | 0.07813 + 0.00781 | 20 | 0 | 20 | 20 |
| 60 | 10 + 1 | 20 | 50 | 60 | 100* |
| 30 | 5 + 0.5 | 20 | 50 | 60 | 50 |
| 15 | 2.5 + 0.25 | 20 | 70 | 76 | 50 |
| 7.5 | 1.25 + 0.125 | 20 | 90 | 92 | 70 |
| 3.75 | 0.625 + 0.0625 | 20 | 90 | 92 | 70 |
| 1.875 | 0.3125 + 0.03125 | 20 | 70 | 76 | 70 |
| 0.9375 | 0.15625 + 0.01563 | 20 | 50 | 60 | 50 |
| 60 | 20 + 2 | 20 | 70 | 76 | 100* |
| 30 | 10 + 1 | 20 | 50 | 60 | 70* |
| 15 | 5 + 0.5 | 20 | 50 | 60 | 50 |
| 7.5 | 2.5 + 0.25 | 20 | 70 | 76 | 50 |
| 3.75 | 1.25 + 0.125 | 20 | 90 | 92 | 70 |
| 1.875 | 0.625 + 0.0625 | 20 | 90 | 92 | 70 |
| 0.9375 | 0.3125 + 0.03125 | 20 | 70 | 76 | 70 |
| 0.46875 | 0.15625 + 0.01563 | 0 | 50 | 50 | 50 |
| 30 | 20 + 2 | 20 | 70 | 76 | 100* |
| 15 | 10 + 1 | 20 | 50 | 60 | 70* |
| 7.5 | 5 + 0.5 | 20 | 50 | 60 | 50 |
| 3.75 | 2.5 + 0.25 | 20 | 70 | 76 | 50 |
| 1.875 | 1.25 + 0.125 | 20 | 90 | 92 | 70 |
| 0.9375 | 0.625 + 0.0625 | 20 | 90 | 92 | 90 |
| 0.46875 | 0.3125 + 0.03125 | 0 | 70 | 70 | 70 |
| 0.234375 | 0.15625 + 0.01563 | 0 | 50 | 50 | 50 |
| 15 | 20 + 2 | 20 | 70 | 76 | 90* |
| 7.5 | 10 + 1 | 20 | 50 | 60 | 50 |
| 3.75 | 5 + 0.5 | 20 | 50 | 60 | 50 |
| 1.875 | 2.5 + 0.25 | 20 | 70 | 76 | 50 |
| 0.9375 | 1.25 + 0.125 | 20 | 90 | 92 | 70 |
| 0.46875 | 0.625 + 0.0625 | 0 | 90 | 90 | 90 |
| 0.234375 | 0.3125 + 0.03125 | 0 | 70 | 70 | 70 |
| 0.1171875 | 0.15625 + 0.01563 | 0 | 50 | 50 | 50 |

TABLE 23

| PPM Al | | AVERAGE CONTROL IN % | | | |
|---|---|---|---|---|---|
| COMPOUND | Sulfoxaflor + | | Sulfoxaflor + | EXPECTED | OBSERVED |
| A5 | COMPOUND II | COMPOUND A5 | COMPOUND II | CONTROL | CONTROL |
| 60 | 5 + 0.5 | 20 | 100 | 100 | 70 |
| 30 | 2.5 + 0.25 | 20 | 100 | 100 | 70 |
| 15 | 1.25 + 0.125 | 20 | 100 | 100 | 70 |
| 7.5 | 0.625 + 0.0625 | 20 | 90 | 92 | 70 |
| 3.75 | 0.3125 + 0.03125 | 20 | 70 | 76 | 70 |
| 1.875 | 0.15625 + 0.01563 | 20 | 20 | 36 | 20 |
| 0.9375 | 0.07813 + 0.00781 | 20 | 0 | 20 | 0 |
| 60 | 10 + 1 | 20 | 100 | 100 | 70 |
| 30 | 5 + 0.5 | 20 | 100 | 100 | 70 |
| 15 | 2.5 + 0.25 | 20 | 100 | 100 | 70 |
| 7.5 | 1.25 + 0.125 | 20 | 100 | 100 | 70 |
| 3.75 | 0.625 + 0.0625 | 20 | 90 | 92 | 70 |
| 1.875 | 0.3125 + 0.03125 | 20 | 70 | 76 | 70 |
| 0.9375 | 0.15625 + 0.01563 | 20 | 20 | 36 | 20 |
| 60 | 20 + 2 | 20 | 100 | 100 | 70 |
| 30 | 10 + 1 | 20 | 100 | 100 | 70 |
| 15 | 5 + 0.5 | 20 | 100 | 100 | 70 |
| 7.5 | 2.5 + 0.25 | 20 | 100 | 100 | 70 |
| 3.75 | 1.25 + 0.125 | 20 | 100 | 100 | 70 |
| 1.875 | 0.625 + 0.0625 | 20 | 90 | 92 | 70 |
| 0.9375 | 0.3125 + 0.03125 | 20 | 70 | 76 | 70 |
| 0.46875 | 0.15625 + 0.01563 | 0 | 20 | 20 | 20 |
| 30 | 20 + 2 | 20 | 100 | 100 | 70 |
| 15 | 10 + 1 | 20 | 100 | 100 | 70 |
| 7.5 | 5 + 0.5 | 20 | 100 | 100 | 70 |
| 3.75 | 2.5 + 0.25 | 20 | 100 | 100 | 70 |
| 1.875 | 1.25 + 0.125 | 20 | 100 | 100 | 70 |
| 0.9375 | 0.625 + 0.0625 | 20 | 90 | 92 | 70 |
| 0.46875 | 0.3125 + 0.03125 | 0 | 70 | 70 | 70 |
| 0.234375 | 0.15625 + 0.01563 | 0 | 20 | 20 | 70* |
| 15 | 20 + 2 | 20 | 100 | 100 | 90 |
| 7.5 | 10 + 1 | 20 | 100 | 100 | 90 |
| 3.75 | 5 + 0.5 | 20 | 100 | 100 | 90 |
| 1.875 | 2.5 + 0.25 | 20 | 100 | 100 | 90 |
| 0.9375 | 1.25 + 0.125 | 20 | 100 | 100 | 90 |
| 0.46875 | 0.625 + 0.0625 | 0 | 90 | 90 | 90 |
| 0.234375 | 0.3125 + 0.03125 | 0 | 70 | 70 | 70 |
| 0.1171875 | 0.15625 + 0.01563 | 0 | 20 | 20 | 50* |

TABLE 24

| PPM Al | | AVERAGE CONTROL IN % | | | |
|---|---|---|---|---|---|
| COMPOUND | Abamectin + | | Abamectin + | EXPECTED | OBSERVED |
| A5 | COMPOUND II | COMPOUND A5 | COMPOUND II | CONTROL | CONTROL |
| 60 | 5 + 0.5 | 20 | 100 | 100 | 70 |
| 30 | 2.5 + 0.25 | 20 | 100 | 100 | 70 |
| 15 | 1.25 + 0.125 | 20 | 100 | 100 | 70 |
| 7.5 | 0.625 + 0.0625 | 20 | 90 | 92 | 70 |
| 3.75 | 0.3125 + 0.03125 | 20 | 70 | 76 | 50 |
| 1.875 | 0.15625 + 0.01563 | 20 | 20 | 36 | 20 |
| 0.9375 | 0.07813 + 0.00781 | 0 | 0 | 0 | 0 |
| 0.46875 | 0.03906 + 0.00391 | 0 | 0 | 0 | 0 |
| 60 | 10 + 1 | 20 | 100 | 100 | 70 |
| 30 | 5 + 0.5 | 20 | 100 | 100 | 70 |
| 15 | 2.5 + 0.25 | 20 | 100 | 100 | 70 |
| 7.5 | 1.25 + 0.125 | 20 | 100 | 100 | 70 |
| 3.75 | 0.625 + 0.0625 | 20 | 90 | 92 | 70 |
| 1.875 | 0.3125 + 0.03125 | 20 | 70 | 76 | 70 |
| 0.9375 | 0.15625 + 0.01563 | 0 | 20 | 20 | 50* |
| 0.46875 | 0.07813 + 0.00781 | 0 | 0 | 0 | 0 |
| 0.234375 | 0.03906 + 0.00391 | 0 | 0 | 0 | 0 |
| 60 | 20 + 2 | 20 | 100 | 100 | 100 |
| 30 | 10 + 1 | 20 | 100 | 100 | 70 |
| 15 | 5 + 0.5 | 20 | 100 | 100 | 70 |
| 7.5 | 2.5 + 0.25 | 20 | 100 | 100 | 70 |
| 3.75 | 1.25 + 0.125 | 20 | 100 | 100 | 70 |
| 1.875 | 0.625 + 0.0625 | 20 | 90 | 92 | 70 |
| 0.9375 | 0.3125 + 0.03125 | 0 | 70 | 70 | 70 |
| 0.46875 | 0.15625 + 0.01563 | 0 | 20 | 20 | 50* |
| 0.234375 | 0.07813 + 0.00781 | 0 | 0 | 0 | 0 |
| 0.1171875 | 0.03906 + 0.00391 | 0 | 0 | 0 | 0 |
| 30 | 20 + 2 | 20 | 100 | 100 | 100 |
| 15 | 10 + 1 | 20 | 100 | 100 | 90 |
| 7.5 | 5 + 0.5 | 20 | 100 | 100 | 90 |
| 3.75 | 2.5 + 0.25 | 20 | 100 | 100 | 90 |
| 1.875 | 1.25 + 0.125 | 20 | 100 | 100 | 90 |
| 0.9375 | 0.625 + 0.0625 | 0 | 90 | 90 | 90 |
| 0.46875 | 0.3125 + 0.03125 | 0 | 70 | 70 | 70 |
| 0.234375 | 0.15625 + 0.01563 | 0 | 20 | 20 | 50* |
| 0.1171875 | 0.07813 + 0.00781 | 0 | 0 | 0 | 0 |
| 15 | 20 + 2 | 20 | 100 | 100 | 100 |
| 7.5 | 10 + 1 | 20 | 100 | 100 | 90 |
| 3.75 | 5 + 0.5 | 20 | 100 | 100 | 90 |
| 1.875 | 2.5 + 0.25 | 20 | 100 | 100 | 90 |
| 0.9375 | 1.25 + 0.125 | 0 | 100 | 100 | 90 |
| 0.46875 | 0.625 + 0.0625 | 0 | 90 | 90 | 90 |
| 0.234375 | 0.3125 + 0.03125 | 0 | 70 | 70 | 90* |
| 0.1171875 | 0.15625 + 0.01563 | 0 | 20 | 20 | 70* |

TABLE 25

| PPM Al | | AVERAGE CONTROL IN % | | | |
|---|---|---|---|---|---|
| COMPOUND | Thiamethoxam + | | Thiamethoxam + | EXPECTED | OBSERVED |
| A5 | COMPOUND II | COMPOUND A5 | COMPOUND II | CONTROL | CONTROL |
| 60 | 5 + 0.5 | 20 | 100 | 100 | 70 |
| 30 | 2.5 + 0.25 | 20 | 100 | 100 | 70 |
| 15 | 1.25 + 0.125 | 20 | 100 | 100 | 70 |
| 7.5 | 0.625 + 0.0625 | 20 | 90 | 92 | 70 |
| 3.75 | 0.3125 + 0.03125 | 20 | 70 | 76 | 50 |
| 1.875 | 0.15625 + 0.01563 | 20 | 0 | 20 | 20 |
| 0.9375 | 0.07813 + 0.00781 | 0 | 0 | 0 | 0 |
| 0.46875 | 0.03906 + 0.00391 | 0 | 0 | 0 | 0 |
| 60 | 10 + 1 | 20 | 100 | 100 | 70 |
| 30 | 5 + 0.5 | 20 | 100 | 100 | 70 |
| 15 | 2.5 + 0.25 | 20 | 100 | 100 | 70 |
| 7.5 | 1.25 + 0.125 | 20 | 100 | 100 | 70 |
| 3.75 | 0.625 + 0.0625 | 20 | 90 | 92 | 70 |
| 1.875 | 0.3125 + 0.03125 | 20 | 70 | 76 | 50 |
| 0.9375 | 0.15625 + 0.01563 | 0 | 0 | 0 | 20* |
| 0.46875 | 0.07813 + 0.00781 | 0 | 0 | 0 | 0 |
| 0.234375 | 0.03906 + 0.00391 | 0 | 0 | 0 | 0 |
| 60 | 20 + 2 | 20 | 100 | 100 | 70 |
| 30 | 10 + 1 | 20 | 100 | 100 | 70 |
| 15 | 5 + 0.5 | 20 | 100 | 100 | 70 |
| 7.5 | 2.5 + 0.25 | 20 | 100 | 100 | 70 |
| 3.75 | 1.25 + 0.125 | 20 | 100 | 100 | 70 |
| 1.875 | 0.625 + 0.0625 | 20 | 90 | 92 | 70 |
| 0.9375 | 0.3125 + 0.03125 | 0 | 70 | 70 | 70 |
| 0.46875 | 0.15625 + 0.01563 | 0 | 0 | 0 | 20* |
| 0.234375 | 0.07813 + 0.00781 | 0 | 0 | 0 | 0 |
| 0.1171875 | 0.03906 + 0.00391 | 0 | 0 | 0 | 0 |
| 30 | 20 + 2 | 20 | 100 | 100 | 70 |
| 15 | 10 + 1 | 20 | 100 | 100 | 70 |
| 7.5 | 5 + 0.5 | 20 | 100 | 100 | 70 |
| 3.75 | 2.5 + 0.25 | 20 | 100 | 100 | 90 |
| 1.875 | 1.25 + 0.125 | 20 | 100 | 100 | 90 |
| 0.9375 | 0.625 + 0.0625 | 0 | 90 | 90 | 90 |
| 0.46875 | 0.3125 + 0.03125 | 0 | 70 | 70 | 70 |
| 0.234375 | 0.15625 + 0.01563 | 0 | 0 | 0 | 50* |
| 0.1171875 | 0.07813 + 0.00781 | 0 | 0 | 0 | 0 |
| 15 | 20 + 2 | 20 | 100 | 100 | 70 |
| 7.5 | 10 + 1 | 20 | 100 | 100 | 90 |
| 3.75 | 5 + 0.5 | 20 | 100 | 100 | 90 |
| 1.875 | 2.5 + 0.25 | 20 | 100 | 100 | 90 |
| 0.9375 | 1.25 + 0.125 | 0 | 100 | 100 | 90 |
| 0.46875 | 0.625 + 0.0625 | 0 | 90 | 90 | 90 |
| 0.234375 | 0.3125 + 0.03125 | 0 | 70 | 70 | 70 |
| 0.1171875 | 0.15625 + 0.01563 | 0 | 0 | 0 | 50* |

TABLE 26

| PPM Al | | | | | |
|---|---|---|---|---|---|
| | Lambda | AVERAGE CONTROL IN % | | | |
| COMPOUND | Cyhalothrin + | | Lambda Cyhalothrin + | EXPECTED | OBSERVED |
| A5 | Azoxystrobin | COMPOUND A5 | Azoxystrobin | CONTROL | CONTROL |
| 60 | 5 + 0.5 | 20 | 90 | 92 | 100* |
| 30 | 2.5 + 0.25 | 20 | 70 | 76 | 100* |
| 15 | 1.25 + 0.125 | 20 | 70 | 76 | 90* |
| 7.5 | 0.625 + 0.0625 | 20 | 50 | 60 | 70* |
| 3.75 | 0.3125 + 0.03125 | 20 | 50 | 60 | 70* |
| 1.875 | 0.15625 + 0.01563 | 0 | 50 | 50 | 50 |
| 0.9375 | 0.07813 + 0.00781 | 0 | 50 | 50 | 50 |
| 0.46875 | 0.03906 + 0.00391 | 0 | 20 | 20 | 20 |
| 30 | 5 + 0.5 | 20 | 90 | 92 | 100* |
| 15 | 2.5 + 0.25 | 20 | 70 | 76 | 90* |
| 7.5 | 1.25 + 0.125 | 20 | 70 | 76 | 70 |
| 3.75 | 0.625 + 0.0625 | 20 | 50 | 60 | 70* |
| 1.875 | 0.3125 + 0.03125 | 0 | 50 | 50 | 50 |
| 0.9375 | 0.15625 + 0.01563 | 0 | 50 | 50 | 50 |
| 0.46875 | 0.07813 + 0.00781 | 0 | 50 | 50 | 50 |
| 0.234375 | 0.03906 + 0.00391 | 0 | 20 | 20 | 50* |
| 15 | 5 + 0.5 | 20 | 90 | 92 | 100* |
| 7.5 | 2.5 + 0.25 | 20 | 70 | 76 | 90* |
| 3.75 | 1.25 + 0.125 | 20 | 70 | 76 | 90* |
| 1.875 | 0.625 + 0.0625 | 0 | 50 | 50 | 70* |
| 0.9375 | 0.3125 + 0.03125 | 0 | 50 | 50 | 70* |
| 0.46875 | 0.15625 + 0.01563 | 0 | 50 | 50 | 50 |
| 0.234375 | 0.07813 + 0.00781 | 0 | 50 | 50 | 50 |
| 0.1171875 | 0.03906 + 0.00391 | 0 | 20 | 20 | 50* |
| 7.5 | 5 + 0.5 | 20 | 90 | 92 | 100* |
| 3.75 | 2.5 + 0.25 | 20 | 70 | 76 | 90* |
| 1.875 | 1.25 + 0.125 | 0 | 70 | 70 | 70 |
| 0.9375 | 0.625 + 0.0625 | 0 | 50 | 50 | 70* |
| 0.46875 | 0.3125 + 0.03125 | 0 | 50 | 50 | 70* |
| 0.234375 | 0.15625 + 0.01563 | 0 | 50 | 50 | 70* |
| 0.1171875 | 0.07813 + 0.00781 | 0 | 50 | 50 | 50 |
| 3.75 | 5 + 0.5 | 20 | 90 | 92 | 90 |
| 1.875 | 2.5 + 0.25 | 0 | 70 | 70 | 70 |
| 0.9375 | 1.25 + 0.125 | 0 | 70 | 70 | 70 |
| 0.46875 | 0.625 + 0.0625 | 0 | 50 | 50 | 70* |
| 0.234375 | 0.3125 + 0.03125 | 0 | 50 | 50 | 70* |
| 0.1171875 | 0.15625 + 0.01563 | 0 | 50 | 50 | 50 |

TABLE 27

| PPM Al | | AVERAGE CONTROL IN % | | | |
|---|---|---|---|---|---|
| COMPOUND | Sulfoxaflor + | | Sulfoxaflor + | EXPECTED | OBSERVED |
| A5 | Azoxystrobin | COMPOUND A5 | Azoxystrobin | CONTROL | CONTROL |
| 60 | 5 + 0.5 | 20 | 70 | 76 | 100* |
| 30 | 2.5 + 0.25 | 20 | 70 | 76 | 70 |
| 15 | 1.25 + 0.125 | 20 | 70 | 76 | 70 |
| 7.5 | 0.625 + 0.0625 | 20 | 70 | 76 | 70 |
| 3.75 | 0.3125 + 0.03125 | 0 | 50 | 50 | 50 |
| 1.875 | 0.15625 + 0.01563 | 0 | 50 | 50 | 50 |
| 0.9375 | 0.07813 + 0.00781 | 0 | 50 | 50 | 50 |
| 0.46875 | 0.03906 + 0.00391 | 0 | 20 | 20 | 20 |
| 60 | 10 + 1 | 20 | 70 | 76 | 100* |
| 30 | 5 + 0.5 | 20 | 70 | 76 | 100* |
| 15 | 2.5 + 0.25 | 20 | 70 | 76 | 90* |
| 7.5 | 1.25 + 0.125 | 20 | 70 | 76 | 70 |
| 3.75 | 0.625 + 0.0625 | 0 | 70 | 70 | 70 |
| 1.875 | 0.3125 + 0.03125 | 0 | 50 | 50 | 70* |
| 0.9375 | 0.15625 + 0.01563 | 0 | 50 | 50 | 50 |
| 0.46875 | 0.07813 + 0.00781 | 0 | 50 | 50 | 50 |
| 0.234375 | 0.03906 + 0.00391 | 0 | 20 | 20 | 50* |
| 60 | 20 + 2 | 20 | 90 | 92 | 100* |
| 30 | 10 + 1 | 20 | 70 | 76 | 100* |
| 15 | 5 + 0.5 | 20 | 70 | 76 | 90* |
| 7.5 | 2.5 + 0.25 | 20 | 70 | 76 | 90* |
| 3.75 | 1.25 + 0.125 | 0 | 70 | 70 | 70 |
| 1.875 | 0.625 + 0.0625 | 0 | 70 | 70 | 70 |
| 0.9375 | 0.3125 + 0.03125 | 0 | 50 | 50 | 50 |
| 0.46875 | 0.15625 + 0.01563 | 0 | 50 | 50 | 50 |
| 0.234375 | 0.07813 + 0.00781 | 0 | 50 | 50 | 50 |
| 0.1171875 | 0.03906 + 0.00391 | 0 | 20 | 20 | 50* |
| 30 | 20 + 2 | 20 | 90 | 92 | 100* |
| 15 | 10 + 1 | 20 | 70 | 76 | 90* |
| 7.5 | 5 + 0.5 | 20 | 70 | 76 | 90* |
| 3.75 | 2.5 + 0.25 | 0 | 70 | 70 | 90* |
| 1.875 | 1.25 + 0.125 | 0 | 70 | 70 | 70 |
| 0.9375 | 0.625 + 0.0625 | 0 | 70 | 70 | 70 |
| 0.46875 | 0.3125 + 0.03125 | 0 | 50 | 50 | 50 |
| 0.234375 | 0.15625 + 0.01563 | 0 | 50 | 50 | 50 |
| 0.1171875 | 0.07813 + 0.00781 | 0 | 50 | 50 | 50 |
| 15 | 20 + 2 | 20 | 90 | 92 | 100* |
| 7.5 | 10 + 1 | 20 | 70 | 76 | 90* |
| 3.75 | 5 + 0.5 | 0 | 70 | 70 | 90* |
| 1.875 | 2.5 + 0.25 | 0 | 70 | 70 | 70 |
| 0.9375 | 1.25 + 0.125 | 0 | 70 | 70 | 70 |
| 0.46875 | 0.625 + 0.0625 | 0 | 70 | 70 | 50 |
| 0.234375 | 0.3125 + 0.03125 | 0 | 50 | 50 | 50 |
| 0.1171875 | 0.15625 + 0.01563 | 0 | 50 | 50 | 50 |

TABLE 28

| PPM Al | | AVERAGE CONTROL IN % | | | |
|---|---|---|---|---|---|
| COMPOUND | Abamectin + | | Abamectin + | EXPECTED | OBSERVED |
| A5 | Azoxystrobin | COMPOUND A5 | Azoxystrobin | CONTROL | CONTROL |
| 60 | 5 + 0.5 | 20 | 90 | 92 | 100* |
| 30 | 2.5 + 0.25 | 20 | 70 | 76 | 90* |
| 15 | 1.25 + 0.125 | 20 | 70 | 76 | 90* |
| 7.5 | 0.625 + 0.0625 | 20 | 70 | 76 | 70 |
| 3.75 | 0.3125 + 0.03125 | 20 | 70 | 76 | 70 |
| 1.875 | 0.15625 + 0.01563 | 0 | 70 | 70 | 50 |
| 0.9375 | 0.07813 + 0.00781 | 0 | 50 | 50 | 50 |
| 0.46875 | 0.03906 + 0.00391 | 0 | 20 | 20 | 50* |
| 60 | 10 + 1 | 20 | 100 | 100 | 100 |
| 30 | 5 + 0.5 | 20 | 90 | 92 | 100* |
| 15 | 2.5 + 0.25 | 20 | 70 | 76 | 90* |
| 7.5 | 1.25 + 0.125 | 20 | 70 | 76 | 90* |
| 3.75 | 0.625 + 0.0625 | 20 | 70 | 76 | 90* |
| 1.875 | 0.3125 + 0.03125 | 0 | 70 | 70 | 70 |
| 0.9375 | 0.15625 + 0.01563 | 0 | 70 | 70 | 70 |
| 0.46875 | 0.07813 + 0.00781 | 0 | 50 | 50 | 50 |
| 0.234375 | 0.03906 + 0.00391 | 0 | 20 | 20 | 50* |
| 60 | 20 + 2 | 20 | 100 | 100 | 100 |
| 30 | 10 + 1 | 20 | 100 | 100 | 100 |
| 15 | 5 + 0.5 | 20 | 90 | 92 | 100* |
| 7.5 | 2.5 + 0.25 | 20 | 70 | 76 | 90* |
| 3.75 | 1.25 + 0.125 | 20 | 70 | 76 | 70 |
| 1.875 | 0.625 + 0.0625 | 0 | 70 | 70 | 70 |
| 0.9375 | 0.3125 + 0.03125 | 0 | 70 | 70 | 70 |
| 0.46875 | 0.15625 + 0.01563 | 0 | 70 | 70 | 50 |
| 0.234375 | 0.07813 + 0.00781 | 0 | 50 | 50 | 50 |
| 0.1171875 | 0.03906 + 0.00391 | 0 | 20 | 20 | 50* |
| 30 | 20 + 2 | 20 | 100 | 100 | 100 |
| 15 | 10 + 1 | 20 | 100 | 100 | 100 |
| 7.5 | 5 + 0.5 | 20 | 90 | 92 | 90 |
| 3.75 | 2.5 + 0.25 | 20 | 70 | 76 | 90* |
| 1.875 | 1.25 + 0.125 | 0 | 70 | 70 | 90* |
| 0.9375 | 0.625 + 0.0625 | 0 | 70 | 70 | 70 |
| 0.46875 | 0.3125 + 0.03125 | 0 | 70 | 70 | 70 |
| 0.234375 | 0.15625 + 0.01563 | 0 | 70 | 70 | 50 |
| 0.1171875 | 0.07813 + 0.00781 | 0 | 50 | 50 | 50 |
| 15 | 20 + 2 | 20 | 100 | 100 | 100 |
| 7.5 | 10 + 1 | 20 | 100 | 100 | 100 |
| 3.75 | 5 + 0.5 | 20 | 90 | 92 | 100* |
| 1.875 | 2.5 + 0.25 | 0 | 70 | 70 | 90* |
| 0.9375 | 1.25 + 0.125 | 0 | 70 | 70 | 70 |
| 0.46875 | 0.625 + 0.0625 | 0 | 70 | 70 | 70 |
| 0.234375 | 0.3125 + 0.03125 | 0 | 70 | 70 | 70 |
| 0.1171875 | 0.15625 + 0.01563 | 0 | 70 | 70 | 70 |

TABLE 29

| PPM Al | | AVERAGE CONTROL IN % | | | |
|---|---|---|---|---|---|
| COMPOUND | Thiamethoxam + | | Thiamethoxam + | EXPECTED | OBSERVED |
| A5 | Azoxystrobin | COMPOUND A5 | Azoxystrobin | CONTROL | CONTROL |
| 60 | 5 + 0.5 | 20 | 70 | 76 | 100* |
| 30 | 2.5 + 0.25 | 20 | 70 | 76 | 70 |
| 15 | 1.25 + 0.125 | 20 | 70 | 76 | 70 |
| 7.5 | 0.625 + 0.0625 | 20 | 70 | 76 | 70 |
| 3.75 | 0.3125 + 0.03125 | 20 | 50 | 60 | 70* |
| 1.875 | 0.15625 + 0.01563 | 20 | 50 | 60 | 50 |
| 0.9375 | 0.07813 + 0.00781 | 0 | 50 | 50 | 50 |
| 0.46875 | 0.03906 + 0.00391 | 0 | 50 | 50 | 50 |
| 60 | 10 + 1 | 20 | 70 | 76 | 100* |
| 30 | 5 + 0.5 | 20 | 70 | 76 | 100* |
| 15 | 2.5 + 0.25 | 20 | 70 | 76 | 70 |
| 7.5 | 1.25 + 0.125 | 20 | 70 | 76 | 70 |
| 3.75 | 0.625 + 0.0625 | 20 | 70 | 76 | 70 |
| 1.875 | 0.3125 + 0.03125 | 20 | 50 | 60 | 70* |
| 0.9375 | 0.15625 + 0.01563 | 0 | 50 | 50 | 50 |
| 0.46875 | 0.07813 + 0.00781 | 0 | 50 | 50 | 50 |
| 0.234375 | 0.03906 + 0.00391 | 0 | 50 | 50 | 50 |
| 60 | 20 + 2 | 20 | 70 | 76 | 100* |
| 30 | 10 + 1 | 20 | 70 | 76 | 100* |
| 15 | 5 + 0.5 | 20 | 70 | 76 | 100* |
| 7.5 | 2.5 + 0.25 | 20 | 70 | 76 | 70 |
| 3.75 | 1.25 + 0.125 | 20 | 70 | 76 | 70 |
| 1.875 | 0.625 + 0.0625 | 20 | 70 | 76 | 70 |
| 0.9375 | 0.3125 + 0.03125 | 0 | 50 | 50 | 70* |
| 0.46875 | 0.15625 + 0.01563 | 0 | 50 | 50 | 70* |
| 0.234375 | 0.07813 + 0.00781 | 0 | 50 | 50 | 50 |
| 0.1171875 | 0.03906 + 0.00391 | 0 | 50 | 50 | 50 |
| 30 | 20 + 2 | 20 | 70 | 76 | 100* |
| 15 | 10 + 1 | 20 | 70 | 76 | 100* |
| 7.5 | 5 + 0.5 | 20 | 70 | 76 | 70 |
| 3.75 | 2.5 + 0.25 | 20 | 70 | 76 | 70 |
| 1.875 | 1.25 + 0.125 | 20 | 70 | 76 | 70 |
| 0.9375 | 0.625 + 0.0625 | 0 | 70 | 70 | 70 |
| 0.46875 | 0.3125 + 0.03125 | 0 | 50 | 50 | 70* |
| 0.234375 | 0.15625 + 0.01563 | 0 | 50 | 50 | 70* |
| 0.1171875 | 0.07813 + 0.00781 | 0 | 50 | 50 | 70* |
| 15 | 20 + 2 | 20 | 70 | 76 | 100* |
| 7.5 | 10 + 1 | 20 | 70 | 76 | 70 |
| 3.75 | 5 + 0.5 | 20 | 70 | 76 | 70 |
| 1.875 | 2.5 + 0.25 | 20 | 70 | 76 | 70 |
| 0.9375 | 1.25 + 0.125 | 0 | 70 | 70 | 70 |
| 0.46875 | 0.625 + 0.0625 | 0 | 70 | 70 | 70 |
| 0.234375 | 0.3125 + 0.03125 | 0 | 50 | 50 | 70* |
| 0.1171875 | 0.15625 + 0.01563 | 0 | 50 | 50 | 70* |

Monographella nivalis (svn. Microdochium nivale, Fusarium nivale), Snow Mould, Foot Rot:

Conidia of the fungus from cryogenic storage were directly mixed into nutrient broth (potato dextrose broth). After placing a (DMSO) solution of the test compounds into a microtiter plate (96-well format) the nutrient broth containing the fungal spores was added. The test plates were incubated at 24° C. and the inhibition of growth was determined photometrically after 72 hours at 620 nm. Application rates are shown in the Tables.

TABLE 30

| PPM Al | | | | | |
|---|---|---|---|---|---|
| | Lambda | AVERAGE CONTROL IN % | | | |
| | Cyhalothrin + | | Lambda Cyhalothrin + | EXPECTED | OBSERVED |
| COMPOUND A5 | COMPOUND II | COMPOUND A5 | COMPOUND II | CONTROL | CONTROL |
| 60 | 5 + 0.5 | 0 | 20 | 20 | 90* |
| 30 | 2.5 + 0.25 | 0 | 0 | 0 | 20* |
| 60 | 10 + 1 | 0 | 50 | 50 | 100* |
| 30 | 5 + 0.5 | 0 | 20 | 20 | 70* |
| 15 | 2.5 + 0.25 | 0 | 0 | 0 | 20* |
| 30 | 10 + 1 | 0 | 50 | 50 | 100* |
| 15 | 5 + 0.5 | 0 | 20 | 20 | 50* |
| 7.5 | 2.5 + 0.25 | 0 | 0 | 0 | 20* |
| 15 | 10 + 1 | 0 | 50 | 50 | 100* |
| 7.5 | 5 + 0.5 | 0 | 20 | 20 | 20 |
| 7.5 | 10 + 1 | 0 | 50 | 50 | 100* |
| 3.75 | 5 + 0.5 | 0 | 20 | 20 | 20 |

TABLE 31

| PPM Al | | AVERAGE CONTROL IN % | | | |
|---|---|---|---|---|---|
| | Sulfoxaflor + | | Sulfoxaflor + | EXPECTED | OBSERVED |
| COMPOUND A5 | COMPOUND II | COMPOUND A5 | COMPOUND II | CONTROL | CONTROL |
| 60 | 5 + 0.5 | 0 | 70 | 70 | 90* |
| 30 | 2.5 + 0.25 | 0 | 50 | 50 | 20 |
| 15 | 1.25 + 0.125 | 0 | 20 | 20 | 0 |
| 30 | 5 + 0.5 | 0 | 70 | 70 | 90* |
| 15 | 2.5 + 0.25 | 0 | 50 | 50 | 20 |
| 15 | 5 + 0.5 | 0 | 70 | 70 | 90* |
| 7.5 | 2.5 + 0.25 | 0 | 50 | 50 | 20 |
| 7.5 | 5 + 0.5 | 0 | 70 | 70 | 90* |
| 3.75 | 2.5 + 0.25 | 0 | 50 | 50 | 50 |
| 1.875 | 1.25 + 0.125 | 0 | 20 | 20 | 20 |
| 3.75 | 5 + 0.5 | 0 | 70 | 70 | 90* |
| 1.875 | 2.5 + 0.25 | 0 | 50 | 50 | 70* |
| 0.9375 | 1.25 + 0.125 | 0 | 20 | 20 | 20 |

TABLE 32

| PPM Al | | AVERAGE CONTROL IN % | | | |
|---|---|---|---|---|---|
| | Abamectin + | | Abamectin + | EXPECTED | OBSERVED |
| COMPOUND A5 | COMPOUND II | COMPOUND A5 | COMPOUND II | CONTROL | CONTROL |
| 60 | 5 + 0.5 | 0 | 70 | 70 | 70 |
| 30 | 2.5 + 0.25 | 0 | 20 | 20 | 20 |
| 15 | 1.25 + 0.125 | 0 | 20 | 20 | 0 |
| 30 | 5 + 0.5 | 0 | 70 | 70 | 90* |
| 15 | 2.5 + 0.25 | 0 | 20 | 20 | 20 |
| 7.5 | 1.25 + 0.125 | 0 | 20 | 20 | 20 |
| 15 | 5 + 0.5 | 0 | 70 | 70 | 90* |
| 7.5 | 2.5 + 0.25 | 0 | 20 | 20 | 20 |
| 7.5 | 5 + 0.5 | 0 | 70 | 70 | 90* |
| 3.75 | 2.5 + 0.25 | 0 | 20 | 20 | 50* |
| 1.875 | 1.25 + 0.125 | 0 | 20 | 20 | 20 |
| 3.75 | 5 + 0.5 | 0 | 70 | 70 | 100* |
| 1.875 | 2.5 + 0.25 | 0 | 20 | 20 | 50* |
| 0.9375 | 1.25 + 0.125 | 0 | 20 | 20 | 20 |

TABLE 33

| PPM Al | | AVERAGE CONTROL IN % | | | |
|---|---|---|---|---|---|
| | Thiamethoxam + | | Thiamethoxam + | EXPECTED | OBSERVED |
| COMPOUND A5 | COMPOUND II | COMPOUND A5 | COMPOUND II | CONTROL | CONTROL |
| 60 | 5 + 0.5 | 0 | 70 | 70 | 70 |
| 30 | 2.5 + 0.25 | 0 | 20 | 20 | 20 |
| 60 | 10 + 1 | 0 | 90 | 90 | 100* |
| 30 | 5 + 0.5 | 0 | 70 | 70 | 70 |
| 15 | 2.5 + 0.25 | 0 | 20 | 20 | 20 |
| 30 | 10 + 1 | 0 | 90 | 90 | 100* |
| 15 | 5 + 0.5 | 0 | 70 | 70 | 70 |
| 7.5 | 2.5 + 0.25 | 0 | 20 | 20 | 20 |
| 15 | 10 + 1 | 0 | 90 | 90 | 100* |
| 7.5 | 5 + 0.5 | 0 | 70 | 70 | 70 |
| 3.75 | 2.5 + 0.25 | 0 | 20 | 20 | 70* |
| 7.5 | 10 + 1 | 0 | 90 | 90 | 100* |
| 3.75 | 5 + 0.5 | 0 | 70 | 70 | 90* |
| 1.875 | 2.5 + 0.25 | 0 | 20 | 20 | 50* |
| 0.9375 | 1.25 + 0.125 | 0 | 0 | 0 | 20* |

TABLE 34

| PPM Al | | | | | |
|---|---|---|---|---|---|
| | Lambda | AVERAGE CONTROL IN % | | | |
| | Cyhalothrin + | | Lambda Cyhalothrin + | EXPECTED | OBSERVED |
| COMPOUND A5 | Azoxystrobin | COMPOUND A5 | Azoxystrobin | CONTROL | CONTROL |
| 1.875 | 0.15625 + 0.01563 | 0 | 90 | 90 | 100* |
| 0.9375 | 0.07813 + 0.00781 | 0 | 20 | 20 | 50* |
| 0.9375 | 0.15625 + 0.01563 | 0 | 90 | 90 | 100* |
| 0.46875 | 0.07813 + 0.00781 | 0 | 20 | 20 | 50* |
| 0.46875 | 0.15625 + 0.01563 | 0 | 90 | 90 | 100* |
| 0.234375 | 0.07813 + 0.00781 | 0 | 20 | 20 | 70* |
| 0.234375 | 0.15625 + 0.01563 | 0 | 90 | 90 | 100* |
| 0.1171875 | 0.07813 + 0.00781 | 0 | 20 | 20 | 100* |
| 0.1171875 | 0.15625 + 0.01563 | 0 | 90 | 90 | 100* |

TABLE 35

| PPM Al | | AVERAGE CONTROL IN % | | | |
|---|---|---|---|---|---|
| | Sulfoxaflor + | | Sulfoxaflor + | EXPECTED | OBSERVED |
| COMPOUND A5 | Azoxystrobin | COMPOUND A5 | Azoxystrobin | CONTROL | CONTROL |
| 1.875 | 0.15625 + 0.01563 | 0 | 70 | 70 | 100* |
| 0.9375 | 0.07813 + 0.00781 | 0 | 20 | 20 | 20 |
| 0.9375 | 0.15625 + 0.01563 | 0 | 70 | 70 | 90* |
| 0.46875 | 0.07813 + 0.00781 | 0 | 20 | 20 | 20 |
| 0.46875 | 0.15625 + 0.01563 | 0 | 70 | 70 | 90* |
| 0.234375 | 0.07813 + 0.00781 | 0 | 20 | 20 | 20 |
| 0.234375 | 0.15625 + 0.01563 | 0 | 70 | 70 | 90* |
| 0.1171875 | 0.07813 + 0.00781 | 0 | 20 | 20 | 50* |
| 0.1171875 | 0.15625 + 0.01563 | 0 | 70 | 70 | 100* |

TABLE 36

| PPM Al | | AVERAGE CONTROL IN % | | | |
|---|---|---|---|---|---|
| | Abamectin + | | Abamectin + | EXPECTED | OBSERVED |
| COMPOUND A5 | Azoxystrobin | COMPOUND A5 | Azoxystrobin | CONTROL | CONTROL |
| 1.875 | 0.15625 + 0.01563 | 0 | 90 | 90 | 100* |
| 0.9375 | 0.07813 + 0.00781 | 0 | 20 | 20 | 50* |
| 0.9375 | 0.15625 + 0.01563 | 0 | 90 | 90 | 100* |
| 0.46875 | 0.07813 + 0.00781 | 0 | 20 | 20 | 50* |
| 0.46875 | 0.15625 + 0.01563 | 0 | 90 | 90 | 100* |
| 0.234375 | 0.07813 + 0.00781 | 0 | 20 | 20 | 50* |
| 0.234375 | 0.15625 + 0.01563 | 0 | 90 | 90 | 100* |
| 0.1171875 | 0.07813 + 0.00781 | 0 | 20 | 20 | 50* |
| 0.1171875 | 0.15625 + 0.01563 | 0 | 90 | 90 | 100* |

TABLE 37

| PPM Al | | AVERAGE CONTROL IN % | | | |
|---|---|---|---|---|---|
| | Thiamethoxam + | | Thiamethoxam + | EXPECTED | OBSERVED |
| COMPOUND A5 | Azoxystrobin | COMPOUND A5 | Azoxystrobin | CONTROL | CONTROL |
| 0.9375 | 0.07813 + 0.00781 | 0 | 20 | 20 | 50* |
| 0.46875 | 0.07813 + 0.00781 | 0 | 20 | 20 | 50* |
| 0.234375 | 0.07813 + 0.00781 | 0 | 20 | 20 | 20 |
| 0.234375 | 0.15625 + 0.01563 | 0 | 100 | 100 | 90 |
| 0.1171875 | 0.07813 + 0.00781 | 0 | 20 | 20 | 20 |

Botrytis cinerea (Gray Mould):

Conidia of the fungus from cryogenic storage were directly mixed into nutrient broth (potato dextrose broth). After placing a (DMSO) solution of the test compounds into a microtiter plate (96-well format) the nutrient broth containing the fungal spores was added. The test plates were incubated at 24° C. and the inhibition of growth was determined photometrically after 72 hours. Application rates are shown in the Tables.

TABLE 38

| PPM Al | | AVERAGE CONTROL IN % | | | |
|---|---|---|---|---|---|
| | Lambda Cyhalothrin + | | Lambda Cyhalothrin + | EXPECTED | OBSERVED |
| COMPOUND A5 | COMPOUND II | COMPOUND A5 | COMPOUND II | CONTROL | CONTROL |
| 60 | 5 + 0.5 | 0 | 70 | 70 | 70 |
| 30 | 2.5 + 0.25 | 0 | 70 | 70 | 50 |
| 15 | 1.25 + 0.125 | 0 | 50 | 50 | 50 |
| 7.5 | 0.625 + 0.0625 | 0 | 20 | 20 | 20 |
| 60 | 10 + 1 | 0 | 90 | 90 | 90 |
| 30 | 5 + 0.5 | 0 | 70 | 70 | 70 |
| 15 | 2.5 + 0.25 | 0 | 70 | 70 | 50 |
| 7.5 | 1.25 + 0.125 | 0 | 50 | 50 | 50 |
| 3.75 | 0.625 + 0.0625 | 0 | 20 | 20 | 20 |
| 30 | 10 + 1 | 0 | 90 | 90 | 90 |
| 15 | 5 + 0.5 | 0 | 70 | 70 | 70 |
| 7.5 | 2.5 + 0.25 | 0 | 70 | 70 | 70 |
| 3.75 | 1.25 + 0.125 | 0 | 50 | 50 | 50 |
| 1.875 | 0.625 + 0.0625 | 0 | 20 | 20 | 50* |
| 0.9375 | 0.3125 + 0.03125 | 0 | 0 | 0 | 20* |
| 15 | 10 + 1 | 0 | 90 | 90 | 90 |
| 7.5 | 5 + 0.5 | 0 | 70 | 70 | 70 |
| 3.75 | 2.5 + 0.25 | 0 | 70 | 70 | 50 |
| 1.875 | 1.25 + 0.125 | 0 | 50 | 50 | 50 |
| 0.9375 | 0.625 + 0.0625 | 0 | 20 | 20 | 20 |
| 0.46875 | 0.3125 + 0.03125 | 0 | 0 | 0 | 20* |
| 15 | 20 + 2 | 0 | 100 | 100 | 100 |
| 7.5 | 10 + 1 | 0 | 90 | 90 | 90 |
| 3.75 | 5 + 0.5 | 0 | 70 | 70 | 70 |
| 1.875 | 2.5 + 0.25 | 0 | 70 | 70 | 50 |
| 0.9375 | 1.25 + 0.125 | 0 | 50 | 50 | 50 |
| 0.46875 | 0.625 + 0.0625 | 0 | 20 | 20 | 20 |
| 0.234375 | 0.3125 + 0.03125 | 0 | 0 | 0 | 20* |

TABLE 39

| PPM Al | | AVERAGE CONTROL IN % | | | |
|---|---|---|---|---|---|
| | Sulfoxaflor + | | Sulfoxaflor + | EXPECTED | OBSERVED |
| COMPOUND A5 | COMPOUND II | COMPOUND A5 | COMPOUND II | CONTROL | CONTROL |
| 60 | 5 + 0.5 | 0 | 70 | 70 | 70 |
| 30 | 2.5 + 0.25 | 0 | 50 | 50 | 50 |
| 15 | 1.25 + 0.125 | 0 | 50 | 50 | 50 |
| 7.5 | 0.625 + 0.0625 | 0 | 20 | 20 | 20 |
| 60 | 10 + 1 | 0 | 90 | 90 | 70 |
| 30 | 5 + 0.5 | 0 | 70 | 70 | 70 |
| 15 | 2.5 + 0.25 | 0 | 50 | 50 | 50 |
| 7.5 | 1.25 + 0.125 | 0 | 50 | 50 | 50 |
| 3.75 | 0.625 + 0.0625 | 0 | 20 | 20 | 20 |
| 30 | 10 + 1 | 0 | 90 | 90 | 90 |
| 15 | 5 + 0.5 | 0 | 70 | 70 | 70 |
| 7.5 | 2.5 + 0.25 | 0 | 50 | 50 | 50 |
| 3.75 | 1.25 + 0.125 | 0 | 50 | 50 | 50 |
| 1.875 | 0.625 + 0.0625 | 0 | 20 | 20 | 20 |
| 30 | 20 + 2 | 0 | 100 | 100 | 100 |
| 15 | 10 + 1 | 0 | 90 | 90 | 90 |
| 7.5 | 5 + 0.5 | 0 | 70 | 70 | 70 |
| 3.75 | 2.5 + 0.25 | 0 | 50 | 50 | 50 |
| 1.875 | 1.25 + 0.125 | 0 | 50 | 50 | 50 |
| 0.9375 | 0.625 + 0.0625 | 0 | 20 | 20 | 20 |
| 7.5 | 10 + 1 | 0 | 90 | 90 | 100* |
| 3.75 | 5 + 0.5 | 0 | 70 | 70 | 90* |
| 1.875 | 2.5 + 0.25 | 0 | 50 | 50 | 70* |
| 0.9375 | 1.25 + 0.125 | 0 | 50 | 50 | 50 |
| 0.46875 | 0.625 + 0.0625 | 0 | 20 | 20 | 50* |
| 0.234375 | 0.3125 + 0.03125 | 0 | 0 | 0 | 20* |

TABLE 40

| PPM Al | | AVERAGE CONTROL IN % | | | |
|---|---|---|---|---|---|
| | Abamectin + | | Abamectin + | EXPECTED | OBSERVED |
| COMPOUND A5 | COMPOUND II | COMPOUND A5 | COMPOUND II | CONTROL | CONTROL |
| 60 | 5 + 0.5 | 0 | 70 | 70 | 50 |
| 30 | 2.5 + 0.25 | 0 | 50 | 50 | 50 |
| 15 | 1.25 + 0.125 | 0 | 50 | 50 | 50 |
| 7.5 | 0.625 + 0.0625 | 0 | 20 | 20 | 20 |
| 60 | 10 + 1 | 0 | 90 | 90 | 70 |
| 30 | 5 + 0.5 | 0 | 70 | 70 | 50 |
| 15 | 2.5 + 0.25 | 0 | 50 | 50 | 50 |
| 7.5 | 1.25 + 0.125 | 0 | 50 | 50 | 50 |
| 3.75 | 0.625 + 0.0625 | 0 | 20 | 20 | 20 |
| 30 | 10 + 1 | 0 | 90 | 90 | 70 |
| 15 | 5 + 0.5 | 0 | 70 | 70 | 70 |
| 7.5 | 2.5 + 0.25 | 0 | 50 | 50 | 50 |
| 3.75 | 1.25 + 0.125 | 0 | 50 | 50 | 50 |
| 1.875 | 0.625 + 0.0625 | 0 | 20 | 20 | 20 |
| 15 | 10 + 1 | 0 | 90 | 90 | 90 |
| 7.5 | 5 + 0.5 | 0 | 70 | 70 | 70 |
| 3.75 | 2.5 + 0.25 | 0 | 50 | 50 | 50 |
| 1.875 | 1.25 + 0.125 | 0 | 50 | 50 | 50 |
| 0.9375 | 0.625 + 0.0625 | 0 | 20 | 20 | 20 |
| 7.5 | 10 + 1 | 0 | 90 | 90 | 90 |
| 3.75 | 5 + 0.5 | 0 | 70 | 70 | 70 |
| 1.875 | 2.5 + 0.25 | 0 | 50 | 50 | 50 |
| 0.9375 | 1.25 + 0.125 | 0 | 50 | 50 | 50 |
| 0.46875 | 0.625 + 0.0625 | 0 | 20 | 20 | 50* |
| 0.234375 | 0.3125 + 0.03125 | 0 | 0 | 0 | 20* |
| 0.1171875 | 0.15625 + 0.01563 | 0 | 0 | 0 | 20* |

TABLE 41

| PPM Al | | AVERAGE CONTROL IN % | | | |
|---|---|---|---|---|---|
| | Thiamethoxam + | | Thiamethoxam + | EXPECTED | OBSERVED |
| COMPOUND A5 | COMPOUND II | COMPOUND A5 | COMPOUND II | CONTROL | CONTROL |
| 60 | 5 + 0.5 | 0 | 70 | 70 | 50 |
| 30 | 2.5 + 0.25 | 0 | 50 | 50 | 50 |
| 15 | 1.25 + 0.125 | 0 | 50 | 50 | 50 |
| 7.5 | 0.625 + 0.0625 | 0 | 20 | 20 | 20 |
| 60 | 10 + 1 | 0 | 90 | 90 | 70 |
| 30 | 5 + 0.5 | 0 | 70 | 70 | 70 |
| 15 | 2.5 + 0.25 | 0 | 50 | 50 | 50 |
| 7.5 | 1.25 + 0.125 | 0 | 50 | 50 | 50 |
| 3.75 | 0.625 + 0.0625 | 0 | 20 | 20 | 20 |
| 30 | 10 + 1 | 0 | 90 | 90 | 70 |
| 15 | 5 + 0.5 | 0 | 70 | 70 | 70 |
| 7.5 | 2.5 + 0.25 | 0 | 50 | 50 | 50 |
| 3.75 | 1.25 + 0.125 | 0 | 50 | 50 | 50 |
| 1.875 | 0.625 + 0.0625 | 0 | 20 | 20 | 20 |
| 30 | 20 + 2 | 0 | 100 | 100 | 90 |
| 15 | 10 + 1 | 0 | 90 | 90 | 90 |
| 7.5 | 5 + 0.5 | 0 | 70 | 70 | 70 |
| 3.75 | 2.5 + 0.25 | 0 | 50 | 50 | 50 |
| 1.875 | 1.25 + 0.125 | 0 | 50 | 50 | 50 |
| 0.9375 | 0.625 + 0.0625 | 0 | 20 | 20 | 20 |
| 15 | 20 + 2 | 0 | 100 | 100 | 100 |
| 7.5 | 10 + 1 | 0 | 90 | 90 | 90 |
| 3.75 | 5 + 0.5 | 0 | 70 | 70 | 70 |
| 1.875 | 2.5 + 0.25 | 0 | 50 | 50 | 70* |
| 0.9375 | 1.25 + 0.125 | 0 | 50 | 50 | 50 |
| 0.46875 | 0.625 + 0.0625 | 0 | 20 | 20 | 50* |
| 0.234375 | 0.3125 + 0.03125 | 0 | 0 | 0 | 20* |

TABLE 42

| PPM Al | | AVERAGE CONTROL IN % | | | |
|---|---|---|---|---|---|
| | Lambda Cyhalothrin + | | Lambda Cyhalothrin + | EXPECTED | OBSERVED |
| COMPOUND A5 | Azoxystrobin | COMPOUND A5 | Azoxystrobin | CONTROL | CONTROL |
| 60 | 10 + 1 | 0 | 20 | 20 | 20 |
| 30 | 10 + 1 | 0 | 20 | 20 | 20 |
| 30 | 20 + 2 | 0 | 20 | 20 | 20 |
| 15 | 10 + 1 | 0 | 20 | 20 | 20 |
| 15 | 20 + 2 | 0 | 20 | 20 | 20 |
| 7.5 | 10 + 1 | 0 | 20 | 20 | 20 |

TABLE 43

| PPM Al | | AVERAGE CONTROL IN % | | | |
|---|---|---|---|---|---|
| | Sulfoxaflor + | | Sulfoxaflor + | EXPECTED | OBSERVED |
| COMPOUND A5 | Azoxystrobin | COMPOUND A5 | Azoxystrobin | CONTROL | CONTROL |
| 60 | 10 + 1 | 0 | 20 | 20 | 20 |
| 30 | 10 + 1 | 0 | 20 | 20 | 20 |
| 30 | 20 + 2 | 0 | 20 | 20 | 20 |
| 15 | 10 + 1 | 0 | 20 | 20 | 20 |
| 15 | 20 + 2 | 0 | 20 | 20 | 20 |
| 7.5 | 10 + 1 | 0 | 20 | 20 | 20 |
| 3.75 | 5 + 0.5 | 0 | 0 | 0 | 20* |

TABLE 44

| PPM Al | | AVERAGE CONTROL IN % | | | |
|---|---|---|---|---|---|
| | Abamectin + | | Abamectin + | EXPECTED | OBSERVED |
| COMPOUND A5 | Azoxystrobin | COMPOUND A5 | Azoxystrobin | CONTROL | CONTROL |
| 60 | 5 + 0.5 | 0 | 20 | 20 | 20 |
| 60 | 10 + 1 | 0 | 20 | 20 | 20 |
| 30 | 5 + 0.5 | 0 | 20 | 20 | 20 |
| 30 | 10 + 1 | 0 | 20 | 20 | 20 |
| 15 | 5 + 0.5 | 0 | 20 | 20 | 20 |
| 30 | 20 + 2 | 0 | 50 | 50 | 20 |
| 15 | 10 + 1 | 0 | 20 | 20 | 20 |
| 7.5 | 5 + 0.5 | 0 | 20 | 20 | 20 |
| 15 | 20 + 2 | 0 | 50 | 50 | 50 |
| 7.5 | 10 + 1 | 0 | 20 | 20 | 20 |
| 3.75 | 5 + 0.5 | 0 | 20 | 20 | 20 |

TABLE 45

| PPM Al | | AVERAGE CONTROL IN % | | | |
|---|---|---|---|---|---|
| | Thiamethoxam + | | Thiamethoxam + | EXPECTED | OBSERVED |
| COMPOUND A5 | Azoxystrobin | COMPOUND A5 | Azoxystrobin | CONTROL | CONTROL |
| 60 | 10 + 1 | 0 | 20 | 20 | 20 |
| 30 | 10 + 1 | 0 | 20 | 20 | 20 |
| 30 | 20 + 2 | 0 | 20 | 20 | 20 |
| 15 | 10 + 1 | 0 | 20 | 20 | 20 |
| 15 | 20 + 2 | 0 | 20 | 20 | 20 |
| 7.5 | 10 + 1 | 0 | 20 | 20 | 20 |
| 3.75 | 5 + 0.5 | 0 | 0 | 0 | 20* |

Glomerella lagenarium (syn. Colletotrichum lagenarium), Anthracnose of cucurbits:

Conidia of the fungus from cryogenic storage were directly mixed into nutrient broth (potato dextrose broth). After placing a (DMSO) solution of the test compounds into a microtiter plate (96-well format) the nutrient broth containing the fungal spores was added. The test plates were incubated at 24° C. and the inhibition of growth was determined photometrically after 72 hours at 620 nm. Application rates are shown in the Tables.

TABLE 46

| PPM Al | | AVERAGE CONTROL IN % | | | |
|---|---|---|---|---|---|
| | Lambda Cyhalothrin + | | Lambda Cyhalothrin + | EXPECTED | OBSERVED |
| COMPOUND A5 | COMPOUND II | COMPOUND A5 | COMPOUND II | CONTROL | CONTROL |
| 60 | 5 + 0.5 | 0 | 90 | 90 | 100* |
| 30 | 2.5 + 0.25 | 0 | 70 | 70 | 90* |
| 15 | 1.25 + 0.125 | 0 | 50 | 50 | 70* |
| 7.5 | 0.625 + 0.0625 | 0 | 20 | 20 | 50* |
| 3.75 | 0.3125 + 0.03125 | 0 | 0 | 0 | 20* |
| 30 | 5 + 0.5 | 0 | 90 | 90 | 100* |
| 15 | 2.5 + 0.25 | 0 | 70 | 70 | 90* |
| 7.5 | 1.25 + 0.125 | 0 | 50 | 50 | 70* |
| 3.75 | 0.625 + 0.0625 | 0 | 20 | 20 | 20 |
| 15 | 5 + 0.5 | 0 | 90 | 90 | 100* |
| 7.5 | 2.5 + 0.25 | 0 | 70 | 70 | 90* |
| 3.75 | 1.25 + 0.125 | 0 | 50 | 50 | 50 |
| 1.875 | 0.625 + 0.0625 | 0 | 20 | 20 | 20 |
| 7.5 | 5 + 0.5 | 0 | 90 | 90 | 100* |
| 3.75 | 2.5 + 0.25 | 0 | 70 | 70 | 90* |
| 1.875 | 1.25 + 0.125 | 0 | 50 | 50 | 50 |
| 0.9375 | 0.625 + 0.0625 | 0 | 20 | 20 | 20 |
| 3.75 | 5 + 0.5 | 0 | 90 | 90 | 100* |
| 1.875 | 2.5 + 0.25 | 0 | 70 | 70 | 90* |
| 0.9375 | 1.25 + 0.125 | 0 | 50 | 50 | 50 |
| 0.46875 | 0.625 + 0.0625 | 0 | 20 | 20 | 20 |

TABLE 47

| PPM Al | | AVERAGE CONTROL IN % | | | |
|---|---|---|---|---|---|
| | Sulfoxaflor + | | Sulfoxaflor + | EXPECTED | OBSERVED |
| COMPOUND A5 | COMPOUND II | COMPOUND A5 | COMPOUND II | CONTROL | CONTROL |
| 60 | 5 + 0.5 | 0 | 90 | 90 | 100* |
| 30 | 2.5 + 0.25 | 0 | 70 | 70 | 70 |
| 15 | 1.25 + 0.125 | 0 | 50 | 50 | 50 |
| 7.5 | 0.625 + 0.0625 | 0 | 20 | 20 | 20 |
| 30 | 5 + 0.5 | 0 | 90 | 90 | 100* |
| 15 | 2.5 + 0.25 | 0 | 70 | 70 | 70 |
| 7.5 | 1.25 + 0.125 | 0 | 50 | 50 | 50 |
| 3.75 | 0.625 + 0.0625 | 0 | 20 | 20 | 20 |
| 15 | 5 + 0.5 | 0 | 90 | 90 | 100* |
| 7.5 | 2.5 + 0.25 | 0 | 70 | 70 | 90* |
| 3.75 | 1.25 + 0.125 | 0 | 50 | 50 | 50 |
| 1.875 | 0.625 + 0.0625 | 0 | 20 | 20 | 20 |
| 7.5 | 5 + 0.5 | 0 | 90 | 90 | 100* |
| 3.75 | 2.5 + 0.25 | 0 | 70 | 70 | 70 |
| 1.875 | 1.25 + 0.125 | 0 | 50 | 50 | 50 |
| 0.9375 | 0.625 + 0.0625 | 0 | 20 | 20 | 20 |
| 3.75 | 5 + 0.5 | 0 | 90 | 90 | 100* |
| 1.875 | 2.5 + 0.25 | 0 | 70 | 70 | 90* |
| 0.9375 | 1.25 + 0.125 | 0 | 50 | 50 | 50 |
| 0.46875 | 0.625 + 0.0625 | 0 | 20 | 20 | 20 |
| 0.234375 | 0.3125 + 0.03125 | 0 | 0 | 0 | 20* |
| 0.1171875 | 0.15625 + 0.01563 | 0 | 0 | 0 | 50* |

TABLE 48

| PPM Al | | AVERAGE CONTROL IN % | | | |
|---|---|---|---|---|---|
| | Abamectin + | | Abamectin + | EXPECTED | OBSERVED |
| COMPOUND A5 | COMPOUND II | COMPOUND A5 | COMPOUND II | CONTROL | CONTROL |
| 60 | 5 + 0.5 | 0 | 90 | 90 | 100* |
| 30 | 2.5 + 0.25 | 0 | 70 | 70 | 90* |
| 15 | 1.25 + 0.125 | 0 | 50 | 50 | 50 |
| 7.5 | 0.625 + 0.0625 | 0 | 20 | 20 | 20 |
| 30 | 5 + 0.5 | 0 | 90 | 90 | 100* |
| 15 | 2.5 + 0.25 | 0 | 70 | 70 | 90* |
| 7.5 | 1.25 + 0.125 | 0 | 50 | 50 | 50 |
| 3.75 | 0.625 + 0.0625 | 0 | 20 | 20 | 20 |
| 15 | 5 + 0.5 | 0 | 90 | 90 | 100* |
| 7.5 | 2.5 + 0.25 | 0 | 70 | 70 | 90* |
| 3.75 | 1.25 + 0.125 | 0 | 50 | 50 | 50 |
| 1.875 | 0.625 + 0.0625 | 0 | 20 | 20 | 20 |
| 7.5 | 5 + 0.5 | 0 | 90 | 90 | 100* |
| 3.75 | 2.5 + 0.25 | 0 | 70 | 70 | 90* |
| 1.875 | 1.25 + 0.125 | 0 | 50 | 50 | 50 |
| 0.9375 | 0.625 + 0.0625 | 0 | 20 | 20 | 20 |
| 3.75 | 5 + 0.5 | 0 | 90 | 90 | 100* |
| 1.875 | 2.5 + 0.25 | 0 | 70 | 70 | 90* |
| 0.9375 | 1.25 + 0.125 | 0 | 50 | 50 | 70* |
| 0.46875 | 0.625 + 0.0625 | 0 | 20 | 20 | 50* |
| 0.234375 | 0.3125 + 0.03125 | 0 | 0 | 0 | 20* |
| 0.1171875 | 0.15625 + 0.01563 | 0 | 0 | 0 | 20* |

TABLE 49

| PPM Al | | AVERAGE CONTROL IN % | | | |
|---|---|---|---|---|---|
| | Thiamethoxam + | | Thiamethoxam + | EXPECTED | OBSERVED |
| COMPOUND A5 | COMPOUND II | COMPOUND A5 | COMPOUND II | CONTROL | CONTROL |
| 60 | 5 + 0.5 | 0 | 90 | 90 | 100* |
| 30 | 2.5 + 0.25 | 0 | 70 | 70 | 90* |
| 15 | 1.25 + 0.125 | 0 | 50 | 50 | 50 |
| 7.5 | 0.625 + 0.0625 | 0 | 20 | 20 | 20 |
| 30 | 5 + 0.5 | 0 | 90 | 90 | 100* |
| 15 | 2.5 + 0.25 | 0 | 70 | 70 | 90* |
| 7.5 | 1.25 + 0.125 | 0 | 50 | 50 | 50 |
| 3.75 | 0.625 + 0.0625 | 0 | 20 | 20 | 20 |
| 15 | 5 + 0.5 | 0 | 90 | 90 | 100* |
| 7.5 | 2.5 + 0.25 | 0 | 70 | 70 | 90* |
| 3.75 | 1.25 + 0.125 | 0 | 50 | 50 | 50 |
| 1.875 | 0.625 + 0.0625 | 0 | 20 | 20 | 20 |
| 7.5 | 5 + 0.5 | 0 | 90 | 90 | 100* |
| 3.75 | 2.5 + 0.25 | 0 | 70 | 70 | 90* |
| 1.875 | 1.25 + 0.125 | 0 | 50 | 50 | 50 |
| 0.9375 | 0.625 + 0.0625 | 0 | 20 | 20 | 20 |
| 3.75 | 5 + 0.5 | 0 | 90 | 90 | 100* |
| 1.875 | 2.5 + 0.25 | 0 | 70 | 70 | 90* |
| 0.9375 | 1.25 + 0.125 | 0 | 50 | 50 | 50 |
| 0.46875 | 0.625 + 0.0625 | 0 | 20 | 20 | 20 |
| 0.234375 | 0.3125 + 0.03125 | 0 | 0 | 0 | 0 |
| 0.1171875 | 0.15625 + 0.01563 | 0 | 0 | 0 | 20* |

TABLE 50

| PPM Al | | | | | |
|---|---|---|---|---|---|
| | Lambda | AVERAGE CONTROL IN % | | | |
| | Cyhalothrin + | | Lambda Cyhalothrin + | EXPECTED | OBSERVED |
| COMPOUND A5 | Azoxystrobin | COMPOUND A5 | Azoxystrobin | CONTROL | CONTROL |
| 7.5 | 0.625 + 0.0625 | 0 | 70 | 70 | 70 |
| 3.75 | 0.3125 + 0.03125 | 0 | 20 | 20 | 20 |
| 1.875 | 0.15625 + 0.01563 | 0 | 20 | 20 | 20 |
| 3.75 | 0.625 + 0.0625 | 0 | 70 | 70 | 70 |
| 1.875 | 0.3125 + 0.03125 | 0 | 20 | 20 | 20 |
| 0.9375 | 0.15625 + 0.01563 | 0 | 20 | 20 | 20 |
| 1.875 | 0.625 + 0.0625 | 0 | 70 | 70 | 90* |
| 0.9375 | 0.3125 + 0.03125 | 0 | 20 | 20 | 20 |
| 0.46875 | 0.15625 + 0.01563 | 0 | 20 | 20 | 20 |
| 0.9375 | 0.625 + 0.0625 | 0 | 70 | 70 | 90* |
| 0.46875 | 0.3125 + 0.03125 | 0 | 20 | 20 | 50* |
| 0.234375 | 0.15625 + 0.01563 | 0 | 20 | 20 | 20 |
| 0.1171875 | 0.07813 + 0.00781 | 0 | 0 | 0 | 20* |
| 0.46875 | 0.625 + 0.0625 | 0 | 70 | 70 | 100* |
| 0.234375 | 0.3125 + 0.03125 | 0 | 20 | 20 | 70* |
| 0.1171875 | 0.15625 + 0.01563 | 0 | 20 | 20 | 50* |

TABLE 51

| PPM Al | | AVERAGE CONTROL IN % | | | |
|---|---|---|---|---|---|
| | Sulfoxaflor + | | Sulfoxaflor + | EXPECTED | OBSERVED |
| COMPOUND A5 | Azoxystrobin | COMPOUND A5 | Azoxystrobin | CONTROL | CONTROL |
| 7.5 | 0.625 + 0.0625 | 0 | 70 | 70 | 70 |
| 3.75 | 0.3125 + 0.03125 | 0 | 20 | 20 | 20 |
| 1.875 | 0.15625 + 0.01563 | 0 | 0 | 0 | 0 |
| 3.75 | 0.625 + 0.0625 | 0 | 70 | 70 | 70 |
| 1.875 | 0.3125 + 0.03125 | 0 | 20 | 20 | 20 |
| 1.875 | 0.625 + 0.0625 | 0 | 70 | 70 | 70 |
| 0.9375 | 0.3125 + 0.03125 | 0 | 20 | 20 | 20 |
| 0.9375 | 0.625 + 0.0625 | 0 | 70 | 70 | 70 |
| 0.46875 | 0.3125 + 0.03125 | 0 | 20 | 20 | 20 |
| 0.46875 | 0.625 + 0.0625 | 0 | 70 | 70 | 90* |
| 0.234375 | 0.3125 + 0.03125 | 0 | 20 | 20 | 50* |
| 0.1171875 | 0.15625 + 0.01563 | 0 | 0 | 0 | 20* |

TABLE 52

| PPM Al | | AVERAGE CONTROL IN % | | | |
|---|---|---|---|---|---|
| | Abamectin + | | Abamectin + | EXPECTED | OBSERVED |
| COMPOUND A5 | Azoxystrobin | COMPOUND A5 | Azoxystrobin | CONTROL | CONTROL |
| 7.5 | 0.625 + 0.0625 | 0 | 70 | 70 | 70 |
| 3.75 | 0.3125 + 0.03125 | 0 | 20 | 20 | 20 |
| 1.875 | 0.15625 + 0.01563 | 0 | 0 | 0 | 0 |
| 3.75 | 0.625 + 0.0625 | 0 | 70 | 70 | 70 |
| 1.875 | 0.3125 + 0.03125 | 0 | 20 | 20 | 20 |
| 1.875 | 0.625 + 0.0625 | 0 | 70 | 70 | 70 |
| 0.9375 | 0.3125 + 0.03125 | 0 | 20 | 20 | 20 |
| 0.9375 | 0.625 + 0.0625 | 0 | 70 | 70 | 90* |
| 0.46875 | 0.3125 + 0.03125 | 0 | 20 | 20 | 20 |
| 0.46875 | 0.625 + 0.0625 | 0 | 70 | 70 | 100* |
| 0.234375 | 0.3125 + 0.03125 | 0 | 20 | 20 | 50* |
| 0.1171875 | 0.15625 + 0.01563 | 0 | 0 | 0 | 20* |

TABLE 53

| PPM Al | | AVERAGE CONTROL IN % | | | |
|---|---|---|---|---|---|
| | Thiamethoxam + | | Thiamethoxam + | EXPECTED | OBSERVED |
| COMPOUND A5 | Azoxystrobin | COMPOUND A5 | Azoxystrobin | CONTROL | CONTROL |
| 7.5 | 0.625 + 0.0625 | 0 | 70 | 70 | 70 |
| 3.75 | 0.3125 + 0.03125 | 0 | 20 | 20 | 20 |
| 3.75 | 0.625 + 0.0625 | 0 | 70 | 70 | 70 |
| 1.875 | 0.3125 + 0.03125 | 0 | 20 | 20 | 20 |
| 1.875 | 0.625 + 0.0625 | 0 | 70 | 70 | 70 |
| 0.9375 | 0.3125 + 0.03125 | 0 | 20 | 20 | 20 |
| 0.9375 | 0.625 + 0.0625 | 0 | 70 | 70 | 70 |
| 0.46875 | 0.3125 + 0.03125 | 0 | 20 | 20 | 20 |
| 0.46875 | 0.625 + 0.0625 | 0 | 70 | 70 | 90* |
| 0.234375 | 0.3125 + 0.03125 | 0 | 20 | 20 | 20 |

Septoria tritici (leaf blotch): Conidia of the fungus from cryogenic storage were directly mixed into nutrient broth (potato dextrose broth). After placing a (DMSO) solution of the test compounds into a microtiter plate (96-well format) the nutrient broth containing the fungal spores was added. The test plates were incubated at 24° C. and the inhibition of growth was determined photometrically after 72 hours. Application rates are shown in the Tables.

TABLE 54

| PPM Al | | | | | |
|---|---|---|---|---|---|
| | Lambda | AVERAGE CONTROL IN % | | | |
| | Cyhalothrin + | | Lambda Cyhalothrin + | EXPECTED | OBSERVED |
| COMPOUND A5 | COMPOUND II | COMPOUND A5 | COMPOUND II | CONTROL | CONTROL |
| 60 | 5 + 0.5 | 0 | 90 | 90 | 100* |
| 30 | 2.5 + 0.25 | 0 | 70 | 70 | 90* |
| 15 | 1.25 + 0.125 | 0 | 50 | 50 | 70* |
| 7.5 | 0.625 + 0.0625 | 0 | 20 | 20 | 50* |
| 3.75 | 0.3125 + 0.03125 | 0 | 0 | 0 | 20* |
| 30 | 5 + 0.5 | 0 | 90 | 90 | 100* |
| 15 | 2.5 + 0.25 | 0 | 70 | 70 | 90* |
| 7.5 | 1.25 + 0.125 | 0 | 50 | 50 | 70* |
| 3.75 | 0.625 + 0.0625 | 0 | 20 | 20 | 20 |
| 15 | 5 + 0.5 | 0 | 90 | 90 | 100* |
| 7.5 | 2.5 + 0.25 | 0 | 70 | 70 | 90* |
| 3.75 | 1.25 + 0.125 | 0 | 50 | 50 | 50 |
| 1.875 | 0.625 + 0.0625 | 0 | 20 | 20 | 20 |
| 7.5 | 5 + 0.5 | 0 | 90 | 90 | 100* |
| 3.75 | 2.5 + 0.25 | 0 | 70 | 70 | 90* |
| 1.875 | 1.25 + 0.125 | 0 | 50 | 50 | 50 |
| 0.9375 | 0.625 + 0.0625 | 0 | 20 | 20 | 20 |
| 3.75 | 5 + 0.5 | 0 | 90 | 90 | 100* |
| 1.875 | 2.5 + 0.25 | 0 | 70 | 70 | 90* |
| 0.9375 | 1.25 + 0.125 | 0 | 50 | 50 | 50 |
| 0.46875 | 0.625 + 0.0625 | 0 | 20 | 20 | 20 |

TABLE 55

| PPM Al | | AVERAGE CONTROL IN % | | | |
|---|---|---|---|---|---|
| COMPOUND | Sulfoxaflor + | | Sulfoxaflor + | EXPECTED | OBSERVED |
| A5 | COMPOUND II | COMPOUND A5 | COMPOUND II | CONTROL | CONTROL |
| 60 | 5 + 0.5 | 0 | 90 | 90 | 100* |
| 30 | 2.5 + 0.25 | 0 | 70 | 70 | 70 |
| 15 | 1.25 + 0.125 | 0 | 50 | 50 | 50 |
| 7.5 | 0.625 + 0.0625 | 0 | 20 | 20 | 20 |
| 30 | 5 + 0.5 | 0 | 90 | 90 | 100* |
| 15 | 2.5 + 0.25 | 0 | 70 | 70 | 70 |
| 7.5 | 1.25 + 0.125 | 0 | 50 | 50 | 50 |
| 3.75 | 0.625 + 0.0625 | 0 | 20 | 20 | 20 |
| 15 | 5 + 0.5 | 0 | 90 | 90 | 100* |
| 7.5 | 2.5 + 0.25 | 0 | 70 | 70 | 90* |
| 3.75 | 1.25 + 0.125 | 0 | 50 | 50 | 50 |
| 1.875 | 0.625 + 0.0625 | 0 | 20 | 20 | 20 |
| 7.5 | 5 + 0.5 | 0 | 90 | 90 | 100* |
| 3.75 | 2.5 + 0.25 | 0 | 70 | 70 | 70 |
| 1.875 | 1.25 + 0.125 | 0 | 50 | 50 | 50 |
| 0.9375 | 0.625 + 0.0625 | 0 | 20 | 20 | 20 |
| 3.75 | 5 + 0.5 | 0 | 90 | 90 | 100* |
| 1.875 | 2.5 + 0.25 | 0 | 70 | 70 | 90* |
| 0.9375 | 1.25 + 0.125 | 0 | 50 | 50 | 50 |
| 0.46875 | 0.625 + 0.0625 | 0 | 20 | 20 | 20 |
| 0.234375 | 0.3125 + 0.03125 | 0 | 0 | 0 | 20* |
| 0.1171875 | 0.15625 + 0.01563 | 0 | 0 | 0 | 50* |

TABLE 56

| PPM Al | | AVERAGE CONTROL IN % | | | |
|---|---|---|---|---|---|
| COMPOUND | Abamectin + | | Abamectin + | EXPECTED | OBSERVED |
| A5 | COMPOUND II | COMPOUND A5 | COMPOUND II | CONTROL | CONTROL |
| 60 | 5 + 0.5 | 0 | 90 | 90 | 100* |
| 30 | 2.5 + 0.25 | 0 | 70 | 70 | 90* |
| 15 | 1.25 + 0.125 | 0 | 50 | 50 | 50 |
| 7.5 | 0.625 + 0.0625 | 0 | 20 | 20 | 20 |
| 30 | 5 + 0.5 | 0 | 90 | 90 | 100* |
| 15 | 2.5 + 0.25 | 0 | 70 | 70 | 90* |
| 7.5 | 1.25 + 0.125 | 0 | 50 | 50 | 50 |
| 3.75 | 0.625 + 0.0625 | 0 | 20 | 20 | 20 |
| 15 | 5 + 0.5 | 0 | 90 | 90 | 100* |
| 7.5 | 2.5 + 0.25 | 0 | 70 | 70 | 90* |
| 3.75 | 1.25 + 0.125 | 0 | 50 | 50 | 50 |
| 1.875 | 0.625 + 0.0625 | 0 | 20 | 20 | 20 |
| 7.5 | 5 + 0.5 | 0 | 90 | 90 | 100* |
| 3.75 | 2.5 + 0.25 | 0 | 70 | 70 | 90* |
| 1.875 | 1.25 + 0.125 | 0 | 50 | 50 | 50 |
| 0.9375 | 0.625 + 0.0625 | 0 | 20 | 20 | 20 |
| 3.75 | 5 + 0.5 | 0 | 90 | 90 | 100* |
| 1.875 | 2.5 + 0.25 | 0 | 70 | 70 | 90* |
| 0.9375 | 1.25 + 0.125 | 0 | 50 | 50 | 70* |
| 0.46875 | 0.625 + 0.0625 | 0 | 20 | 20 | 50* |
| 0.234375 | 0.3125 + 0.03125 | 0 | 0 | 0 | 20* |
| 0.1171875 | 0.15625 + 0.01563 | 0 | 0 | 0 | 20* |

TABLE 57

| PPM Al | | AVERAGE CONTROL IN % | | | |
|---|---|---|---|---|---|
| COMPOUND | Thiamethoxam + | | Thiamethoxam + | EXPECTED | OBSERVED |
| A5 | COMPOUND II | COMPOUND A5 | COMPOUND II | CONTROL | CONTROL |
| 60 | 5 + 0.5 | 0 | 90 | 90 | 100* |
| 30 | 2.5 + 0.25 | 0 | 70 | 70 | 90* |
| 15 | 1.25 + 0.125 | 0 | 50 | 50 | 50 |
| 7.5 | 0.625 + 0.0625 | 0 | 20 | 20 | 20 |
| 30 | 5 + 0.5 | 0 | 90 | 90 | 100* |
| 15 | 2.5 + 0.25 | 0 | 70 | 70 | 90* |
| 7.5 | 1.25 + 0.125 | 0 | 50 | 50 | 50 |
| 3.75 | 0.625 + 0.0625 | 0 | 20 | 20 | 20 |
| 15 | 5 + 0.5 | 0 | 90 | 90 | 100* |
| 7.5 | 2.5 + 0.25 | 0 | 70 | 70 | 90* |
| 3.75 | 1.25 + 0.125 | 0 | 50 | 50 | 50 |
| 1.875 | 0.625 + 0.0625 | 0 | 20 | 20 | 20 |
| 7.5 | 5 + 0.5 | 0 | 90 | 90 | 100* |
| 3.75 | 2.5 + 0.25 | 0 | 70 | 70 | 90* |
| 1.875 | 1.25 + 0.125 | 0 | 50 | 50 | 50 |
| 0.9375 | 0.625 + 0.0625 | 0 | 20 | 20 | 20 |
| 3.75 | 5 + 0.5 | 0 | 90 | 90 | 100* |
| 1.875 | 2.5 + 0.25 | 0 | 70 | 70 | 90* |
| 0.9375 | 1.25 + 0.125 | 0 | 50 | 50 | 50 |
| 0.46875 | 0.625 + 0.0625 | 0 | 20 | 20 | 20 |
| 0.234375 | 0.3125 + 0.03125 | 0 | 0 | 0 | 0 |
| 0.1171875 | 0.15625 + 0.01563 | 0 | 0 | 0 | 20* |

TABLE 58

| PPM Al | | AVERAGE CONTROL IN % | | | |
|---|---|---|---|---|---|
| COMPOUND | Lambda Cyhalothrin + | | Lambda Cyhalothrin + | EXPECTED | OBSERVED |
| A5 | Azoxystrobin | COMPOUND A5 | Azoxystrobin | CONTROL | CONTROL |
| 7.5 | 0.625 + 0.0625 | 0 | 70 | 70 | 70 |
| 3.75 | 0.3125 + 0.03125 | 0 | 20 | 20 | 20 |
| 1.875 | 0.15625 + 0.01563 | 0 | 20 | 20 | 20 |
| 3.75 | 0.625 + 0.0625 | 0 | 70 | 70 | 70 |
| 1.875 | 0.3125 + 0.03125 | 0 | 20 | 20 | 20 |
| 0.9375 | 0.15625 + 0.01563 | 0 | 20 | 20 | 20 |
| 1.875 | 0.625 + 0.0625 | 0 | 70 | 70 | 90* |
| 0.9375 | 0.3125 + 0.03125 | 0 | 20 | 20 | 20 |
| 0.46875 | 0.15625 + 0.01563 | 0 | 20 | 20 | 20 |
| 0.9375 | 0.625 + 0.0625 | 0 | 70 | 70 | 90* |
| 0.46875 | 0.3125 + 0.03125 | 0 | 20 | 20 | 50* |
| 0.234375 | 0.15625 + 0.01563 | 0 | 20 | 20 | 20 |
| 0.1171875 | 0.07813 + 0.00781 | 0 | 0 | 0 | 20* |
| 0.46875 | 0.625 + 0.0625 | 0 | 70 | 70 | 100* |
| 0.234375 | 0.3125 + 0.03125 | 0 | 20 | 20 | 70* |
| 0.1171875 | 0.15625 + 0.01563 | 0 | 20 | 20 | 50* |

TABLE 59

| PPM Al | | AVERAGE CONTROL IN % | | | |
|---|---|---|---|---|---|
| COMPOUND | Sulfoxaflor + | | Sulfoxaflor + | EXPECTED | OBSERVED |
| A5 | Azoxystrobin | COMPOUND A5 | Azoxystrobin | CONTROL | CONTROL |
| 7.5 | 0.625 + 0.0625 | 0 | 70 | 70 | 70 |
| 3.75 | 0.3125 + 0.03125 | 0 | 20 | 20 | 20 |
| 1.875 | 0.15625 + 0.01563 | 0 | 0 | 0 | 0 |
| 3.75 | 0.625 + 0.0625 | 0 | 70 | 70 | 70 |
| 1.875 | 0.3125 + 0.03125 | 0 | 20 | 20 | 20 |
| 1.875 | 0.625 + 0.0625 | 0 | 70 | 70 | 70 |
| 0.9375 | 0.3125 + 0.03125 | 0 | 20 | 20 | 20 |
| 0.9375 | 0.625 + 0.0625 | 0 | 70 | 70 | 70 |
| 0.46875 | 0.3125 + 0.03125 | 0 | 20 | 20 | 20 |
| 0.46875 | 0.625 + 0.0625 | 0 | 70 | 70 | 90* |
| 0.234375 | 0.3125 + 0.03125 | 0 | 20 | 20 | 50* |
| 0.1171875 | 0.15625 + 0.01563 | 0 | 0 | 0 | 20* |

TABLE 60

| PPM Al | | AVERAGE CONTROL IN % | | | |
|---|---|---|---|---|---|
| COMPOUND | Abamectin + | | Abamectin + | EXPECTED | OBSERVED |
| A5 | Azoxystrobin | COMPOUND A5 | Azoxystrobin | CONTROL | CONTROL |
| 7.5 | 0.625 + 0.0625 | 0 | 70 | 70 | 70 |
| 3.75 | 0.3125 + 0.03125 | 0 | 20 | 20 | 20 |
| 1.875 | 0.15625 + 0.01563 | 0 | 0 | 0 | 0 |
| 3.75 | 0.625 + 0.0625 | 0 | 70 | 70 | 70 |
| 1.875 | 0.3125 + 0.03125 | 0 | 20 | 20 | 20 |
| 1.875 | 0.625 + 0.0625 | 0 | 70 | 70 | 70 |
| 0.9375 | 0.3125 + 0.03125 | 0 | 20 | 20 | 20 |
| 0.9375 | 0.625 + 0.0625 | 0 | 70 | 70 | 90* |
| 0.46875 | 0.3125 + 0.03125 | 0 | 20 | 20 | 20 |
| 0.46875 | 0.625 + 0.0625 | 0 | 70 | 70 | 100* |
| 0.234375 | 0.3125 + 0.03125 | 0 | 20 | 20 | 50* |
| 0.1171875 | 0.15625 + 0.01563 | 0 | 0 | 0 | 20* |

TABLE 61

| PPM Al | | AVERAGE CONTROL IN % | | | |
|---|---|---|---|---|---|
| COMPOUND | Thiamethoxam + | | Thiamethoxam + | EXPECTED | OBSERVED |
| A5 | Azoxystrobin | COMPOUND A5 | Azoxystrobin | CONTROL | CONTROL |
| 7.5 | 0.625 + 0.0625 | 0 | 70 | 70 | 70 |
| 3.75 | 0.3125 + 0.03125 | 0 | 20 | 20 | 20 |
| 3.75 | 0.625 + 0.0625 | 0 | 70 | 70 | 70 |
| 1.875 | 0.3125 + 0.03125 | 0 | 20 | 20 | 20 |
| 1.875 | 0.625 + 0.0625 | 0 | 70 | 70 | 70 |
| 0.9375 | 0.3125 + 0.03125 | 0 | 20 | 20 | 20 |
| 0.9375 | 0.625 + 0.0625 | 0 | 70 | 70 | 70 |
| 0.46875 | 0.3125 + 0.03125 | 0 | 20 | 20 | 20 |
| 0.46875 | 0.625 + 0.0625 | 0 | 70 | 70 | 90* |
| 0.234375 | 0.3125 + 0.03125 | 0 | 20 | 20 | 20 |

Mycosphaerella arachidis (svn. Cercospora arachidicola), Brown Leaf Spot of Groundnut (Peanut):

Conidia of the fungus from cryogenic storage were directly mixed into nutrient broth (potato dextrose broth). After placing a (DMSO) solution of the test compounds into a microtiter plate (96-well format) the nutrient broth containing the fungal spores was added. The test plates were incubated at 24° C. and the inhibition of growth was determined photometrically after approximately 5-6 days at 620 nm. Application rates are shown in the Tables.

TABLE 62

| PPM Al | | AVERAGE CONTROL IN % | | | |
|---|---|---|---|---|---|
| COMPOUND | Lambda Cyhalothrin + | | Lambda Cyhalothrin + | EXPECTED | OBSERVED |
| A5 | COMPOUND II | COMPOUND A5 | COMPOUND II | CONTROL | CONTROL |
| 7.5 | 0.625 + 0.0625 | 0 | 90 | 90 | 90 |
| 3.75 | 0.3125 + 0.03125 | 0 | 70 | 70 | 70 |
| 1.875 | 0.15625 + 0.01563 | 0 | 20 | 20 | 20 |
| 3.75 | 0.625 + 0.0625 | 0 | 90 | 90 | 90 |
| 1.875 | 0.3125 + 0.03125 | 0 | 70 | 70 | 70 |
| 0.9375 | 0.15625 + 0.01563 | 0 | 20 | 20 | 20 |
| 1.875 | 0.625 + 0.0625 | 0 | 90 | 90 | 90 |
| 0.9375 | 0.3125 + 0.03125 | 0 | 70 | 70 | 70 |
| 0.46875 | 0.15625 + 0.01563 | 0 | 20 | 20 | 20 |
| 0.9375 | 0.625 + 0.0625 | 0 | 90 | 90 | 90 |
| 0.46875 | 0.3125 + 0.03125 | 0 | 70 | 70 | 50 |
| 0.234375 | 0.15625 + 0.01563 | 0 | 20 | 20 | 20 |
| 0.46875 | 0.625 + 0.0625 | 0 | 90 | 90 | 90 |
| 0.234375 | 0.3125 + 0.03125 | 0 | 70 | 70 | 50 |
| 0.1171875 | 0.15625 + 0.01563 | 0 | 20 | 20 | 20 |

TABLE 63

| PPM Al | | AVERAGE CONTROL IN % | | | |
|---|---|---|---|---|---|
| | Sulfoxaflor + | | Sulfoxaflor + | EXPECTED | OBSERVED |
| COMPOUND A5 | COMPOUND II | COMPOUND A5 | COMPOUND II | CONTROL | CONTROL |
| 30 | 2.5 + 0.25 | 0 | 90 | 90 | 100* |
| 15 | 1.25 + 0.125 | 0 | 90 | 90 | 100* |
| 7.5 | 0.625 + 0.0625 | 0 | 90 | 90 | 90 |
| 3.75 | 0.3125 + 0.03125 | 0 | 70 | 70 | 70 |
| 1.875 | 0.15625 + 0.01563 | 0 | 50 | 50 | 20 |
| 15 | 2.5 + 0.25 | 0 | 90 | 90 | 100* |
| 7.5 | 1.25 + 0.125 | 0 | 90 | 90 | 100* |
| 3.75 | 0.625 + 0.0625 | 0 | 90 | 90 | 90 |
| 1.875 | 0.3125 + 0.03125 | 0 | 70 | 70 | 70 |
| 0.9375 | 0.15625 + 0.01563 | 0 | 50 | 50 | 50 |
| 7.5 | 2.5 + 0.25 | 0 | 90 | 90 | 100* |
| 3.75 | 1.25 + 0.125 | 0 | 90 | 90 | 100* |
| 1.875 | 0.625 + 0.0625 | 0 | 90 | 90 | 90 |
| 0.9375 | 0.3125 + 0.03125 | 0 | 70 | 70 | 90* |
| 0.46875 | 0.15625 + 0.01563 | 0 | 50 | 50 | 20 |
| 0.234375 | 0.07813 + 0.00781 | 0 | 20 | 20 | 0 |
| 3.75 | 2.5 + 0.25 | 0 | 90 | 90 | 100* |
| 1.875 | 1.25 + 0.125 | 0 | 90 | 90 | 100* |
| 0.9375 | 0.625 + 0.0625 | 0 | 90 | 90 | 90 |
| 0.46875 | 0.3125 + 0.03125 | 0 | 70 | 70 | 50 |
| 0.234375 | 0.15625 + 0.01563 | 0 | 50 | 50 | 20 |
| 0.1171875 | 0.07813 + 0.00781 | 0 | 20 | 20 | 0 |
| 1.875 | 2.5 + 0.25 | 0 | 90 | 90 | 100* |
| 0.9375 | 1.25 + 0.125 | 0 | 90 | 90 | 100* |
| 0.46875 | 0.625 + 0.0625 | 0 | 90 | 90 | 90 |
| 0.234375 | 0.3125 + 0.03125 | 0 | 70 | 70 | 70 |
| 0.1171875 | 0.15625 + 0.01563 | 0 | 50 | 50 | 50 |

TABLE 64

| PPM Al | | AVERAGE CONTROL IN % | | | |
|---|---|---|---|---|---|
| | Abamectin + | | Abamectin + | EXPECTED | OBSERVED |
| COMPOUND A5 | COMPOUND II | COMPOUND A5 | COMPOUND II | CONTROL | CONTROL |
| 7.5 | 0.625 + 0.0625 | 0 | 90 | 90 | 90 |
| 3.75 | 0.3125 + 0.03125 | 0 | 70 | 70 | 70 |
| 1.875 | 0.15625 + 0.01563 | 0 | 20 | 20 | 20 |
| 3.75 | 0.625 + 0.0625 | 0 | 90 | 90 | 90 |
| 1.875 | 0.3125 + 0.03125 | 0 | 70 | 70 | 70 |
| 0.9375 | 0.15625 + 0.01563 | 0 | 20 | 20 | 20 |
| 1.875 | 0.625 + 0.0625 | 0 | 90 | 90 | 90 |
| 0.9375 | 0.3125 + 0.03125 | 0 | 70 | 70 | 70 |
| 0.46875 | 0.15625 + 0.01563 | 0 | 20 | 20 | 20 |
| 0.9375 | 0.625 + 0.0625 | 0 | 90 | 90 | 100* |
| 0.46875 | 0.3125 + 0.03125 | 0 | 70 | 70 | 70 |
| 0.234375 | 0.15625 + 0.01563 | 0 | 20 | 20 | 20 |
| 0.46875 | 0.625 + 0.0625 | 0 | 90 | 90 | 100* |
| 0.234375 | 0.3125 + 0.03125 | 0 | 70 | 70 | 70 |
| 0.1171875 | 0.15625 + 0.01563 | 0 | 20 | 20 | 70* |

TABLE 65

| PPM Al | | AVERAGE CONTROL IN % | | | |
|---|---|---|---|---|---|
| | Thiamethoxam + | | Thiamethoxam + | EXPECTED | OBSERVED |
| COMPOUND A5 | COMPOUND II | COMPOUND A5 | COMPOUND II | CONTROL | CONTROL |
| 7.5 | 0.625 + 0.0625 | 0 | 90 | 90 | 90 |
| 3.75 | 0.3125 + 0.03125 | 0 | 70 | 70 | 50 |
| 1.875 | 0.15625 + 0.01563 | 0 | 20 | 20 | 20 |
| 3.75 | 0.625 + 0.0625 | 0 | 90 | 90 | 90 |
| 1.875 | 0.3125 + 0.03125 | 0 | 70 | 70 | 50 |
| 0.9375 | 0.15625 + 0.01563 | 0 | 20 | 20 | 20 |
| 1.875 | 0.625 + 0.0625 | 0 | 90 | 90 | 90 |
| 0.9375 | 0.3125 + 0.03125 | 0 | 70 | 70 | 70 |
| 0.46875 | 0.15625 + 0.01563 | 0 | 20 | 20 | 20 |
| 0.9375 | 0.625 + 0.0625 | 0 | 90 | 90 | 90 |
| 0.46875 | 0.3125 + 0.03125 | 0 | 70 | 70 | 20 |
| 0.234375 | 0.15625 + 0.01563 | 0 | 20 | 20 | 0 |
| 0.46875 | 0.625 + 0.0625 | 0 | 90 | 90 | 100* |
| 0.234375 | 0.3125 + 0.03125 | 0 | 70 | 70 | 70 |
| 0.1171875 | 0.15625 + 0.01563 | 0 | 20 | 20 | 20 |

TABLE 66

| PPM Al | | AVERAGE CONTROL IN % | | | |
|---|---|---|---|---|---|
| | Lambda | | Lambda | | |
| | Cyhalothrin + | | Cyhalothrin + | EXPECTED | OBSERVED |
| COMPOUND A5 | Azoxystrobin | COMPOUND A5 | Azoxystrobin | CONTROL | CONTROL |
| 3.75 | 0.3125 + 0.03125 | 0 | 70 | 70 | 70 |
| 1.875 | 0.15625 + 0.01563 | 0 | 20 | 20 | 20 |
| 1.875 | 0.3125 + 0.03125 | 0 | 70 | 70 | 70 |
| 0.9375 | 0.15625 + 0.01563 | 0 | 20 | 20 | 20 |
| 0.9375 | 0.3125 + 0.03125 | 0 | 70 | 70 | 90* |
| 0.46875 | 0.15625 + 0.01563 | 0 | 20 | 20 | 50* |
| 0.46875 | 0.3125 + 0.03125 | 0 | 70 | 70 | 70 |
| 0.234375 | 0.15625 + 0.01563 | 0 | 20 | 20 | 50* |
| 0.1171875 | 0.07813 + 0.00781 | 0 | 0 | 0 | 20* |
| 0.46875 | 0.625 + 0.0625 | 0 | 100 | 100 | 90 |
| 0.234375 | 0.3125 + 0.03125 | 0 | 70 | 70 | 90* |
| 0.1171875 | 0.15625 + 0.01563 | 0 | 20 | 20 | 70* |

TABLE 67

| PPM Al | | AVERAGE CONTROL IN % | | | |
|---|---|---|---|---|---|
| | Sulfoxaflor + | | Sulfoxaflor + | EXPECTED | OBSERVED |
| COMPOUND A5 | Azoxystrobin | COMPOUND A5 | Azoxystrobin | CONTROL | CONTROL |
| 7.5 | 0.625 + 0.0625 | 0 | 90 | 90 | 90 |
| 3.75 | 0.3125 + 0.03125 | 0 | 70 | 70 | 70 |
| 1.875 | 0.15625 + 0.01563 | 0 | 20 | 20 | 20 |
| 3.75 | 0.625 + 0.0625 | 0 | 90 | 90 | 90 |
| 1.875 | 0.3125 + 0.03125 | 0 | 70 | 70 | 70 |
| 0.9375 | 0.15625 + 0.01563 | 0 | 20 | 20 | 20 |
| 1.875 | 0.625 + 0.0625 | 0 | 90 | 90 | 90 |
| 0.9375 | 0.3125 + 0.03125 | 0 | 70 | 70 | 70 |
| 0.46875 | 0.15625 + 0.01563 | 0 | 20 | 20 | 20 |
| 0.9375 | 0.625 + 0.0625 | 0 | 90 | 90 | 90 |
| 0.46875 | 0.3125 + 0.03125 | 0 | 70 | 70 | 70 |
| 0.234375 | 0.15625 + 0.01563 | 0 | 20 | 20 | 20 |
| 0.46875 | 0.625 + 0.0625 | 0 | 90 | 90 | 100* |
| 0.234375 | 0.3125 + 0.03125 | 0 | 70 | 70 | 70 |
| 0.1171875 | 0.15625 + 0.01563 | 0 | 20 | 20 | 20 |

TABLE 68

| PPM Al | | AVERAGE CONTROL IN % | | | |
|---|---|---|---|---|---|
| | Abamectin + | | Abamectin + | EXPECTED | OBSERVED |
| COMPOUND A5 | Azoxystrobin | COMPOUND A5 | Azoxystrobin | CONTROL | CONTROL |
| 7.5 | 0.625 + 0.0625 | 0 | 90 | 90 | 100* |
| 3.75 | 0.3125 + 0.03125 | 0 | 70 | 70 | 70 |
| 1.875 | 0.15625 + 0.01563 | 0 | 20 | 20 | 20 |
| 3.75 | 0.625 + 0.0625 | 0 | 90 | 90 | 100* |
| 1.875 | 0.3125 + 0.03125 | 0 | 70 | 70 | 70 |
| 0.9375 | 0.15625 + 0.01563 | 0 | 20 | 20 | 20 |
| 1.875 | 0.625 + 0.0625 | 0 | 90 | 90 | 100* |
| 0.9375 | 0.3125 + 0.03125 | 0 | 70 | 70 | 70 |
| 0.46875 | 0.15625 + 0.01563 | 0 | 20 | 20 | 20 |
| 0.9375 | 0.625 + 0.0625 | 0 | 90 | 90 | 100* |
| 0.46875 | 0.3125 + 0.03125 | 0 | 70 | 70 | 70 |
| 0.234375 | 0.15625 + 0.01563 | 0 | 20 | 20 | 20 |
| 0.46875 | 0.625 + 0.0625 | 0 | 90 | 90 | 90 |
| 0.234375 | 0.3125 + 0.03125 | 0 | 70 | 70 | 70 |
| 0.1171875 | 0.15625 + 0.01563 | 0 | 20 | 20 | 50* |

TABLE 69

| PPM Al | | AVERAGE CONTROL IN % | | | |
|---|---|---|---|---|---|
| | Thiamethoxam + | | Thiamethoxam + | EXPECTED | OBSERVED |
| COMPOUND A5 | Azoxystrobin | COMPOUND A5 | Azoxystrobin | CONTROL | CONTROL |
| 7.5 | 0.625 + 0.0625 | 0 | 90 | 90 | 100* |
| 3.75 | 0.3125 + 0.03125 | 0 | 70 | 70 | 70 |
| 1.875 | 0.15625 + 0.01563 | 0 | 50 | 50 | 20 |
| 0.9375 | 0.07813 + 0.00781 | 0 | 20 | 20 | 20 |
| 3.75 | 0.625 + 0.0625 | 0 | 90 | 90 | 100* |
| 1.875 | 0.3125 + 0.03125 | 0 | 70 | 70 | 90* |
| 0.9375 | 0.15625 + 0.01563 | 0 | 50 | 50 | 20 |
| 0.46875 | 0.07813 + 0.00781 | 0 | 20 | 20 | 20 |
| 1.875 | 0.625 + 0.0625 | 0 | 90 | 90 | 90 |
| 0.9375 | 0.3125 + 0.03125 | 0 | 70 | 70 | 50 |
| 0.46875 | 0.15625 + 0.01563 | 0 | 50 | 50 | 20 |
| 0.234375 | 0.07813 + 0.00781 | 0 | 20 | 20 | 0 |
| 0.9375 | 0.625 + 0.0625 | 0 | 90 | 90 | 90 |
| 0.46875 | 0.3125 + 0.03125 | 0 | 70 | 70 | 50 |
| 0.234375 | 0.15625 + 0.01563 | 0 | 50 | 50 | 20 |
| 0.1171875 | 0.07813 + 0.00781 | 0 | 20 | 20 | 0 |
| 0.46875 | 0.625 + 0.0625 | 0 | 90 | 90 | 100* |
| 0.234375 | 0.3125 + 0.03125 | 0 | 70 | 70 | 70 |
| 0.1171875 | 0.15625 + 0.01563 | 0 | 50 | 50 | 20 |

Data is not shown for experiments where there was no insect mortality or where the single components and mixtures resulted in 100% control.

What is claimed is:

1. A pesticidal mixture comprising a component A, a component B and a component C, wherein component A is a compound of formula I 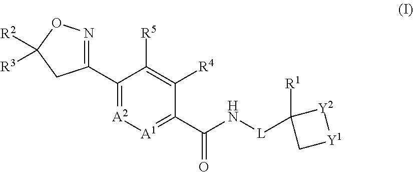
wherein
one of Y¹ and Y² is S, SO or SO₂ and the other is CH₂;
L is a direct bond or methylene;
A¹ and A² are C—H, or one of A¹ and A² is C—H and the other is N;
R¹ is hydrogen or methyl;
R² is chlorodifluoromethyl or trifluoromethyl;
R³ is 3,5-dibromo-phenyl, 3,5-dichloro-phenyl, 3,4-dichloro-phenyl, or 3,4,5-trichloro-phenyl;
R⁴ is methyl;
R⁵ is hydrogen;
or R⁴ and R⁵ together form a bridging 1,3-butadiene group;
component B is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen, N-[9-(dichloromethylene)-1,2,3,4-tetrahydro-1,4-methanonaphthalen-5-yl]-3-(difluoromethyl)-1-methyl-1H-pyrazole-4-carboxamide and Fuxapyroxad; or
component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria spp., Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat; and
component C is a compound selected from an insecticide, a fungicide and a nematicide, which insecticide is selected from neonicotinoids, carbamates, diamides, spinosyns, phenylpyrazoles, pyrethroids, Pyrifluquinazone, Pymetrozine, Sulfoxaflor and Spirotetramat;
which fungicide is selected from Azoxystrobin, Trifloxystrobin, Fluoxastrobin, Cyproconazole, Difenoconazole, Prothioconazole, Tebuconazole, Triticonazole, Fludioxonil, Thiabendazole, Ipconazole, Cyprodinil, Myclobutanil, Metalaxyl, Mefenoxam, Sedaxane, N-[9-(dichloromethylene)-1,2,3,4-tetrahydro-1,4-methanonaphthalen-5-yl]-3-(difluoromethyl)-1-methyl-1H-pyrazole-4-carboxamide, Fluopyram, Penflufen, Fuxapyroxad, Fluopyram, and Penthiopyrad;
which nematicide is selected from Abamectin, carbamate nematicides organophosphorus nematicides, Captan, Thiophanate-methyl, Thiabendazole, a compound of formula X, 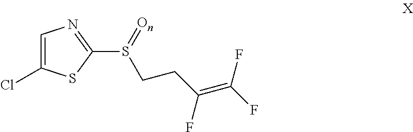
wherein n is 0, 1 or 2 and the thiazole ring may be optionally substituted, Bacillus spp., Streptomyces spp. and Pasteuria spp.; Pochonia spp., Metarhizium spp.; wherein components B and C are different.

2. A pesticidal mixture according to claim 1, wherein in the compound of formula I L is a direct bond or methylene; one of Y¹ and Y² is S and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

3. A pesticidal mixture according to claim 1, wherein in the compound of formula I L is a direct bond or methylene; one of Y¹ and Y² is SO and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

4. A pesticideal mixtures according to claim 3, wherein the molar proportion of the cis SO compounds of formula I compared to the total amount of compounds of cis SO and trans SO compound of formula I is greater than 50%.

5. A pesticidal mixture according to claim 1, wherein in the compound of formula I L is a direct bond or methylene; one of Y¹ and Y² is SO₂ and the other is CH₂; A¹ and A² are C—H; R¹ is hydrogen or methyl; R² is trifluoromethyl; R³ is 3,5-dichloro-phenyl; R⁴ is methyl; and R⁵ is hydrogen.

6. A pesticidal mixture according to claim 1, wherein when L is a direct bond Y² is CH₂ and Y¹ is S, SO or SO₂, and wherein when L is methylene Y² is S, SO or SO₂ and Y¹ is CH₂.

7. A pesticidal mixtures according to claim 1, wherein component A is a mixture of compounds of formula I* and I**. 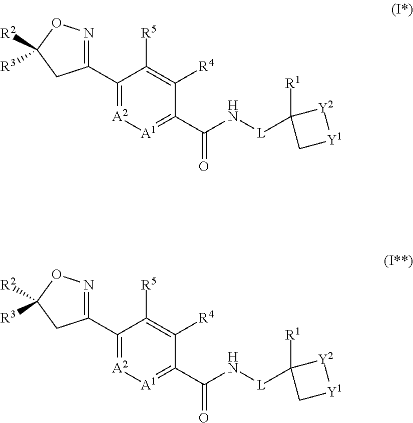
wherein the molar proportion of compound I** compared to the total amount of both enantiomers is greater than 50%.

8. A pesticidal mixture according to claim 1, wherein component C is a compound selected from Thiamethoxam, Clothianidin, Nithiazine, Flonicamid, Imidacloprid, Acetamiprid, Dinotefuran, Nitenpyram, Thiacloprid, Thiodicarb, Aldicarb, Carbofuran, Furadan, Fenoxycarb, Carbaryl, Sevin, Ethienocarb, Fenobucarb, Chlorantraniliprole, Cyantraniliprole, Flubendiamide, Spinosad, Spinetoram, Cyhalothrin, Lambda-cyhalothrin, Gamma-cyhalothrin, Tefluthrin, Fipronil, Azoxystrobin, Trifloxystrobin, Fluoxastrobin, Cyproconazole, Difenoconazole, Prothioconazole, Tebuconazole, Triticonazole, Fludioxonil, Thiabendazole, Ipconazole, Cyprodinil, Myclobutanil, Metalaxyl, Mefenoxam, Sedaxane, Fluopyram, Penflufen, Fuxapyroxad, Abamectin, Aldicarb, Thiodicarb, Carbofuran, Carbosulfan, Oxamyl, Aldoxycarb, Ethoprop, Methomyl, Benomyl, Alanycarb, Iprodione, Phenamiphos, Fensulfothion, Terbufos, Fosthiazate, Dimethoate, Phosphocarb, Dichlofenthion, Isamidofos, Fosthietan, Isazofos, Ethoprophos, Cadusafos, Terbufos, Chlorpyrifos, Dichlofenthion, Heterophos, Isamidofos, Mecarphon, Phorate, Thionazin, Triazophos, Diamidafos, Fosthietan, Phosphamidon, Imicyafos, Captan, Thiophanate-methyl, Thiabendazole, a compound of formula X, Pyrifluquinazone, Pymetrozine, Sulfoxaflor and Spirotetramat, Bacillus firmus, Bacillus subtilis, Pasteuria penetrans and Pasteuria nishizawae.

9. A pesticidal mixture according to claim 1, herein component C is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans and Pasteuria nishizawae, Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat, wherein components B and C are different.

10. A pesticidal mixture according to claim 1, wherein component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans and Pasteuria nishizawae; and component C is a compound selected from Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat.

11. A pesticidal mixture according claim 1, wherein component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans and Pasteuria nishizawae; and component C is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad.

12. A pesticidal mixture according claim 1, wherein component B is a compound selected from Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat; and component C is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad.

13. A pesticidal mixture according to claim 1, wherein component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans and Pasteuria nishizawae; and wherein the mixture comprises as component C, component C1 and component C2, wherein component C1 is a compound selected from Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat; and component C2 is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad.

14. A pesticidal mixture according to claim 1, wherein component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans, Pasteuria nishizawae, Imidacloprid, Thiacloprid and component C is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans and Pasteuria nishizawae.

15. A pesticidal mixture according to claim 1, wherein component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans, Pasteuria nishizawae, Imidacloprid, Thiacloprid and component C is a compound selected from Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat.

16. A pesticidal mixture according to claim 1, wherein component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans, Pasteuria nishizawae, Imidacloprid, Thiacloprid and component C is a compound selected from Sedaxane, Fludioxonil, Metalaxyl, Mefenoxam, Cyprodinil, Azoxystrobin, Tebuconazole, Difenoconazole, Thiabendazole, Fluopyram, Penflufen and Fuxapyroxad, provided that components B and C are different.

17. A pesticidal mixture according to claim 1, wherein component B is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, Pasteuria penetrans, Pasteuria nishizawae, Imidacloprid, Thiacloprid and the pesticidal mixture comprises, as component C, component C1 and component C2, wherein component C1 is a compound selected from Tefluthrin, Lambda-cyhalothrin, Abamectin, Spinosad, Spinetoram, Chlorpyrifos, Thiodicarb, Chlorantraniliprole, Cyantraniliprole, Bacillus firmus, Bacillus subtilis, and Pasteuria penetrans, Pasteuria nishizawae, and component C2 is a compound selected from Imidacloprid, Thiacloprid, Acetamiprid, Nitenpyram, Dinotefuran, Thiamethoxam, Clothianidin, Nithiazine, Flonicamid, Fipronil, Pyrifluquinazone, Pymetrozine, Sulfoxaflor and Spirotetramat.

18. A pesticidal mixture according to claim 1, wherein the mixture comprises as componetns A, B and C:
a compound of formula I, thiamethoxam and lambda cyhalothrin;
a compound of formula I, abamectin and lambda cyhalothrin;
a compound of formula I, spirotetramat and lambda cyhalothrin;
a compound of formula I, sulfoxaflor and lambda cyhalothrin;
a compound of formula I, a compound of formula II and lambda cyhalothrin;
a compound of formula I, a compound of formula II and sulfoxaflor;
a compound of formula I, a compound of formula II and abamectin;
a compound of formula I, a compound of formula II and thiamethoxam;
a compound of formula I, azoxystrobin and lambda cyhalothrin;
a compound of formula I, azoxystrobin and sulfoxaflor;
a compound of formula I, azoxystrobin and abamectin;
a compound of formula I, azoxystrobin and thiamethoxam.

19. A pesticidal mixture according to claim 1, wherein the mixture is not one comprising Cyantraniliprole and Thiamethoxam; or
Chlorantraniliprole and Thiamethoxam.

20. A pesticidal mixture according to claim 1, wherein the mixture comprises an agricultural acceptable carrier and optionally a surfactant.

21. A pesticidal mixture according to claim 1, wherein the weight ratio of A to each of components B and C is 1000:1 to 1:1000.

22. A method of controlling phytopathogenic diseases on useful plants or on propagation material thereof, which comprises applying to the useful plants, the locus thereof or propagation material thereof a combination of components A, B and C, wherein components A, B and C are as defined in claim 1.

23. A method of controlling insects, acarines, nematodes or molluscs which comprises applying to a pest, to a locus of a pest, to a plant susceptible to attack by a pest, or to plant propagation material susceptible to attack by a pest, a combination of components A, B and C, wherein components A, B and C are as defined in claim 1.

24. A seed comprising a pesticidal mixture as defined in claim 1.

25. A method comprising applying to a seed a mixture as defined in claim 1.
